(19) United States
(12) Patent Application Publication
(10) Pub. No.: US 2026/0355945 A1
(43) Pub. Date: Nov. 12, 2026

(54) SYSTEMS AND METHODS FOR VACUUM ENGAGEMENT AND RELEASE CONTROL FOR SOLAR PANELS

(71) Applicant: Luminous Robotics, Inc., Boston, MA (US)

(72) Inventors: Jay Ming Wong, Boston, MA (US); Matthew Aidan Sweeney, North Billerica, MA (US); Emma Sage Gardner-Garvey, Meredith, NH (US); Harvey Anthony Koselka, Bolton, MA (US); Robert Thomas Boyd, Weston, MA (US)

(21) Appl. No.: 19/671,087

(22) Filed: May 7, 2026

Related U.S. Application Data
(60) Provisional application No. 63/802,214, filed on May 8, 2025.
(60) Provisional application No. 63/854,602, filed on Jul. 31, 2025.

(51) Int. Cl. B25J 9/16; B25J 5/00; B25J 15/06

(52) U.S. Cl. CPC B25J 9/1612; B25J 5/005; B25J 15/0658

(57) ABSTRACT

A gripper assembly can include a frame mounting structure, a frame structure having a plurality of suction cups, a rotational shaft disposed within the frame mounting structure and coupled to the frame structure, and an actuator coupled to the frame mounting structure and coupled to the rotational shaft. The actuator can be configured to rotate the frame structure via the rotational shaft. A robotic system can include a movable base, an articulated arm disposed on the movable base, and the gripper assembly coupled to the articulated arm. The robotic system can position the gripper adjacent to a solar panel, engage the solar panel with the plurality of suction cups, and rotate the frame structure via the actuator to reposition the solar panel.

### CROSS-REFERENCE TO RELATED APPLICATION

The present application claims priority to U.S. Provisional Patent Application No. 63/802,214, filed on May 8, 2025, and U.S. Provisional Patent Application No. 63/854,602, filed on Jul. 31, 2025, each of which is incorporated herein by reference in its entirety.

### BACKGROUND

Solar panel installation environments can include rows of racking infrastructure, such as torque tubes and hat rails, onto which solar panels are mounted across large areas of terrain. Placing solar panels onto racking infrastructure can involve transporting each panel from a staging location to a mounting location and positioning the panel in a particular orientation relative to the racking infrastructure. Handling solar panels during installation across solar farm environments can present challenges related to, but not limited to, maintaining panel grip during transport, positioning panels according to respective electrical polarity orientation, and determining placement locations relative to previously installed panels.

### SUMMARY

The systems and methods of the present disclosure provide a movable base that travels along a row of an installation environment and an articulated arm that picks and places solar panels laterally without reorienting the movable base. A gripper assembly carried by the articulated arm can include a rotatable frame structure with a plurality of suction cups and a rotational actuator that provides an additional degree of freedom beyond the joints of the articulated arm, enabling underhand pickup of a panel and lateral deployment to a mounting location on a torque tube. A controller of the robotic system can determine positions of electrical lead terminals on a solar panel using camera imagery and can select a coupling location and a rotation path based on terminal position, travel direction, and deployment side, such that each placed panel has a target electrical polarity orientation. The robotic system can use redundant vacuum sources on separate fluid lines, each individually sufficient to retain the solar panel, and can maintain vacuum as a default state that is terminated in response to an affirmative release command, such that loss of a communication signal or a single vacuum pathway does not result in a dropped panel. The controller can apply positive pressure through a shared fluid line to break residual stiction during panel release.

At least one aspect relates to a gripper assembly. The gripper assembly can include a frame mounting structure. The gripper assembly can include a frame structure having a plurality of suction cups. The gripper assembly can include a rotational shaft disposed within the frame mounting structure and coupled to the frame structure. The gripper assembly can include an actuator coupled to the frame mounting structure and coupled to the rotational shaft, the actuator to rotate the frame structure via the rotational shaft.

In some implementations, the frame structure includes a carbon fiber frame. In some implementations, the gripper assembly can further include a gear system operably coupled between the rotational shaft and the actuator. In some implementations, the rotational shaft is directly coupled to the actuator. In some implementations, each suction cup is mounted to the frame structure via a suction cup mount. In some implementations, the suction cup mount includes a port to fluidly connect a suction cup to a vacuum source. In some implementations, the vacuum source includes a plurality of vacuum sources, and a first subset of the plurality of suction cups is fluidly connected to a first vacuum source and a second subset of the plurality of suction cups is fluidly connected to a second vacuum source. In some implementations, the rotational shaft is oriented perpendicular to a plane defined by the frame structure. In some implementations, the frame mounting structure includes a plurality of interconnected sidewalls defining an interior volume. In some implementations, the actuator is mounted to a sidewall of the frame mounting structure.

At least one other aspect relates to a method. The method can be performed, for example, by one or more processors coupled to non-transitory memory. The method can include positioning a gripper assembly adjacent to a solar panel, the gripper assembly including a frame structure and a plurality of suction cups mounted to the frame structure. The method can include engaging the solar panel with the plurality of suction cups. The method can include causing an actuator coupled to a shaft of the gripper assembly to rotate the frame structure. The method can include repositioning the solar panel using the rotated gripper assembly.

In some implementations, the frame structure includes a carbon fiber frame. In some implementations, engaging the solar panel includes independently adjusting each of the plurality of suction cups to engage the solar panel. In some implementations, the method can include transporting the solar panel to a mounting location using the gripper assembly. In some implementations, transporting the solar panel includes moving the gripper assembly using an articulated arm. In some implementations, causing the actuator to rotate includes rotating the frame structure by 90 degrees. In some implementations, the method can include aligning the rotated solar panel with a mounting structure.

At least one other aspect relates to a robotic system for solar panel installation. The robotic system can include a movable base. The robotic system can include an articulated arm coupled to the movable base. The robotic system can include a gripper assembly coupled to the articulated arm. The gripper assembly can include a frame structure having a plurality of suction cups. The gripper assembly can include a rotational actuator coupled to the frame structure, the rotational actuator to rotate the frame structure relative to the articulated arm.

In some implementations, the plurality of suction cups includes four suction cups arranged in a rectangular configuration on the frame structure. In some implementations, the rotational actuator includes a shaft extending across the frame structure, a gear system coupled to the shaft, and an actuator connected to the gear system. In some implementations, the gear system includes a first gear and a second gear mounted on the shaft, the first gear having a larger diameter than the second gear. In some implementations, the rotational actuator is to rotate the frame structure by 90 degrees relative to the articulated arm to reposition a solar panel engaged by the plurality of suction cups.

At least one other aspect relates to a method. The method can be performed, for example, by one or more processors coupled to non-transitory memory. The method can include transmitting a first control signal to a first controller of an articulated arm to position a gripper assembly adjacent to a solar panel, the gripper assembly including a frame structure and a plurality of suction cups mounted to the frame structure. The method can include actuating a vacuum source to couple the plurality of suction cups to the solar panel. The method can include transmitting a second control signal to the first controller to position the solar panel proximate to a target location. The method can include transmitting a third control signal to an actuator of the gripper assembly to rotate the solar panel to a target orientation.

In some implementations, the first control signal and the third control signal are transmitted simultaneously.

At least one other aspect relates to a robotic system. The robotic system can include a movable base having a vacuum source and a positive pressure source. The robotic system can include an articulated arm disposed on the movable base and including a gripper to couple to a solar panel, the gripper having a plurality of suction cups. The robotic system can include a controller. The system can control the articulated arm to position the gripper adjacent to the solar panel. The system can activate the vacuum source to couple the plurality of suction cups to a surface of the solar panel. The system can control the articulated arm to move the solar panel to a mounting location while maintaining suction via the plurality of suction cups and the vacuum source. The system can deactivate the vacuum source and activate the positive pressure source to release the solar panel from the plurality of suction cups based on the solar panel being proximate to the mounting location.

In some implementations, the system can deactivate the vacuum source and activate the positive pressure source to release the solar panel in response to user input. In some implementations, the system can deactivate the vacuum source and activate the positive pressure source to release the solar panel in response to a position of the solar panel satisfying a condition. In some implementations, the condition includes at least one of a distance of the solar panel to the mounting location, an orientation of the solar panel, a length of time, or contact of the solar panel at the mounting location. In some implementations, the positive pressure source includes a compressed air source fluidly coupled to the plurality of suction cups. In some implementations, the system can activate the positive pressure source based on supplying positive pressure to the plurality of suction cups for a predetermined time period. In some implementations, to release the solar panel, the system can activate the positive pressure source to apply positive pressure to the plurality of suction cups and control the articulated arm to move towards the movable base while the positive pressure source is activated. In some implementations, the vacuum source includes a plurality of vacuum sources, and a first subset of the plurality of suction cups is fluidly connected to a first vacuum source and a second subset of the plurality of suction cups is fluidly connected to a second vacuum source. In some implementations, the system can maintain coupling of the gripper to the solar panel through at least one of the plurality of vacuum sources in response to loss of vacuum from another of the plurality of vacuum sources. In some implementations, the system can activate the vacuum source in response to the plurality of suction cups directly contacting the surface of the solar panel.

At least one other aspect relates to a method. The method can be performed, for example, by one or more processors coupled to non-transitory memory. The method can include positioning, using an articulated arm disposed on a movable base of a robotic system, a gripper adjacent to a solar panel, and the gripper having a plurality of suction cups. The method can include activating a vacuum source on the movable base to couple the plurality of suction cups to a surface of the solar panel. The method can include controlling the articulated arm to move the solar panel to a mounting location while maintaining suction via the plurality of suction cups and the vacuum source. The method can include deactivating the vacuum source and activating a positive pressure source on the movable base to release the solar panel from the plurality of suction cups based on the solar panel being proximate to the mounting location.

In some implementations, deactivating the vacuum source and activating the positive pressure source to release the solar panel is performed in response to user input. In some implementations, deactivating the vacuum source and activating the positive pressure source to release the solar panel is performed in response to a position of the solar panel satisfying a condition. In some implementations, the condition includes at least one of a distance of the solar panel to the mounting location, an orientation of the solar panel, a length of time, or contact of the solar panel at the mounting location. In some implementations, activating the positive pressure source includes supplying compressed air from a compressed air source fluidly coupled to the plurality of suction cups. In some implementations, activating the positive pressure source includes supplying positive pressure to the plurality of suction cups for a predetermined time period. In some implementations, releasing the solar panel further includes activating the positive pressure source to apply positive pressure to the plurality of suction cups and controlling the articulated arm to move toward the movable base while the positive pressure source is activated. In some implementations, activating the vacuum source includes activating a plurality of vacuum sources, such that a first subset of the plurality of suction cups is fluidly connected to a first vacuum source and a second subset of the plurality of suction cups is fluidly connected to a second vacuum source. In some implementations, the method can include maintaining coupling of the gripper to the solar panel through at least one of the plurality of vacuum sources in response to loss of vacuum from another of the plurality of vacuum sources. In some implementations, the method can include activating the vacuum source in response to the plurality of suction cups directly contacting the surface of the solar panel.

At least one other aspect relates to a robotic system. The robotic system can include a movable base having a first vacuum source and a second vacuum source. The robotic system can include an articulated arm disposed on the movable base and including a gripper to couple to a solar panel, the gripper having a plurality of suction cups. The robotic system can include a controller. The system can control the articulated arm to position a gripper assembly adjacent to the solar panel. The system can activate the first vacuum source and the second vacuum source to couple the plurality of suction cups to a surface of the solar panel, where a first subset of the plurality of suction cups is coupled to the first vacuum source and a second subset of the plurality of suction cups is coupled to the second vacuum source. The system can control the articulated arm to move the solar panel to a mounting location while maintaining suction via the plurality of suction cups, the first vacuum source, and the second vacuum source. The first vacuum source can provide suction sufficient to maintain coupling of the solar panel to the gripper via the first subset of the plurality of suction cups independent of the second vacuum source.

In some implementations, the robotic system can further include a positive pressure source fluidly coupled to the plurality of suction cups. In some implementations, the system can deactivate at least one of the first vacuum source or the second vacuum source and activate the positive pressure source to release the solar panel from the plurality of suction cups in response to determining that the solar panel is within a distance threshold to the mounting location. In some implementations, the first subset of the plurality of suction cups is fluidly coupled to the first vacuum source through a first vacuum line, and the second subset of the plurality of suction cups is fluidly coupled to the second vacuum source through a second vacuum line separate from the first vacuum line. In some implementations, each of the first vacuum source and the second vacuum source is coupled to at least two suction cups of the plurality of suction cups. In some implementations, the system can transmit a first signal to the articulated arm to control movement of the articulated arm and transmit a second signal different from the first signal to the articulated arm to control activation of the first vacuum source and the second vacuum source. In some implementations, the system can transmit at least one of the first signal or the second signal in response to receiving user input requesting movement of the solar panel. In some implementations, the system can control the first vacuum source and the second vacuum source using a common vacuum control signal. In some implementations, the system can control the first vacuum source using a first vacuum control signal and the second vacuum source using a second vacuum control signal different from the first vacuum control signal. In some implementations, the system can initiate activation of at least one of the first vacuum source or the second vacuum source in response to the gripper being within a threshold distance from the solar panel.

At least one other aspect relates to a method. The method can be performed, for example, by one or more processors coupled to non-transitory memory. The method can include positioning, using an articulated arm disposed on a movable base of a robotic system, a gripper adjacent to a solar panel, and the gripper having a plurality of suction cups. The method can include activating a first vacuum source and a second vacuum source on the movable base to couple the plurality of suction cups to a surface of the solar panel, where a first subset of the plurality of suction cups is coupled to the first vacuum source and a second subset of the plurality of suction cups is coupled to the second vacuum source. The method can include controlling the articulated arm to move the solar panel to a mounting location while maintaining suction via the plurality of suction cups, the first vacuum source, and the second vacuum source. The first vacuum source can provide suction sufficient to maintain coupling of the solar panel to the gripper via the first subset of the plurality of suction cups independent of the second vacuum source.

In some implementations, the method can include supplying positive pressure from a positive pressure source fluidly coupled to the plurality of suction cups. In some implementations, the method can include deactivating at least one of the first vacuum source or the second vacuum source and activating the positive pressure source to release the solar panel from the plurality of suction cups in response to determining that the solar panel is within a distance threshold from the mounting location. In some implementations, coupling the plurality of suction cups to the first vacuum source includes fluidly coupling the first subset of the plurality of suction cups to the first vacuum source through a first vacuum line, and coupling the plurality of suction cups to the second vacuum source includes fluidly coupling the second subset of the plurality of suction cups to the second vacuum source through a second vacuum line separate from the first vacuum line. In some implementations, each of activating the first vacuum source and activating the second vacuum source includes applying vacuum to at least two suction cups of the plurality of suction cups. In some implementations, the method can include transmitting a first signal to the articulated arm to control movement of the articulated arm and transmitting a second signal different from the first signal to the articulated arm to control activation of the first vacuum source and the second vacuum source. In some implementations, transmitting at least one of the first signal or the second signal is performed in response to receiving user input requesting movement of the solar panel. In some implementations, activating the first vacuum source and the second vacuum source includes activating the first vacuum source and the second vacuum source using a common vacuum control signal. In some implementations, activating the first vacuum source includes activating the first vacuum source using a first vacuum control signal and activating the second vacuum source includes activating the second vacuum source using a second vacuum control signal different from the first vacuum control signal. In some implementations, the method can include initiating activation of at least one of the first vacuum source or the second vacuum source in response to determining that the gripper is within a threshold distance from the solar panel.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the present disclosure can be combined with other aspects. Aspects can be implemented in any convenient form, for example, by appropriate computer programs, which may be carried on appropriate carrier media (e.g., computer-readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a schematic of an example robotic system, according to aspects of the present disclosure.

FIG. 2 illustrates another schematic of the robotic system of FIG. 1, according to aspects of the present disclosure.

FIG. 3 illustrates an exploded view of the robotic system of FIG. 1, according to aspects of the present disclosure.

FIG. 4A illustrates an isometric view of a gripper assembly, according to aspects of the present disclosure.

FIG. 4B illustrates an orthogonal view of the gripper assembly, according to aspects of the present disclosure.

FIG. 4C illustrates another orthogonal view of the gripper assembly, according to aspects of the present disclosure.

FIG. 4D illustrates an orthogonal top view of the gripper assembly, according to aspects of the present disclosure.

FIG. 4E illustrates an orthogonal side view of the gripper assembly, according to aspects of the present disclosure.

FIG. 4F illustrates an orthogonal side view of the gripper assembly, according to aspects of the present disclosure.

FIG. 4G illustrates an isometric view of the gripper assembly, according to aspects of the present disclosure.

FIG. 5A illustrates a top perspective view of a gripper assembly with a carbon fiber frame, according to aspects of the present disclosure.

FIG. 5B illustrates a bottom perspective view of the gripper assembly of FIG. 5A, according to aspects of the present disclosure.

FIG. 5C illustrates a top orthogonal view of the gripper assembly, according to aspects of the present disclosure.

FIG. 5D illustrates a bottom orthogonal view of the gripper assembly in a diamond configuration, according to aspects of the present disclosure.

FIG. 5E illustrates an orthogonal side view of the gripper assembly, according to aspects of the present disclosure.

FIG. 5F illustrates an isometric view of the gripper assembly, according to aspects of the present disclosure.

FIG. 6A illustrates an isometric view of a rotational actuation assembly, according to aspects of the present disclosure.

FIG. 6B illustrates an orthogonal side view of the rotational actuation assembly, according to aspects of the present disclosure.

FIG. 6C illustrates another orthogonal side view of the rotational actuation assembly, according to aspects of the present disclosure.

FIG. 6D illustrates an orthogonal side view of the rotational actuation assembly, according to aspects of the present disclosure.

FIG. 6E illustrates an orthogonal side view of the rotational actuation assembly, according to aspects of the present disclosure.

FIG. 6F illustrates an isometric view of the rotational actuation assembly, according to aspects of the present disclosure.

FIGS. 7, 8, and 9 illustrate various views of a gripper assembly attached to an articulated arm, according to aspects of the present disclosure.

FIG. 10 illustrates a top view of a gripper assembly attached to an articulated arm, according to aspects of the present disclosure.

FIGS. 11A and 11B are perspective views of a gripper assembly, according to aspects of the present disclosure.

FIGS. 12A, 12B, 13A, and 13B illustrate orthogonal side views of the gripper assembly, according to aspects of the present disclosure.

FIGS. 14A and 14B illustrate top views of the gripper assembly, according to aspects of the present disclosure.

FIGS. 15A and 15B illustrate other views of a gripper assembly attached to an articulated arm, according to aspects of the present disclosure.

FIG. 16 illustrates a view of a panel held by a gripper assembly, according to aspects of the present disclosure.

FIG. 17 illustrates a view of a gripper assembly, according to aspects of the present disclosure.

FIG. 18 illustrates a schematic of an example environment of an example robotic system, according to aspects of the present disclosure.

FIG. 19 illustrates a flow diagram of an example method for moving a solar panel using a gripper assembly, according to aspects of the present disclosure.

FIG. 20 illustrates a flow diagram of an example method for controlling a gripper assembly, according to aspects of the present disclosure.

FIG. 21 illustrates a flow diagram of an example method of using a vacuum source to move a solar panel, according to aspects of the present disclosure.

FIG. 22 illustrates a flow diagram of an example method for moving a solar panel, according to aspects of the present disclosure.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations can be utilized, and other changes can be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Solar energy systems can include arrays of solar panels mounted on racking structures, such as torque tubes with hat rails, across expansive outdoor installation environments. Installing solar panels at such sites can involve transporting each panel from a staging area, orienting the panel to a target position, and placing the panel onto the racking infrastructure with a particular alignment relative to adjacent panels. Robotic systems can be used to automate portions of the installation process, including picking panels from a staging location using vacuum-actuated grippers and placing the panels onto mounting structures. During an installation cycle, the robotic system can pick a solar panel from a staging position, transport the panel to a mounting location on a torque tube, and release the panel at the mounting location.

However, some approaches may force a robotic system to reorient in order to rotate a solar panel between a pick orientation and a placement orientation, which can limit the range of motion of the arm and increase cycle times. In addition, a vacuum system that relies on a single vacuum source connected through a single fluid path can present a single point of failure, such that a pump malfunction or a line rupture during transport of a solar panel can result in loss of vacuum and a dropped panel. Furthermore, releasing a solar panel from a vacuum gripper at a mounting location can be complicated by residual stiction between the suction cups and the panel surface, and some release approaches that rely on vacuum deactivation alone may not reliably overcome the residual stiction, leading to delays or misplacement during the release phase of the installation cycle.

The systems and methods described herein provide a gripper assembly with a rotational actuator that provides an additional degree of freedom beyond the joints of the articulated arm, a redundant multi-path vacuum system with fail-safe retention behavior, and a positive-pressure release system that uses compressed air delivered through the same fluid lines as the vacuum to break residual stiction during panel release. The rotational actuator of the gripper assembly can include a rotational shaft disposed within a frame mounting structure and coupled to a frame structure carrying a plurality of suction cups. An actuator coupled to the rotational shaft can rotate the frame structure relative to the articulated arm, such that a solar panel engaged by the suction cups can be rotated about an axis of the rotational shaft without requiring the articulated arm to reorient. The rotational shaft can be oriented perpendicular to a plane defined by the frame structure, and the actuator can be coupled to the rotational shaft through a gear system or through a direct coupling.

To implement the redundant vacuum retention, the movable base can house a first vacuum source and a second vacuum source, each fluidly coupled through separate vacuum lines to different subsets of the plurality of suction cups on the gripper assembly. Each vacuum source can be individually sufficient to maintain coupling of the solar panel to the gripper through the respective subset of suction cups, independent of the other vacuum source. A controller of the robotic system can maintain vacuum in an active state as a default while the panel is engaged, such that vacuum is terminated in response to an affirmative release command rather than in response to an absence of a control signal. To release the solar panel at the mounting location, the controller can deactivate the vacuum source and activate a positive pressure source on the movable base, where the positive pressure source can deliver compressed air through the same fluid lines used for vacuum. The compressed air can break residual stiction between the suction cups and the panel surface, such that the panel separates from the gripper and settles onto the mounting location. The controller can activate the positive pressure source for a predetermined time period and can retract the articulated arm toward the movable base while the positive pressure source is active to further assist in physical separation of the suction cups from the panel surface.

The rotational actuator of the gripper assembly can provide a seventh degree of freedom beyond the six joints of the articulated arm, such that the frame structure and an engaged solar panel can be rotated without involving reorientation of the arm, thereby reducing cycle time and expanding the reachable placement envelope of the robotic system. The redundant dual-path vacuum architecture, in which each vacuum source is independently sufficient to retain the solar panel, can mitigate a single point of failure from resulting in a dropped panel during transport. The fail-safe persistence behavior, in which vacuum remains active absent an affirmative release command, can maintain panel retention even in the event of a communication interruption or a controller fault. The positive-pressure release through the shared fluid lines can overcome residual stiction that vacuum deactivation alone may not address, providing a more reliable and repeatable release of the solar panel at the mounting location.

### A. Overview of Robotic System

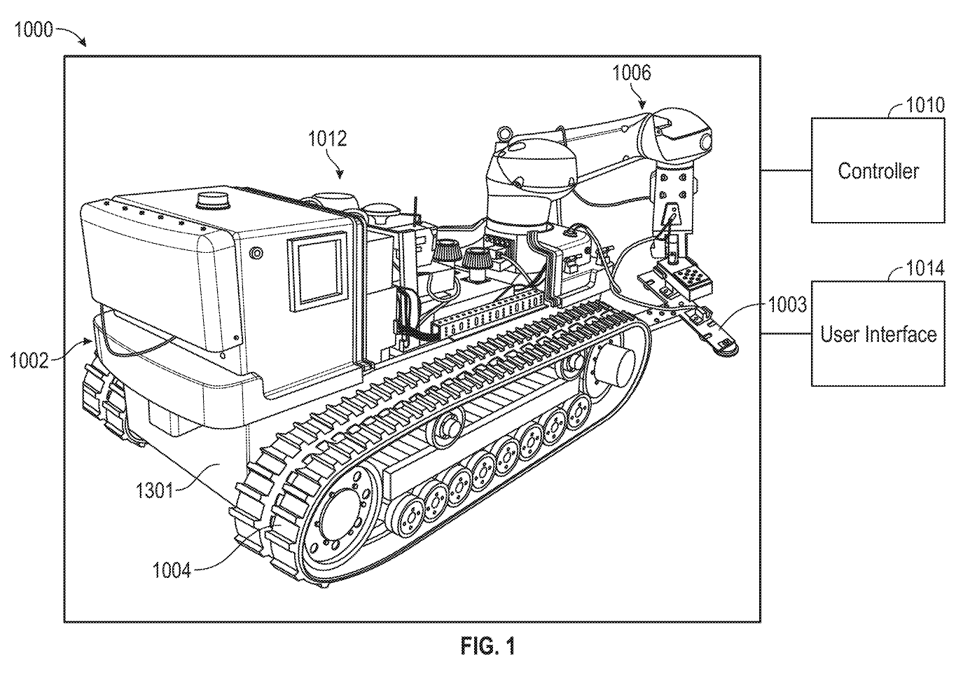

Referring now to FIG. 1, illustrated is a perspective view of a robotic system 1000 (e.g., a robotic installation platform, tracked robot, etc.), in accordance with one or more implementations. The robotic system 1000 can include at least one of: a movable base 1002 (e.g., a tracked vehicle, mobile platform, etc.), an articulated arm 1006 (e.g., a multi-joint robotic arm, manipulator, etc.) disposed on the movable base 1002, a gripper assembly 1003 (e.g., an end effector, suction gripper, vacuum gripper, etc.) coupled to a distal end of the articulated arm 1006, a controller 1010, a vacuum source 1012 (e.g., one or more vacuum pumps, vacuum generators, negative pressure sources, diaphragm pumps, pneumatic suction sources, etc.), or a user interface 1014 (e.g., a display, remote controller, tablet, handheld terminal, operator interface device, etc.). The robotic system 1000 can be used in solar panel installation environments to perform pick-and-place operations in which solar panels (e.g., solar panel 1802) are transported from a staging location to a mounting location on racking infrastructure such as torque tubes with hat rails. The robotic system 1000 can travel along rows of the installation environment, pick up solar panels using vacuum-actuated suction, and place the solar panels onto the racking infrastructure using coordinated movements of the articulated arm 1006 and the gripper assembly 1003.

The movable base 1002 can be a tracked vehicle that provides a mobile platform for the articulated arm 1006, the gripper assembly 1003, the controller 1010, the vacuum source 1012, and other onboard subsystems of the robotic system 1000. As shown in FIG. 1, the movable base 1002 can include a pair of tracks 1004 (e.g., one or more continuous belts, treads, crawlers, track assemblies such as rubber tracks, composite tracks, steel-body tracks, etc.) disposed on opposing lateral sides of a chassis (e.g., chassis 1301, etc.) of the movable base 1002. Each of the tracks 1004 can extend along a longitudinal axis of the movable base 1002 and can engage the ground surface beneath the movable base 1002 to propel the movable base 1002 in a travel direction. The tracks 1004 can provide stability on uneven terrain that can be encountered at solar construction sites, such as graded earth, gravel, or compacted soil. In some implementations, the tracks 1004 can be formed from a flexible composite material with steel bodies. The tracked drivetrain of the movable base 1002 can distribute the weight of the robotic system 1000 across a contact area defined by the footprint of the pair of tracks 1004. In some implementations, the contact area can be in a range of about 1.5 square meters to about 4.0 square meters, such as about 2.5 square meters to about 3.5 square meters. The distribution of the weight of the robotic system 1000 across this contact area can reduce the ground pressure exerted by the robotic system 1000 on the terrain surface.

The articulated arm 1006 can be disposed on the movable base 1002 and can carry the gripper assembly 1003 at a distal end of the articulated arm 1006. The articulated arm 1006 can be a multi-joint robotic arm that provides multiple degrees of freedom for positioning the gripper assembly 1003 in three-dimensional space relative to the movable base 1002. In some implementations, the articulated arm 1006 can provide six degrees of freedom through six rotational joints arranged in a serial kinematic chain. In some implementations, a seventh degree of freedom can be provided by a rotational actuator (e.g., actuator 114, etc.) interposed between an end effector flange of the articulated arm 1006 and the gripper assembly 1003. The articulated arm 1006 can be mounted toward a front portion of a chassis of the movable base 1002, which can position the articulated arm 1006 to reach forward and engage solar panels that are staged ahead of the robotic system 1000 in the travel direction. In some implementations, the articulated arm 1006 can include an arm controller that receives control signals from the controller 1010 and that generates joint-level motor commands to position the articulated arm 1006 at commanded poses. The articulated arm 1006 can provide the reach and payload capacity to pick up solar panels from a staging location, transport the solar panels across the lateral span of the movable base 1002, and lower the solar panels onto racking infrastructure at a mounting location.

The gripper assembly 1003 can include a support beam carrying a plurality of suction cups (e.g., suction cups 108, etc.) arranged to engage a surface of a solar panel. The suction cups can be fluidly coupled to the vacuum source 1012 housed on the movable base 1002 through vacuum lines routed through or alongside the articulated arm 1006. When the vacuum source 1012 is activated, negative pressure can be supplied to the suction cups, which can draw the suction cups against the surface of the solar panel and couple the gripper assembly 1003 to the solar panel. The gripper assembly 1003 can include a rotational actuator that provides an additional rotational degree of freedom beyond the joints of the articulated arm 1006, as described herein. The gripper assembly 1003 can engage the underside or non-active surface (e.g., first surface 1804, etc.) of the solar panel during transport from the staging location to the mounting location.

The controller 1010 can be communicatively coupled with and can coordinate operation of the articulated arm 1006, the gripper assembly 1003, the vacuum source 1012, and the movable base 1002 during pick-and-place operations. In some implementations, the controller 1010 is disposed in or otherwise coupled to the movable base 1002. The controller 1010 can include one or more processors, one or more memory devices, and communications interfaces for transmitting and receiving control signals. The controller 1010 can transmit a first control signal to an arm controller of the articulated arm 1006 to position the gripper assembly 1003 adjacent to a solar panel. The controller 1010 can transmit a second control signal to activate the vacuum source 1012 to couple the suction cups of the gripper assembly 1003 to the solar panel. The controller 1010 can transmit additional control signals to coordinate movement of the articulated arm 1006 and rotation of the gripper assembly 1003 to transport the solar panel to a mounting location and to orient the solar panel in a mounting orientation. The controller 1010 can receive input from the user interface 1014 and can generate commands in response to the received input. In some implementations, the controller 1010 can receive input from one or more cameras coupled to the articulated arm 1006 and/or to the movable base 1002 and can use image data from the cameras to determine panel positions, mounting locations, electrical lead terminal positions, and safety conditions, as described herein.

The vacuum source 1012 can be housed on the movable base 1002 and can generate negative pressure for coupling the suction cups of the gripper assembly 1003 to a solar panel. In some implementations, the vacuum source 1012 can include one or more vacuum pumps, such as diaphragm pumps, piston pumps, or rotary vane pumps. In some implementations, the vacuum source 1012 can include two or more vacuum sources that are fluidly coupled to respective subsets of the suction cups of the gripper assembly 1003 through separate vacuum lines, as described herein. Each vacuum source can be individually sufficient to maintain coupling of the solar panel to the gripper assembly 1003 via its respective subset of suction cups, independent of the other vacuum source. The vacuum source 1012 can be fluidly coupled to the suction cups through vacuum lines that are routed through or alongside the articulated arm 1006 from the movable base 1002 to the gripper assembly 1003. A positive pressure source, such as a compressed air source, can also be housed on the movable base 1002 and can be fluidly coupled to the suction cups through the same fluid lines used for vacuum. The positive pressure source can be activated during a release sequence to blow compressed air through the suction cups and break residual stiction between the suction cups and the panel surface.

The user interface 1014 can provide an interface through which an operator can interact with the robotic system 1000. The user interface 1014 can be communicatively coupled with the controller 1010, and can provide inputs from the operator to the controller 1010. In some implementations, the user interface 1014 can be a remote controller, a tablet, a display, or a handheld device that communicates with the controller 1010 via a wired or wireless connection. The user interface 1014 can display image data from cameras of the robotic system 1000, status information about the articulated arm 1006 and the vacuum source 1012, and graphical indicators representing panel positions, mounting locations, distances, and alignment information. The user interface 1014 can receive operator inputs such as commands to initiate a pick operation, a place operation, a release operation, or a navigation command. In some implementations, the user interface 1014 can display visual cues such as red, yellow, and green color coding to indicate proximity and alignment of a solar panel to a target placement position, as described herein. In some implementations, the user interface 1014 can receive a selection of one or more cameras for calibration, as described herein.

The controller 1010 can generate alignment indicator data for display on the user interface 1014 based at least on image data received from the image sensors 1302 and/or the image sensors 1320. The controller 1010 can process the image data to detect a boundary of a solar panel in a captured image frame and can determine a lateral offset and an angular offset of the gripper assembly 1003 relative to a target coupling position on the solar panel. The lateral offset can represent a displacement of the gripper assembly 1003 in a direction parallel to the surface of the solar panel relative to a target engagement point on the solar panel. The angular offset can represent a rotational misalignment between an orientation axis of the gripper assembly 1003 and a corresponding axis of the solar panel, such as an edge or a centerline of the solar panel. The controller 1010 can compare the lateral offset to a lateral offset threshold and can compare the angular offset to an angular offset threshold. Based at least on the comparison results, the controller 1010 can assign an alignment indicator state to be displayed on the user interface 1014. In some implementations, the alignment indicator state can include a first state, a second state, and a third state corresponding to respective alignment conditions.

The user interface 1014 can display an alignment indicator that transitions among a plurality of visual states based at least on the alignment indicator data generated by the controller 1010. In some implementations, the alignment indicator can include a color-coded indicator that displays a first color, such as red, when the lateral offset exceeds a first lateral threshold and/or the angular offset exceeds a first angular threshold. The alignment indicator can display a second color, such as yellow, when the lateral offset is between the first lateral threshold and a second lateral threshold and/or the angular offset is between the first angular threshold and a second angular threshold. The alignment indicator can display a third color, such as green, when the lateral offset is below the second lateral threshold and the angular offset is below the second angular threshold. In some implementations, the first lateral threshold can be about 50 mm, about 75 mm, or about 100 mm, among others. In some implementations, the second lateral threshold can be about 10 mm, about 20 mm, or about 30 mm, among others. In some implementations, the first angular threshold can be about 10 degrees, about 15 degrees, or about 20 degrees, among others. In some implementations, the second angular threshold can be about 2 degrees, about 5 degrees, or about 7 degrees, among others.

The controller 1010 can detect the boundary of the solar panel in the image data using image recognition techniques. In some implementations, the controller 1010 can apply edge detection to the image data to identify edge pixels corresponding to the perimeter of the solar panel. In some implementations, the controller 1010 can apply a segmentation model to the image data to generate a segmentation mask that delineates the solar panel region from the background. In some implementations, the controller 1010 can identify corner features of the solar panel in the image data and can fit a quadrilateral to the identified corner features to determine the panel boundary. The controller 1010 can compute a centroid of the detected panel boundary and can compare the centroid to a reference position in the image frame corresponding to a target coupling position. The difference between the centroid and the reference position can be used to compute the lateral offset. The controller 1010 can compute an orientation of the detected panel boundary, such as an angle of a detected edge relative to a horizontal or vertical reference axis, and can compare the computed orientation to a target orientation to determine the angular offset.

The user interface 1014 can display the alignment indicator as an overlay on a live camera feed from one of the image sensors 1302 and/or the image sensors 1320. In some implementations, the alignment indicator can include a graphical element, such as a colored border, a colored crosshair, a colored reticle, or a colored status icon, that is rendered on top of the camera feed image. In some implementations, the user interface 1014 can display a target position indicator, such as a crosshair or a bounding box, that represents the target coupling position on the solar panel, and the controller 1010 can update the color of the target position indicator based on the alignment indicator state. In some implementations, the user interface 1014 can display numeric values representing the lateral offset and/or the angular offset in addition to the color-coded indicator. In some implementations, the user interface 1014 can display a directional arrow or guidance indicator that indicates a direction in which the operator should move the gripper assembly 1003 to reduce the lateral offset and/or the angular offset. In some implementations, the alignment indicator can transition from the first color to the second color to the third color as the operator adjusts the position of the gripper assembly 1003 toward alignment with the solar panel, providing real-time or near real-time visual feedback that indicates when the gripper assembly 1003 is sufficiently aligned with the solar panel for vacuum engagement.

In some implementations, the robotic system 1000 can include one or more image sensors (e.g., cameras, sensors, etc.) coupled to the movable base 1002 and/or to the articulated arm 1006. The image sensors can capture image data of the installation environment, including the staged solar panels, the torque tubes, previously placed solar panels, and objects in the vicinity of the robotic system 1000. The controller 1010 can receive the image data from the image sensors and can use the image data to determine panel positions, mounting locations, electrical lead terminal positions, viewing conditions, and safety conditions, as described herein. The image sensors coupled to the movable base 1002 can have a pose that is fixed relative to the movable base 1002, and the image sensors coupled to the articulated arm 1006 can have a pose that moves with the articulated arm 1006 as the articulated arm 1006 changes position. The controller 1010 can select which image sensor to use based on viewing conditions affecting one or more of the image sensors, such as sun angle or glare that may degrade the image quality from a particular image sensor at a given time of day.

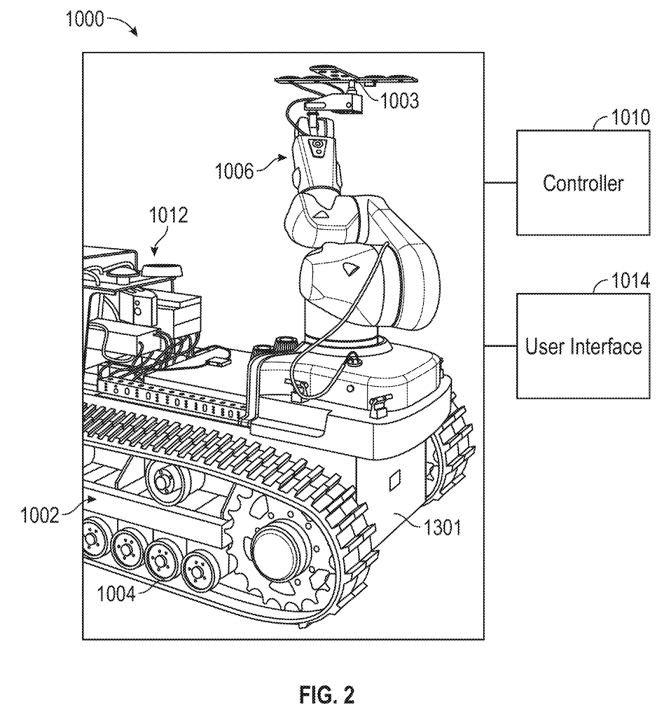

Referring now to FIG. 2, illustrated is a perspective view of the robotic system 1000 including the movable base 1002 and the articulated arm 1006 coupled with the gripper assembly 1003, in accordance with one or more implementations. As shown in FIG. 2, the articulated arm 1006 can be positioned in a configuration in which the gripper assembly 1003 is elevated above the movable base 1002 and oriented in a raised position.

The articulated arm 1006 in FIG. 2 can be shown in a configuration in which multiple joints of the articulated arm 1006 are articulated to position the gripper assembly 1003 at an elevated position relative to the movable base 1002. This configuration can correspond to a transport pose or a placement pose in which the articulated arm 1006 carries a solar panel laterally from the movable base 1002 toward a mounting location on a torque tube. The gripper assembly 1003 can be visible at the distal end of the articulated arm 1006 and can include the frame structure and the plurality of suction cups described herein. The user interface 1014 can be depicted adjacent to the robotic system 1000 and can communicate with the controller 1010 to receive operator inputs and to display status information during the pick-and-place operation.

FIG. 2 can illustrate the relationship between the articulated arm 1006 and the movable base 1002 during a phase of a pick-and-place cycle in which the articulated arm 1006 is extended upward and to one side of the movable base 1002. The articulated arm 1006 can include multiple links connected by rotational joints, and each joint can be actuated by a respective motor that receives commands from the arm controller in response to control signals from the controller 1010. The articulated arm 1006 can position the gripper assembly 1003 at a range of positions and orientations relative to the movable base 1002, including positions that are forward of the movable base 1002 for panel pickup, positions that are lateral to the movable base 1002 for panel transport, and positions that are above the movable base 1002 for panel placement onto a torque tube. The multiple degrees of freedom of the articulated arm 1006, combined with the additional rotational degree of freedom provided by the rotational actuator of the gripper assembly 1003, can provide the robotic system 1000 with the kinematic capability to pick up a solar panel from a staged orientation and to transport and rotate the solar panel into a mounting orientation without reorienting the movable base 1002.

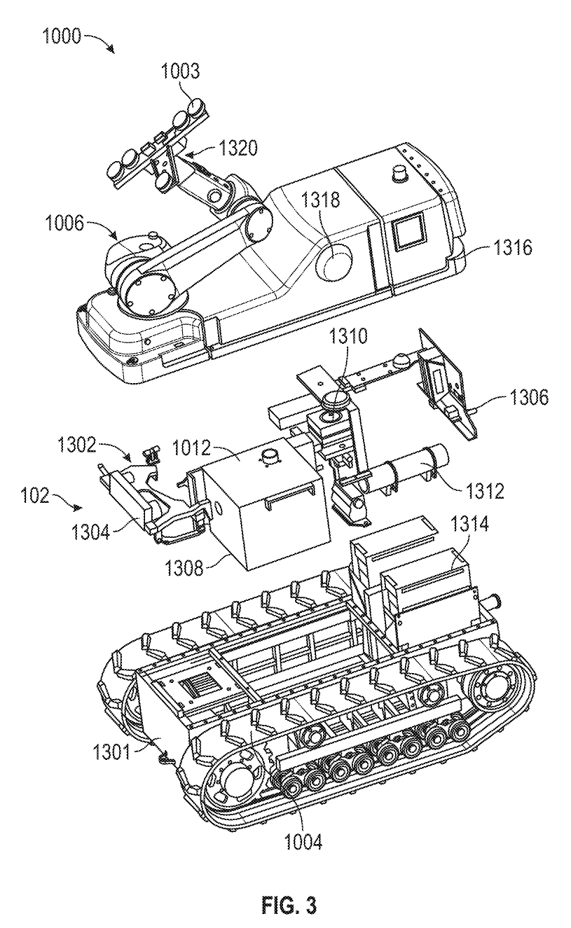

Referring now to FIG. 3, illustrated is an exploded perspective view of the robotic system 1000 showing the movable base 1002, onboard subsystems, the articulated arm 1006, and the gripper assembly 1003, in accordance with one or more implementations. FIG. 3 can depict the robotic system 1000 with the subsystems separated from the chassis 1301 of the movable base 1002 to illustrate the arrangement and positioning of each subsystem within the robotic system 1000. As shown in FIG. 3, the robotic system 1000 can include the gripper assembly 1003, the articulated arm 1006, the controller 1010, the vacuum source 1012, one or more image sensors 1302 (e.g., one or more cameras, image sensors, RGB-D sensors, depth cameras, optical detectors, etc.) coupled to the movable base 1002, one or more image sensors 1320 (e.g., one or more cameras, image sensors, RGB-D sensors, depth cameras, optical detectors, etc.) coupled to the articulated arm 1006 proximate to the gripper assembly 1003, an electrical enclosure 1304 (e.g., a sealed cabinet, electronics housing, wiring enclosure, or electrical compartment, etc.), a power assembly 1306 (e.g., a power converter, voltage regulator, inverter, charge controller unit, etc.), a compressor assembly 1308 (e.g., a compressor, pneumatic pump, air compressor, etc.), a rear intake fan 1310 (e.g., a cooling fan, exhaust blower, ventilation fan, air intake impeller, etc.), batteries 1312 (e.g., one or more battery cells, battery packs, energy storage cells, rechargeable accumulators, etc.), a battery assembly 1314 (e.g., a battery pack, energy storage assembly, battery tray, power storage bank, etc.), a hood 1316 (e.g., a cover, cowling, canopy, protective shell, enclosure lid, etc.), and an exhaust 1318 (e.g., a vent, exhaust port, air outlet, thermal exhaust, etc.).

A chassis 1301 (e.g., frame, etc.) of the movable base 1002 is depicted in FIG. 3, and can be formed from a rigid material, such as steel or aluminum, and can provide a structural platform for mounting the onboard subsystems. The chassis 1301 can define an interior volume or a plurality of mounting surfaces for receiving the electrical enclosure 1304, the power assembly 1306, the compressor assembly 1308, the batteries 1312, the battery assembly 1314, and the controller 1010. The tracks 1004 can be coupled to the chassis via a tracked drivetrain assembly that includes drive sprockets, idler wheels, and track tensioning elements. The tracks 1004 can receive drive commands from the controller 1010 to propel the movable base 1002 in a travel direction along a row of the installation environment.

The one or more image sensors 1302 can be coupled to the movable base 1002 at positions on the chassis 1301. As shown in FIG. 3, the movable base 1002 can include four image sensors 1302 coupled to the chassis 1301, with two image sensors 1302 positioned at a front portion of the chassis 1301 and one image sensor 1302 positioned on each lateral side of the chassis 1301 facing laterally outward. The image sensors 1302 can capture image data of the installation environment, including the terrain ahead of the robotic system 1000, the staged solar panels, the torque tubes, and any objects or personnel in the vicinity of the robotic system 1000. Each of the image sensors 1302 can have a pose that is fixed relative to the movable base 1002, such that the position and orientation of each image sensor 1302 in the coordinate frame of the movable base 1002 does not change as the articulated arm 1006 moves. The controller 1010 can receive image data from the image sensors 1302 and can use the image data to determine panel positions, mounting locations, previously placed panel locations, and safety conditions. In some implementations, the controller 1010 can select which of the image sensors 1302 to use based on viewing conditions affecting one or more of the image sensors 1302, such as sun angle or glare that may degrade the image quality from a particular image sensor 1302 at a given time of day. For example, a west-facing image sensor 1302 may be affected by glare near sunset, and the controller 1010 can select a different image sensor 1302 that is not affected by the glare condition.

The one or more image sensors 1320 can be coupled to the articulated arm 1006 proximate to the distal end of the articulated arm 1006, near the gripper assembly 1003. As shown in FIG. 3, the robotic system 1000 can include two image sensors 1320 coupled to the articulated arm 1006. Each of the image sensors 1320 can have a pose that is fixed relative to the articulated arm 1006, such that the image sensors 1320 move with the articulated arm 1006 as the articulated arm 1006 changes position and orientation during pick-and-place operations. The image sensors 1320 can capture image data from a vantage point at the end of the articulated arm 1006, which can be distinct from the vantage points of the image sensors 1302 on the chassis 1301. The image sensors 1320 can provide image data of the solar panel surface, the electrical lead terminals of the solar panel, the torque tube and hat rails at the mounting location, and the gap between the gripper assembly 1003 and the panel surface during engagement. The controller 1010 can receive image data from the image sensors 1320 and can use the image data to determine the position of electrical lead terminals, to identify coupling locations on the solar panel, and to determine the alignment between the solar panel and the mounting location. In some implementations, when the gripper assembly 1003 is holding a solar panel, the image sensors 1320 may be partially occluded by the solar panel, and the controller 1010 can rely on the image sensors 1302 on the chassis in that state, or vice versa.

The electrical enclosure 1304 can be disposed within the chassis 1301 of the movable base 1002 and can house electrical components of the robotic system 1000. The electrical enclosure 1304 can include power distribution circuitry, motor controllers, communications interfaces, and other electrical hardware that distributes electrical power from the battery system to the various subsystems of the robotic system 1000 and that routes control signals and data between the controller 1010 and the other subsystems. In some implementations, the electrical enclosure 1304 can be a sealed or partially sealed enclosure that provides protection for the electrical components from environmental contaminants such as dust, moisture, and debris that can be present at outdoor solar installation sites. The electrical enclosure 1304 can be positioned within the chassis in a location that provides access for maintenance and service while maintaining a compact arrangement within the movable base 1002.

The power assembly 1306 can be disposed within the chassis of the movable base 1002 and can include power conversion and distribution equipment for the robotic system 1000. In some implementations, the power assembly 1306 can include voltage converters, inverters, charge controllers, and/or power management circuitry that regulate the flow of electrical power from the batteries 1312 to the various subsystems of the robotic system 1000. The power assembly 1306 can receive electrical power from the battery assembly 1314 and can convert the received power to one or more voltage levels used by the articulated arm 1006, the controller 1010, the vacuum source 1012, and other subsystems.

The compressor assembly 1308 can be disposed within the chassis 1301 of the movable base 1002 and can generate vacuum and/or compressed air for the gripper assembly 1003. The compressor assembly 1308 can include one or more compressors, vacuum pumps, accumulators, pressure regulators, valves, and/or fluid lines for generating and distributing negative pressure (vacuum) and positive pressure (compressed air) to the suction cups of the gripper assembly 1003. In some implementations, the compressor assembly 1308 can include the vacuum source 1012 and a positive pressure source that share the same fluid lines to the suction cups, such that the system can switch between a vacuum mode for panel engagement and a positive pressure mode for panel release. In some implementations, the compressor assembly 1308 can include a first vacuum source (e.g., vacuum source 1012, etc.) and a second vacuum source (e.g., vacuum source 1013, etc.) that are fluidly coupled to respective subsets of the suction cups (e.g., first subset 1016, second subset 1018, etc.) through separate vacuum lines (e.g., first vacuum line 1022, second vacuum line 1024, etc.). Each vacuum source can be individually sufficient to maintain coupling of the solar panel to the gripper assembly 1003 via its respective subset of suction cups, independent of the other vacuum source. This dual-path vacuum architecture can mitigate a single-point vacuum failure from resulting in a dropped solar panel.

The rear intake fan 1310 can be disposed at a rear portion of the chassis of the movable base 1002 and can draw air into the chassis to provide cooling for the onboard subsystems. The rear intake fan 1310 can be electrically coupled to the power assembly 1306 and/or the electrical enclosure 1304 and can be controlled by the controller 1010 to operate at one or more fan speeds based on the thermal conditions within the chassis. In some implementations, the robotic system 1000 can include front intake fans positioned at a front portion of the chassis in addition to the rear intake fan 1310, such that airflow passes through the chassis from the front to the rear. The exhaust 1318 can be disposed at the rear or upper portion of the movable base 1002 and can provide an outlet for heated air to exit the chassis. The rear intake fan 1310 and the exhaust 1318 can cooperate to maintain the temperature of the onboard subsystems within operating limits during sustained pick-and-place operations in outdoor solar installation environments where ambient temperatures can be elevated.

The batteries 1312 can be disposed within the chassis of the movable base 1002 and can store electrical energy for powering the robotic system 1000. The batteries 1312 can be part of the battery assembly 1314, which can include the batteries 1312, a battery management system, and wiring that connects the batteries 1312 to the power assembly 1306 and the electrical enclosure 1304. The battery assembly 1314 can provide sufficient energy to power the robotic system 1000 throughout an entire work shift of solar panel installation operations. For example, the batteries 1312 can provide electrical power to the articulated arm 1006, the controller 1010, the vacuum source 1012, and other onboard subsystems. The batteries 1312 can be positioned within the chassis 1301 in a location that distributes the weight of the batteries 1312 across the chassis 1301 to reduce the ground pressure of the movable base 1002.

The hood 1316 can be a cover or enclosure element that is disposed over the upper portion of the chassis of the movable base 1002. The hood 1316 can provide environmental protection for the onboard subsystems, such as the controller 1010, the power assembly 1306, and the electrical enclosure 1304, from rain, dust, solar radiation, and debris. The hood 1316 can be formed from a rigid material, such as sheet metal, fiberglass, or a polymer material, and can be coupled to the chassis via fasteners, latches, or hinges that allow the hood 1316 to be opened for maintenance and service. The hood 1316 can define the upper profile of the movable base 1002 and can be contoured to provide clearance for the articulated arm 1006 and for any torque tubes or racking infrastructure that may be positioned above the movable base 1002 as the robotic system 1000 travels along a row of the installation environment. In some implementations, the robotic system 1000 can have a lower profile that facilitates navigation beneath torque tubes.

The controller 1010 can coordinate pick-and-place operations across multiple phases. During a pick phase, the controller 1010 can receive image data from the image sensors 1302 and/or the image sensors 1320 and can determine the position and orientation of a staged solar panel ahead of the robotic system 1000. The controller 1010 can transmit a control signal to the arm controller of the articulated arm 1006 to extend the articulated arm 1006 forward from the movable base 1002 and to move the gripper assembly 1003 toward the underside of the staged solar panel. The controller 1010 can activate the vacuum source 1012 to generate vacuum at the suction cups of the gripper assembly 1003, and the suction cups can couple to the underside of the solar panel. In some implementations, the controller 1010 can activate the vacuum source 1012 while the gripper assembly 1003 is approaching the solar panel, such that the vacuum is at operating capacity by the time physical contact is made between the suction cups and the panel surface. In some implementations, the controller 1010 can activate the vacuum source 1012 in response to the gripper assembly 1003 being within a threshold distance from the solar panel.

During a placement phase, the controller 1010 can transmit control signals to the arm controller of the articulated arm 1006 to rotate and translate the solar panel laterally in a second direction transverse to the travel direction of the movable base 1002. The controller 1010 can transmit a control signal to the rotational actuator of the gripper assembly 1003 to rotate the solar panel to a mounting orientation. In some implementations, the controller 1010 can transmit the arm movement control signal and the gripper rotation control signal simultaneously, such that the articulated arm 1006 is moving while the rotational actuator of the gripper assembly 1003 is simultaneously rotating the solar panel. The solar panel can be above the gripper assembly 1003 during the lateral movement, and the articulated arm 1006 can swing the solar panel to the left or right side of the movable base 1002 and lower the solar panel onto the hat rails at the mounting location. Throughout the pick and placement phases, the movable base 1002 can remain oriented along the travel direction and does not turn left or right.

During a release phase, the controller 1010 can deactivate the vacuum source 1012 when the solar panel is proximate to the mounting location. The controller 1010 can activate the positive pressure source to blow compressed air through the suction cups and break residual stiction between the suction cups and the panel surface. In some implementations, the controller 1010 can activate the positive pressure source for a predetermined time period and then automatically deactivate the positive pressure source. In some implementations, the controller 1010 can command the articulated arm 1006 to retract toward the movable base 1002 while the positive pressure source is still active, which can assist in physically separating the suction cups from the panel surface. In some implementations, the controller 1010 can apply a slight oscillation or jiggle motion to the articulated arm 1006 during release to overcome stiction between the suction cups and the panel surface. The release can be triggered by user input via the user interface 1014, or the release can be triggered by a condition satisfied by a position of the solar panel, such as a distance of the solar panel to the mounting location falling below a threshold, an orientation of the solar panel being achieved, an elapsed time, or contact of the solar panel at the mounting location being detected.

During a return phase, the controller 1010 can command the articulated arm 1006 to retract, moving in a third direction transverse to the travel direction and the lateral placement direction, and then back toward the movable base 1002 to a neutral position. The controller 1010 can then command the movable base 1002 to advance along the row to the position of the next staged solar panel, and the pick-and-place cycle can repeat.

The controller 1010 can operate in multiple operating modes to accommodate bidirectional travel along rows of the installation environment. In a first operating mode, the controller 1010 can control the movable base 1002 to travel in a first direction, such as from south to north, along a first row. In a second operating mode, the controller 1010 can control the movable base 1002 to travel in a second direction opposite the first direction, such as from north to south, along a second row. In the second operating mode, the controller 1010 can determine a different coupling location on the next solar panel and a different mounting location based on the reversed travel direction. This bidirectional capability can allow the robotic system 1000 to install solar panels in both travel directions without repositioning at the end of each row.

FIG. 3 can illustrate the spatial arrangement of the subsystems within the robotic system 1000. A proximal end of the articulated arm 1006 can be disposed at the front of the chassis, with the gripper assembly 1003 and the image sensors 1320 at the distal end of the articulated arm 1006. The image sensors 1302 can be coupled to the chassis 1301 at the front and side positions. The vacuum source 1012 can be disposed in a mid-region of the chassis 1301. The electrical enclosure 1304 and the compressor assembly 1308 can be disposed adjacent to the controller 1010. The batteries 1312 and the battery assembly 1314 can be disposed in a lower or rear portion of the chassis 1301. The hood 1316 can cover the upper portion of the chassis 1301, and the rear intake fan 1310 and the exhaust 1318 can be positioned at the rear of the chassis 1301 to provide airflow. The tracks 1004 can extend along the lower lateral sides of the chassis 1301 and can provide the locomotion for the movable base 1002. This arrangement can integrate all electronics, power, vacuum, and computing systems on board the movable base 1002, which can eliminate the need for a separate trailer and can provide a self-contained mobile platform for solar panel installation operations.

### B. Overview of Gripper

The robotic system 1000 includes the gripper assembly 1003 for use in solar panel installation systems. The gripper assembly can be part of a larger automated system for increasing the speed of solar panel deployment. In some cases, the system incorporating the gripper assembly can be capable of accelerating deployment speeds by up to tenfold compared to other methods.

The gripper assembly 1003 can be incorporated into existing solar panel installation operations without substantial alterations to established processes or extensive onsite integration efforts. The gripper assembly 1003 can allow for versatile application across various solar construction projects. The gripper assembly 1003 can include a frame structure, multiple suction cups to secure panel engagement, a rotational shaft, and an actuation system. The combination of these elements can enable the gripper assembly to perform reorientation maneuvers while maintaining a grip on solar panels throughout the installation process. The actuation system can drive rotation of the frame structure using either a direct-drive or gear-driven arrangement. In a direct-drive arrangement, the actuation system can be coupled to the rotational shaft without intermediate transmission elements. In a gear-driven arrangement, the actuation system can be coupled to multiple gears, which drive the rotational shaft to rotate the frame structure. The frame mounting structure can include a plurality of interconnected sidewalls defining an interior volume that houses the actuation components, and the actuator can be mounted to a sidewall of the frame mounting structure. The frame mounting structure can provide an attachment interface to an end effector flange of the articulated arm.

By incorporating automation and mechanical systems at the gripper level, the gripper assembly can contribute to streamlining solar panel installation procedures. This approach can lead to improvements in deployment efficiency and overall project timelines for solar farm construction.

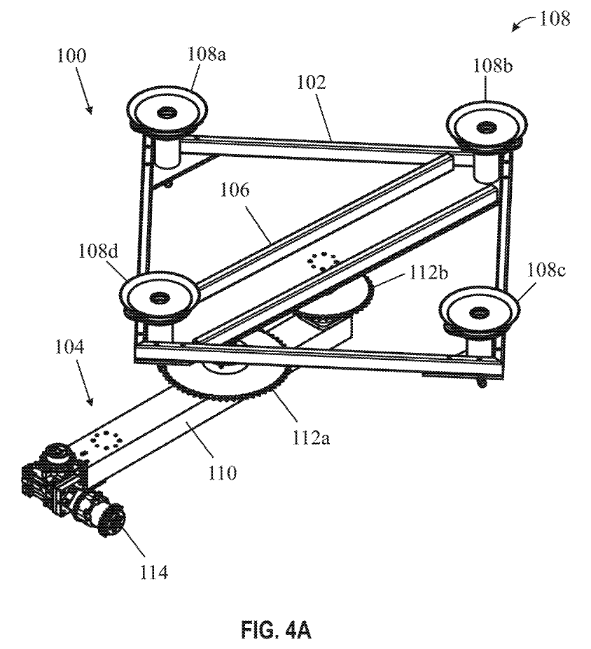

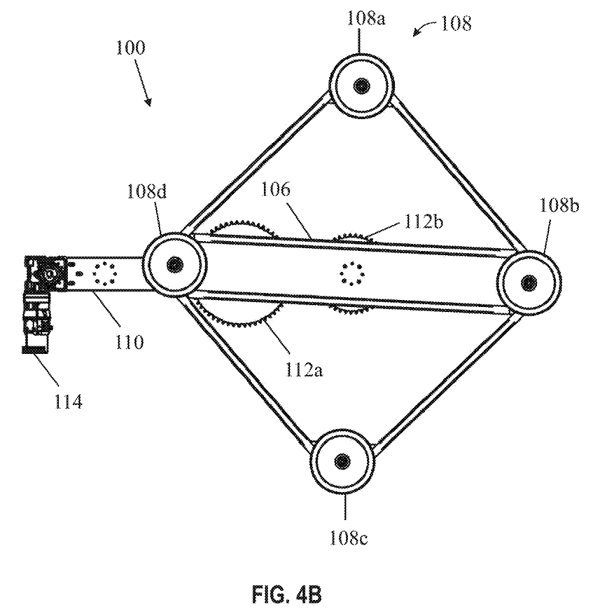

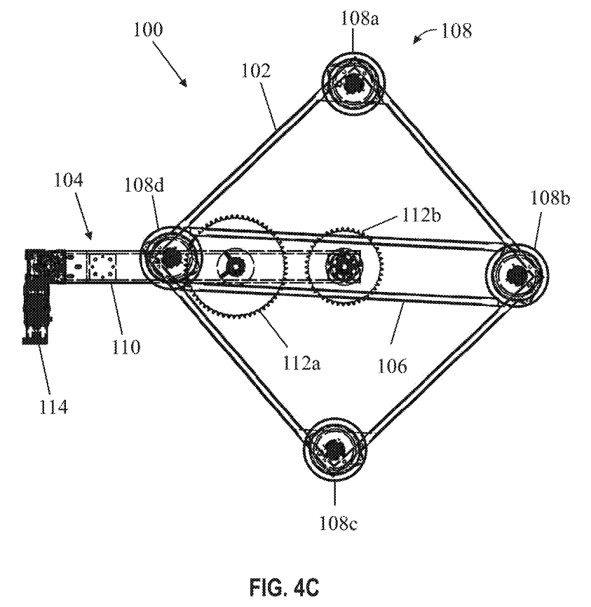

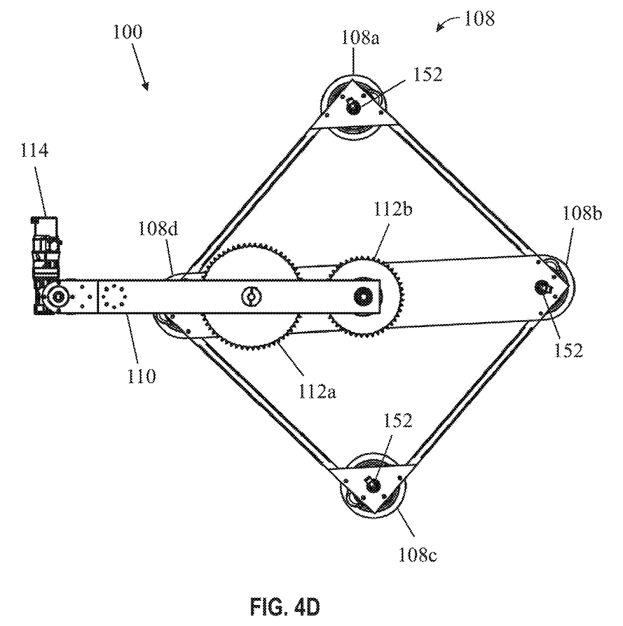

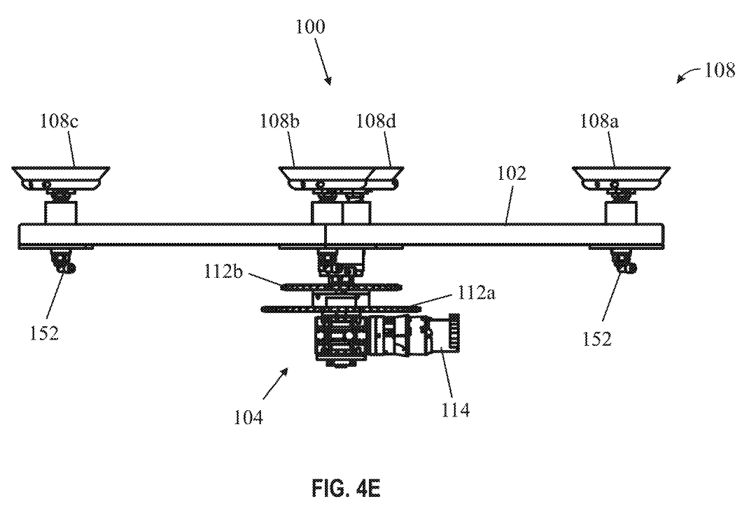

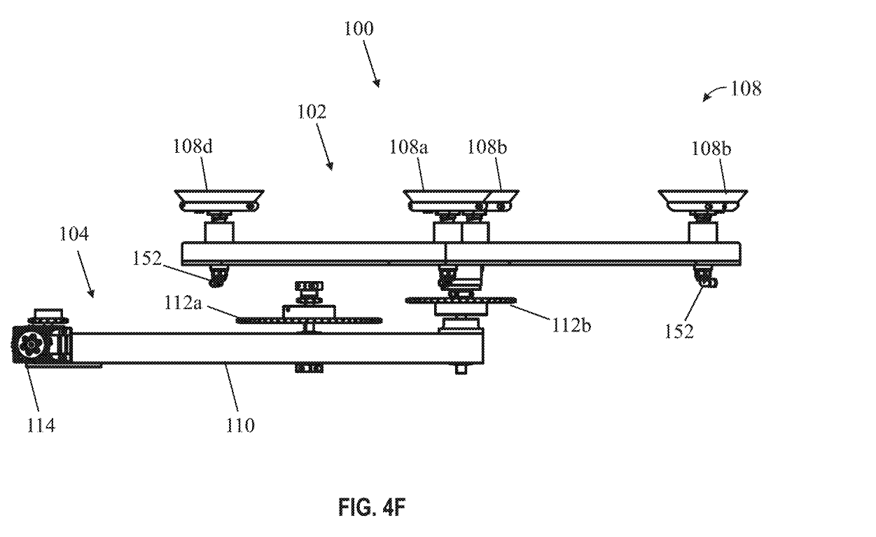

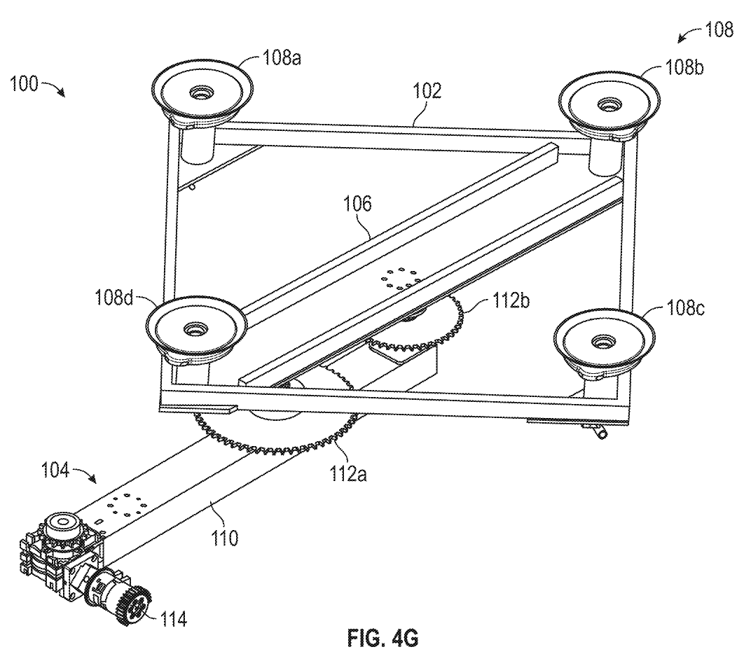

Referring now to FIGS. 4A-4G, illustrated are various views of a gripper assembly 100 (e.g., a vacuum-actuated end effector, suction-based gripping tool, panel retention head, vacuum pickup assembly, etc.), in accordance with one or more implementations. The gripper assembly 100 can be an example of the gripper assembly 1003 and/or the gripper assembly 1003 can include the gripper assembly 100. The gripper assembly 100 can include a frame structure 102 (e.g., frame, etc.) and a frame mounting structure 104 (e.g., first frame mounting structure, frame mount, etc.). The frame structure 102 can serve as a distal, object-engaging portion of the gripper assembly 100 and can carry a plurality of suction cups 108 (e.g., vacuum cups, suction pads, pneumatic adhesion discs, vacuum retention elements, etc.) that contact and retain a solar panel or other planar object. The frame mounting structure 104 can serve as a proximal region that interfaces with a robotic arm or other manipulator and that houses or provides structural mounting for rotational components of the gripper assembly 100. The frame structure 102 can be rotatably coupled to the frame mounting structure 104 such that the frame structure 102 rotates relative to the frame mounting structure 104 about a rotational axis. This rotational coupling can enable the gripper assembly 100 to reorient a grasped object without requiring repositioning of the robotic arm itself. The frame mounting structure 104 can include a plurality of interconnected sidewalls defining an interior volume that accommodates the actuation system and rotational components of the gripper assembly 100.

As shown in FIG. 4A, the gripper assembly 100 can include a support beam 106 (e.g., crossbar, etc.) that extends across the frame structure 102. The support beam 106 can be a diagonal or transverse structural element that contributes to the rigidity of the frame structure 102 and maintains dimensional stability during panel handling operations. In some implementations, the support beam 106 can span between opposing corners or between opposing sides of the frame structure 102, forming a cross-brace that distributes mechanical loads across the frame and resists deflection when the gripper assembly 100 is retaining a solar panel or other planar object. The support beam 106 can be formed from carbon fiber, metal, composite material, or a combination thereof. In some implementations, the support beam 106 can be integrally formed with other members of the frame structure 102, while in other implementations, the support beam 106 can be a discrete structural member that is fastened, bonded, or otherwise affixed to the perimeter members of the frame structure 102.

In some implementations, the plurality of suction cups 108 can include a first suction cup 108a, a second suction cup 108b, a third suction cup 108c, and a fourth suction cup 108d. These suction cups 108 can be positioned at or near respective corners of the frame structure 102 and can be arranged in a rectangular arrangement. The rectangular arrangement can distribute contact forces across a broad area of the solar panel surface, which can reduce localized stress concentrations and can reduce the risk of damage to fragile panel substrates during lifting and transport operations. In some implementations, the suction cups 108 can be positioned at locations that are inboard from the corners of the frame structure 102 by a predetermined distance, such that the suction cups 108 contact a solar panel at positions that are spaced from the panel edges. In some implementations, the positions of the suction cups 108 can be selected based on the dimensions and geometry of the solar panels intended to be retained, such that the contact points avoid regions of the panel that are susceptible to mechanical stress or that include protruding features on the rear surface of the panel. Each suction cup 108 can be mounted to the frame structure 102 via a suction cup mount 152 (e.g., a suction cup bracket, vacuum pad holder, retention cup fitting, pneumatic cup seat, etc.) that includes a port fluidly connecting the suction cup 108 to a vacuum source (e.g., vacuum source 1012, etc.). In some implementations, a first subset of the plurality of suction cups 108 can be fluidly coupled to a first vacuum source through a first vacuum line, and a second subset of the plurality of suction cups 108 can be fluidly coupled to a second vacuum source through a second vacuum line separate from the first vacuum line, such that each vacuum source can be individually sufficient to maintain coupling of a solar panel to the gripper assembly 100 via its respective subset of suction cups 108 independent of the other vacuum source.

The gripper assembly 100 can include a member 110 (e.g., a shaft, axle, spindle, rotary rod, rotational coupling member, bar member, etc.) that extends along or across the frame mounting structure 104. The member 110 can be an elongate structural element, such as a rectangular bar member, a channel member, or an extruded profile, that provides a mounting platform for one or more components of the actuation system. For example, the member 110 can carry a gear system that includes a first gear 112a (e.g., a first toothed wheel, spur gear, drive gear, rotary transmission element, etc.) and a second gear 112b (e.g., a second toothed wheel, spur gear, driven gear, pinion, etc.). The first gear 112a and the second gear 112b can be mounted on or along the member 110 in a spaced arrangement. In some implementations, the member 110 can include bearing seats, shaft mounts, or mounting bosses at positions corresponding to the rotational axes of the first gear 112a and the second gear 112b. The member 110 can be formed from metal, such as aluminum or steel, or from a composite material, and can be dimensioned to receive the mechanical loads transmitted through the gear system during frame rotation.

An actuator 114 (e.g., a servomotor, rotary drive, torque generator, electric rotary actuator, etc.) can be mechanically coupled to the gear system and can be positioned at or near one end of the frame mounting structure 104. The actuator 114 can drive rotation of the frame structure 102 via the gear system. In some implementations, the actuator 114 can include a servo motor, a brushless DC motor, a high-torque motor, an integrated actuator and gearbox unit, or a direct-drive motor. In some implementations, the actuator 114 can be a stepper motor or a rotary actuator that provides precise angular control. The actuator 114 can be mounted to a sidewall of the frame mounting structure 104. The actuator 114 can provide rotational torque to the first gear 112a, which in turn can mesh with or otherwise transmit rotational motion to the second gear 112b. The second gear 112b can be coupled to the frame structure 102 or to a rotational shaft that is coupled to the frame structure 102, such that rotation of the second gear 112b causes corresponding rotation of the frame structure 102 relative to the frame mounting structure 104. In some implementations, the actuator 114 can include an output pinion or drive gear that meshes with the first gear 112a, or the actuator 114 can be coupled to the first gear 112a via a keyed shaft, a splined connection, or a coupling hub. The gear system can transmit torque from the actuator 114 to the frame structure 102 at a gear ratio determined by the relative sizes of the first gear 112a and the second gear 112b, enabling the actuator 114 to control the angular position, speed, and torque at the frame structure 102 during panel manipulation. In some implementations, the actuator 114 can be coupled to the rotational shaft without an intermediate gear system in a direct-drive arrangement, such that the shaft of the actuator 114 itself serves as the rotational shaft.

Referring now to FIG. 4B, illustrated is a plan view of the gripper assembly 100, in accordance with one or more implementations. As shown in FIG. 4B, the support beam 106 can extend across the frame structure 102 in a diagonal orientation relative to the outer perimeter of the frame structure 102. The support beam 106 can provide additional structural reinforcement that resists torsional and bending loads experienced during panel handling. In some implementations, the support beam 106 can extend between diagonally opposite corners of the frame structure 102, forming a diagonal strut that triangulates the frame geometry and increases the torsional stiffness of the frame structure 102. In some implementations, the frame structure 102 can include two or more diagonal structural elements that intersect at or near the center of the frame, forming an X-shaped bracing pattern.

The first suction cup 108a, the second suction cup 108b, the third suction cup 108c, and the fourth suction cup 108d can be positioned at the four corner regions of the frame structure 102 in a diamond arrangement when viewed from above. In this view, the diamond arrangement can be understood as a rotation of the rectangular arrangement, with suction cups 108 positioned at the top, bottom, left, and right extremities of the frame when viewed in plan. The member 110 can extend outward from the frame structure 102 toward the actuator 114, carrying the first gear 112a and the second gear 112b along its length. In some implementations, the first gear 112a can have a larger diameter than the second gear 112b, which can provide a gear reduction that increases torque output at the frame structure 102 while reducing rotational speed. In other implementations, the relative diameters of the first gear 112a and the second gear 112b can be reversed or can be equal, depending on the torque and speed characteristics desired for a given application. For example, equal-diameter gears can provide a one-to-one gear ratio that preserves the output speed of the actuator 114 without torque amplification, while a gear arrangement in which the second gear 112b has a larger diameter than the first gear 112a can provide a speed increase at the output at the expense of reduced torque.

Referring now to FIG. 4C, illustrated is another plan view of the gripper assembly 100, in accordance with one or more implementations. As depicted in FIG. 4C, the frame mounting structure 104 can extend laterally from the frame structure 102 and can serve as an attachment point for coupling the gripper assembly 100 to a robotic arm, a manipulator, or another automated handling system. The frame mounting structure 104 can include one or more mechanical interfaces, such as attachment flanges, bolt holes, recessed channels, quick-release connectors, or dovetail joints, that facilitate secure mounting of the gripper assembly 100 to the distal end of the robotic arm. In some implementations, the frame mounting structure 104 can include a tool plate or adapter for compatibility with robotic arm end-effector interfaces, such as flanges or adapters. The arrangement of the suction cups 108, the member 110, and the gear system including the first gear 112a and the second gear 112b can cooperate to enable controlled rotational movement and positioning of objects retained by the gripper assembly 100. The support beam 106 can be visible in this view extending across the interior of the frame structure 102, providing a structural cross-brace that can maintain the planar geometry of the frame structure 102 under loading conditions encountered during panel pickup and transport. In some implementations, the support beam 106 can serve as a cable or tubing routing path, with vacuum lines or electrical wiring secured along the length of the support beam 106 to maintain an organized routing arrangement within the frame structure 102.

Referring now to FIG. 4D, illustrated is a plan view of the gripper assembly 100 showing suction cup mounts 152, in accordance with one or more implementations. As shown in FIG. 4D, the gripper assembly 100 can include suction cup mounts 152 for attaching the suction cups 108 to the frame structure 102. Each of the suction cup mounts 152 can provide a secure mechanical connection between a respective suction cup 108 and the frame structure 102. The suction cup mounts 152 can be positioned at the corner regions of the frame structure 102, corresponding to the locations of the first suction cup 108a, the second suction cup 108b, the third suction cup 108c, and the fourth suction cup 108d. Each suction cup mount 152 can include a base portion that attaches to the frame structure 102 and an upper portion that receives and retains the corresponding suction cup 108. In some implementations, the base portion can be bolted, riveted, welded, or adhesively bonded to a surface of the frame structure 102, and the upper portion can include a socket, a collar, a threaded receiver, or a snap-fit interface that mechanically captures the suction cup 108. Each suction cup mount 152 can include a port that fluidly connects the suction cup 108 to a vacuum source via a vacuum line routed along or through the frame structure 102. The suction cup mounts 152 can incorporate a degree of flexibility or adjustability, allowing the suction cups 108 to move and adjust their position relative to the frame structure 102. This adjustability can enable the suction cups 108 to accommodate variations in the surface geometry of solar panels or other objects being gripped by the gripper assembly 100. In some implementations, each suction cup mount 152 can include a compliant element, such as a coil spring, an elastomeric bushing, or a rubber boot, that provides vertical compliance and permits the suction cup 108 to deflect toward or away from the frame structure 102 within a predetermined travel range.

In some implementations, the suction cup mounts 152 can include articulation points or flexible joints that permit limited movement in multiple directions. For example, each suction cup mount 152 can include a ball-and-socket joint, a gimbal-type connection, a spring-loaded pivot, a universal joint, or a compliant elastomeric coupling that allows the corresponding suction cup 108 to tilt, swivel, or translate along one or more axes relative to the frame structure 102. This multi-axis movement capability can allow each suction cup 108 to independently adjust its level and orientation when brought into contact with a target surface. In some implementations, each suction cup mount 152 can permit angular deflection of up to about 5 degrees, about 10 degrees, about 15 degrees, or about 20 degrees, among others, from a neutral position, and can permit vertical translation of up to about 5 mm, about 10 mm, about 15 mm, or about 20 mm, among others. Such adaptability can be beneficial when retaining solar panels or other objects that do not have flat or uniform surfaces. For example, when grasping the rear side of a solar panel, the surface can include raised junction boxes, protruding electrical leads, adhesive pads, label stickers, or other irregularities that form a non-planar contact surface. The compliant suction cup mounts 152 can allow each suction cup 108 to self-level and maintain a seal against the panel surface despite these local variations in surface topology. In some implementations, the suction cup mounts 152 can include a spring return that biases the suction cup 108 toward a neutral position when no external contact force is applied, which can facilitate consistent initial engagement across successive pick-and-place cycles.

The ability of the suction cups 108 to self-adjust via the suction cup mounts 152 can extend the versatility of the gripper assembly 100 across a range of panel types and surface conditions. In some implementations, this feature can allow the gripper assembly 100 to maintain a secure grip on panels with slight warping, manufacturing variations, thermal distortion, or other minor surface irregularities. The independent adjustment of each suction cup 108 can distribute the gripping force across the panel surface in a manner that reduces the risk of localized stress concentrations. Distributing the gripping force can be beneficial for fragile solar panel substrates, which can be susceptible to cracking or microcracking under concentrated loads. In some implementations, the suction cup mounts 152 can include a self-leveling feature in which the suction cup 108 passively returns to a neutral orientation when not in contact with a panel surface, which can facilitate repeatable and consistent engagement across successive pick-and-place cycles. In some implementations, each suction cup mount 152 can include a vacuum port or fluid passage that extends through the mount body and fluidly connects the suction cup 108 to a vacuum line routed along or through the frame structure 102. This integrated vacuum routing can simplify the tubing layout and can reduce the number of external tubing connections within the gripper assembly 100.

Referring now to FIG. 4E, illustrated is a front elevational view of the gripper assembly 100, in accordance with one or more implementations. As shown in FIG. 4E, the frame structure 102 can extend laterally and can carry the first suction cup 108a, the second suction cup 108b, the third suction cup 108c, and the fourth suction cup 108d at distributed positions along its span. The suction cup mounts 152 can be visible below the frame structure 102, coupling each suction cup 108 to the frame. In some implementations, the suction cup mounts 152 can include compliant spring elements that are visible in the front elevational view as coiled or compressed springs disposed between the suction cup 108 body and the frame surface. The frame mounting structure 104 can be positioned below the frame structure 102 in this view and can include the first gear 112a and the second gear 112b disposed within or adjacent to the frame mounting structure 104. The actuator 114 can be visible at one side of the frame mounting structure 104. The arrangement of the frame structure 102, with suction cups 108 distributed at spaced intervals, can provide multiple contact points when gripping objects. This distributed contact arrangement can contribute to the stability of the gripper assembly 100 during operation by mitigating the grasped panel from tilting or shifting during rotation and transport. The front elevational view can illustrate the relative vertical separation between the frame structure 102 and the frame mounting structure 104, which can be defined by a rotational shaft or axle that couples the two structures and permits relative rotation therebetween. In some implementations, the vertical separation can be selected to provide clearance for the gear system and the rotational shaft while maintaining a compact overall profile for the gripper assembly 100. In some implementations, the vertical separation between the frame structure 102 and the frame mounting structure 104 can be about 20 mm, about 40 mm, about 60 mm, or about 80 mm, among others, depending on the dimensions of the gear system and the rotational shaft.

Referring now to FIG. 4F, illustrated is a side elevational view of the gripper assembly 100, in accordance with one or more implementations. As depicted in FIG. 4F, the frame structure 102 can be visible as an elongate horizontal element carrying the first suction cup 108a, the second suction cup 108b, and the fourth suction cup 108d at spaced positions along its length, each mounted via respective suction cup mounts 152. The member 110 can extend below the frame structure 102, and the first gear 112a and the second gear 112b can be visible along the member 110. The actuator 114 can be positioned at the end of the frame mounting structure 104 opposite the gear system. In some implementations, the frame structure 102 can be constructed from carbon fiber or another composite material, such as fiberglass, aramid fiber, or a hybrid composite laminate. The carbon fiber construction can provide a high stiffness-to-weight ratio, which can reduce the payload burden on the robotic arm and can improve the dynamic response of the robotic system during rapid pick-and-place operations. In some implementations, the gripper assembly 100 can incorporate cushioning elements or compliant pads at the interface between the suction cups 108 and the frame structure 102, which can further reduce the risk of panel fractures during handling. The gripper assembly 100 can achieve millimeter-level precision in grasping and placing solar panels, which can be beneficial for delicate photovoltaic modules where dimensional accuracy during installation affects both structural fitment and electrical connectivity. The side elevational view of FIG. 4F can illustrate the spatial relationship between the first gear 112a and the second gear 112b, showing how the two gears can be spaced along the member 110 and can mesh at a tangential point between their toothed perimeters. In some implementations, the first gear 112a can be positioned closer to the junction between the frame mounting structure 104 and the frame structure 102, while the second gear 112b can be positioned closer to the actuator 114, or vice versa, depending on the specific gear train layout.

Referring now to FIG. 4G, illustrated is a perspective view of the gripper assembly 100, in accordance with one or more implementations. As shown in FIG. 4G, the frame structure 102 can be visible as a rectangular frame carrying the first suction cup 108a, the second suction cup 108b, the third suction cup 108c, and the fourth suction cup 108d at its four corners. The support beam 106 can extend diagonally across the interior of the frame structure 102, providing structural bracing. The frame mounting structure 104 can extend from one side of the frame structure 102 and can carry the member 110, the first gear 112a, the second gear 112b, and the actuator 114. The perspective view of FIG. 4G can illustrate the three-dimensional spatial relationship among the frame structure 102, the frame mounting structure 104, and the gear system. In some implementations, the frame structure 102 can be formed from carbon fiber frame members having a woven or layered composite construction that can be visible as a textured surface in the perspective view. The woven carbon fiber construction can include a twill weave, a plain weave, or a unidirectional fiber layup, depending on the mechanical properties and manufacturing approach selected for the frame. The arrangement of the actuator 114 working in conjunction with the gear system and the member 110 can enable controlled rotational movement of the frame structure 102 and the attached suction cups 108 relative to the frame mounting structure 104. This arrangement can provide the gripper assembly 100 with the capability to perform rotational maneuvers while maintaining a secure grip on objects being retained, such as solar panels being transferred from a pallet to a mounting structure. In some implementations, the gripper assembly 100 can rotate the frame structure 102 while the robotic arm is stationary, while the robotic arm is in motion, or during a combined motion sequence in which both the robotic arm and the frame structure 102 are simultaneously repositioned.

In some implementations, the actuator 114 can generate rotational torque that is transmitted through the gear system to rotate the frame structure 102 about an axis that is perpendicular to the plane of the frame structure 102. The gear system can include meshing spur gears, as illustrated in FIGS. 4A-4G or can include other gear types such as worm gears, harmonic gearing, planetary gears, or belt-driven or chain-driven transmission elements. The selection of gear type can depend on the torque, speed, backlash, and packaging constraints of a particular implementation. For example, spur gears can provide a compact and straightforward meshing arrangement with a defined gear ratio, worm gears can provide a self-locking characteristic that resists back driving under external loads, harmonic gearing can provide high gear ratios in a compact envelope with reduced backlash, and planetary gears can provide high torque density in a coaxial arrangement. Belt-driven or chain-driven arrangements can accommodate larger center-to-center distances between the driving and driven elements and can provide flexibility in routing the transmission path around other components within the frame mounting structure 104. In some implementations, the first gear 112a can have a larger pitch diameter than the second gear 112b, which can provide a gear reduction ratio that increases the output torque available at the frame structure 102 while decreasing the rotational speed. This torque amplification can be beneficial when the gripper assembly 100 is carrying a heavy solar panel and the rotational actuation system is tasked with overcoming the inertial and gravitational loads of the panel during rotation. In some implementations, the gear ratio between the first gear 112a and the second gear 112b can be about 2:1, about 3:1, about 4:1, about 5:1, about 10:1, about 75:1, or about 300:1, among others, depending on the torque and speed constraints of the application.

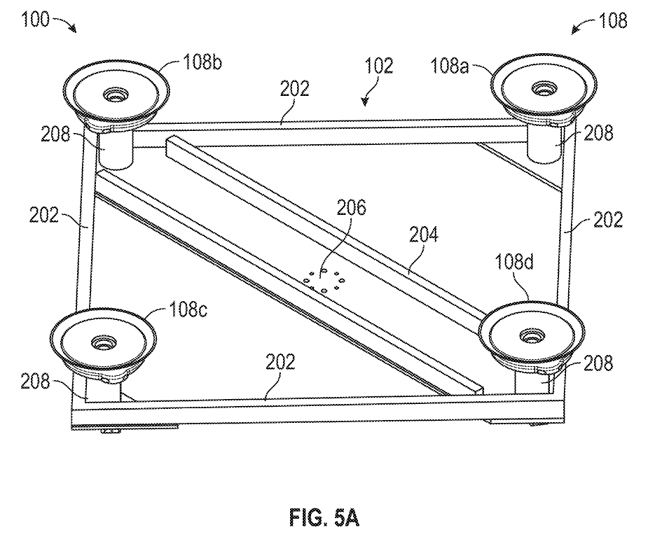

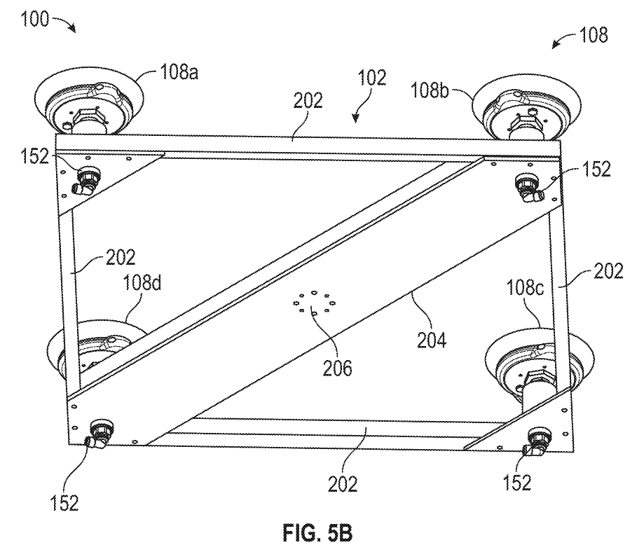

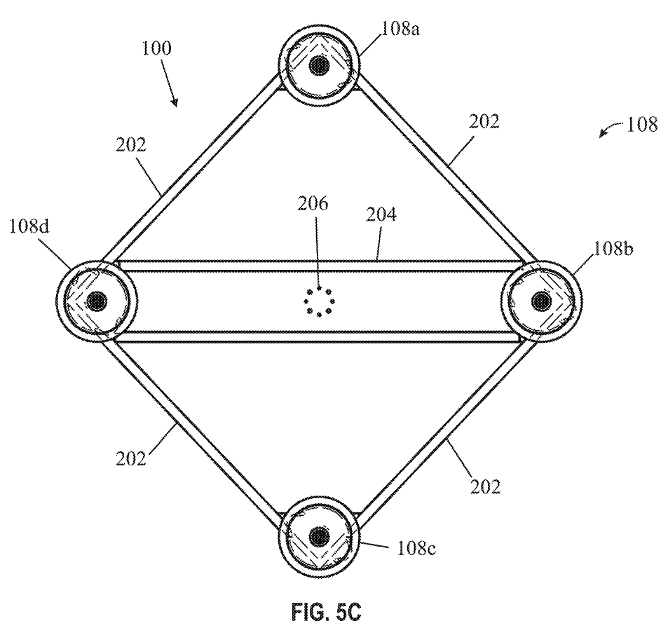

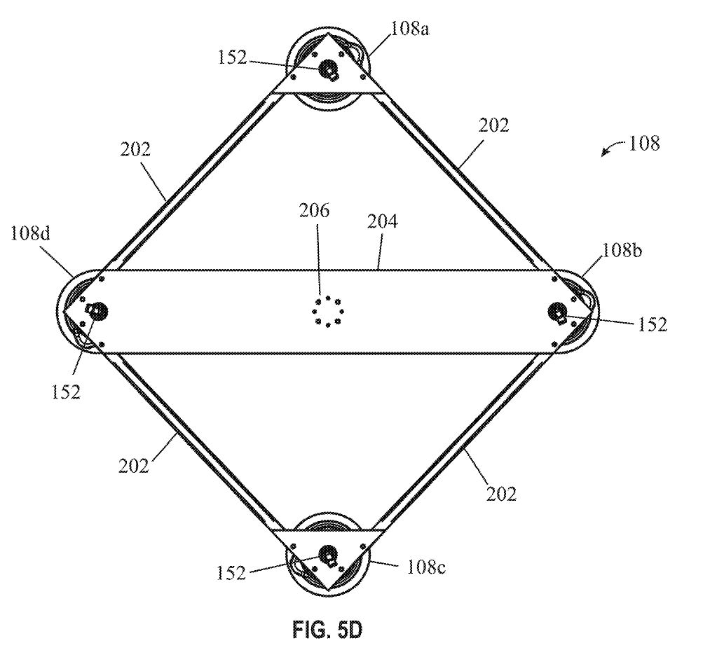

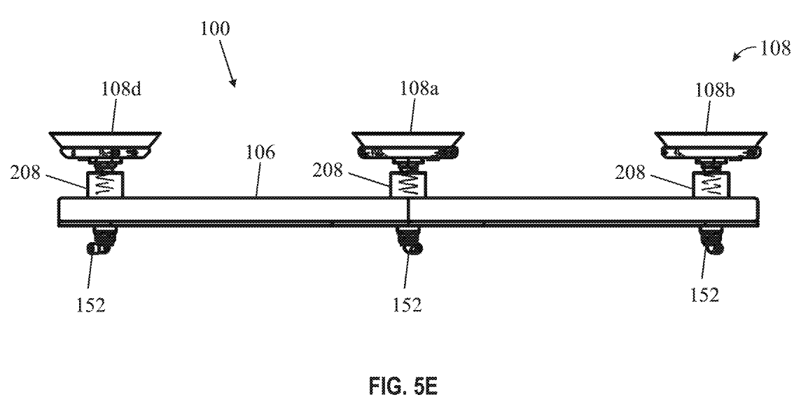

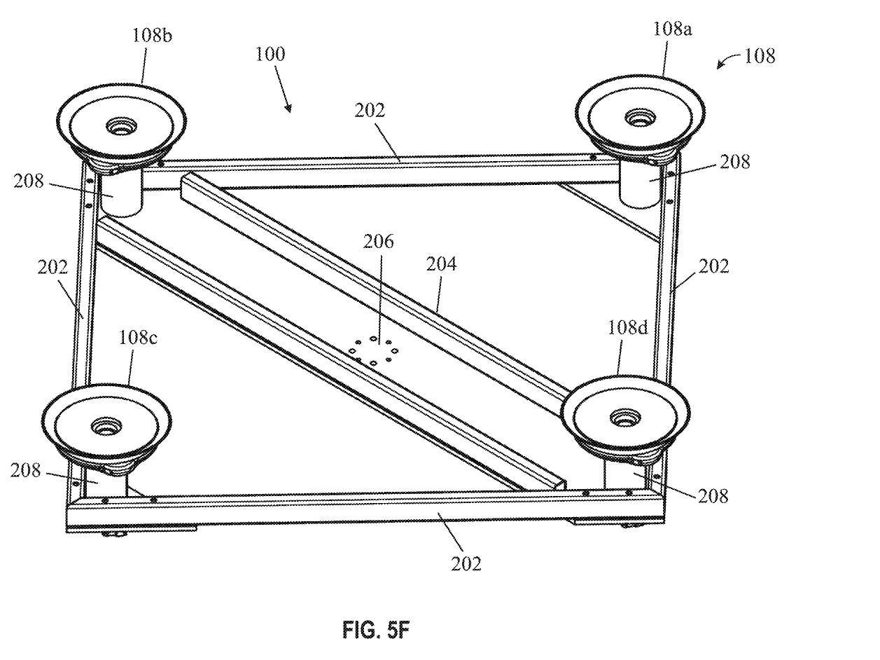

Referring now to FIGS. 5A-5F, illustrated are various views of the gripper assembly 100 with a carbon fiber frame, in accordance with one or more implementations. As shown in FIG. 5A, the gripper assembly 100 can include a carbon fiber frame member 202 (e.g., a perimeter rail, edge extrusion, border beam, boundary bar, etc.) that forms a structural base for the assembly. The carbon fiber frame member 202 can include a plurality of carbon fiber frame members arranged in a rectangular or other polygonal geometry. In some implementations, the carbon fiber frame member 202 can include four perimeter members that define the outer boundary of a rectangular frame, with the members joined at their ends by corner brackets, adhesive bonds, mechanical fasteners, or interlocking joints. The carbon fiber frame member 202 can provide a lightweight yet rigid foundation for the gripper assembly 100, which can reduce the overall mass of the end effector and can improve the reach, payload capacity, and dynamic performance of the robotic arm to which the gripper assembly 100 is attached. In some implementations, the carbon fiber frame member 202 can have an overall length of about 500 mm to about 2000 mm and an overall width of about 300 mm to about 1500 mm, depending on the dimensions of the solar panels intended to be retained. The cross-sectional profile of each carbon fiber frame member can be rectangular, square, circular, or tubular, and the wall thickness can be selected based on the structural loading constraints of the particular application.

The gripper assembly 100 can include a plurality of suction cups 108 mounted to the carbon fiber frame member 202. In some implementations, the plurality of suction cups 108 can include the first suction cup 108a, the second suction cup 108b, the third suction cup 108c, and the fourth suction cup 108d. These suction cups 108 can be positioned at or near each corner of the carbon fiber frame member 202 and can be arranged in a rectangular arrangement. The suction cups 108 can be mounted to the carbon fiber frame member 202 via suction cup mounts 208. Each of the suction cup mounts 208 can include a base flange, a cylindrical post, a threaded stud, or another mounting interface that couples the suction cup 108 to the carbon fiber frame member 202. In some implementations, the suction cup mounts 208 can include compliant elements such as springs, elastomeric bushings, bellows, or articulating joints that permit each suction cup 108 to self-level relative to the surface being grasped. In some implementations, each of the suction cup mounts 208 can include a fluid passage or port that provides a vacuum connection between the suction cup 108 and a vacuum line routed along the carbon fiber frame member 202. Mounting holes 206 can be incorporated into the carbon fiber frame member 202 at or near the center of the frame. The mounting holes 206 can define an area where the carbon fiber frame member 202 can be coupled to the frame mounting structure 104 or to a rotational shaft that passes through the frame and connects to the actuation system disposed in the frame mounting structure 104. In some implementations, the mounting holes 206 can include a reinforced plate, a hub insert, or a metal fitting bonded or mechanically fastened to the carbon fiber frame members, providing a durable interface for transferring rotational loads between the shaft and the frame.

Referring now to FIG. 5B, illustrated is a bottom perspective view of the gripper assembly 100, in accordance with one or more implementations. As shown in FIG. 5B, the carbon fiber frame member 202 can include a plurality of frame members that define the perimeter of the rectangular frame, with a cross member 204 extending diagonally across the carbon fiber frame member 202. The cross member 204 can provide additional structural reinforcement and can resist torsional deflection of the carbon fiber frame member 202 under loading. In some implementations, the cross member 204 can extend between two diagonally opposite corners of the carbon fiber frame member 202. In some implementations, two cross members can be provided in an X-shaped arrangement, with each beam extending between a respective pair of diagonally opposite corners. The cross member 204 can be formed of carbon fiber, which can further contribute to the lightweight and rigid characteristics of the gripper assembly 100. In some implementations, the cross member 204 can be formed from a different material, such as aluminum, steel, or fiberglass, where the stiffness characteristics of the diagonal member differ from those of the perimeter members. The suction cup mounts 152 can be visible on the underside of the carbon fiber frame member 202, illustrating how each suction cup 108 is mechanically coupled to the frame from below. The mounting holes 206 can be visible at or near the center of the carbon fiber frame member 202, indicating the region where the rotational shaft can pass through the frame to connect with the actuation system. In some implementations, the mounting holes 206 can include a hub, a flange, a reinforced plate, or a set of bolt holes that receive and secure the rotational shaft, establishing a rigid coupling between the shaft and the carbon fiber frame member 202 such that rotation of the shaft causes corresponding rotation of the entire frame. In some implementations, the mounting holes 206 can include a metal insert that is co-molded or secondarily bonded into the carbon fiber layup, providing a metal-to-metal interface for the shaft connection that can resist wear and fatigue over repeated rotational cycles.

Referring now to FIG. 5C, illustrated is a plan view of the gripper assembly 100 in a diamond arrangement, in accordance with one or more implementations. As depicted in FIG. 5C, the carbon fiber frame member 202 can be arranged such that the frame members form a diamond shape when viewed from above, with the first suction cup 108a positioned at the top vertex, the third suction cup 108c positioned at the bottom vertex, and the second suction cup 108b and fourth suction cup 108d positioned at the left and right vertices, respectively. The carbon fiber frame member 202 can include a plurality of interconnected frame members that extend between adjacent suction cup 108 locations, creating the diamond-shaped geometry. In some implementations, each frame member can extend between two adjacent vertices, forming four frame members that together define a rhombus or square shape when oriented in the diamond arrangement. A cross member 204 can extend horizontally across the midpoint of the diamond arrangement, connecting the left and right vertices. The mounting holes 206 can be positioned at or near the center of the diamond shape where the cross member 204 intersects the frame members. This diamond arrangement can provide an alternative suction cup 108 placement pattern that can be advantageous for certain panel geometries or for achieving a more symmetric load distribution during rotational operations. In some implementations, the diamond arrangement can distribute the suction cups 108 at positions that correspond to the midpoints of the edges of a rectangular solar panel, rather than at the corners, which can provide a different stress distribution pattern on the panel surface. The diamond arrangement can provide the gripper assembly 100 with a more balanced rotational inertia about the rotational axis, which can reduce the torque and power constraints of the actuator 114 during rapid angular repositioning.

Referring now to FIG. 5D, illustrated is a front view of the gripper assembly 100 in the diamond arrangement, in accordance with one or more implementations. As shown in FIG. 5D, the carbon fiber frame member 202 can be visible in elevation, with the suction cup mounts 152 coupling each of the first suction cup 108a, second suction cup 108b, third suction cup 108c, and fourth suction cup 108d to the frame members. The cross member 204 can extend transversely across the frame, and the mounting holes 206 can be visible at the central junction. This view can illustrate how the suction cup mounts 152 extend from the frame members and position the suction cups 108 at positions that can be offset from the plane of the frame. In some implementations, each suction cup mount 152 can include a vertical post or standoff that spaces the suction cup 108 away from the carbon fiber frame member 202 by a predetermined distance, which can provide clearance for the suction cup 108 to compress and form a seal against the panel surface without interference from the frame members. In some implementations, the standoff height can be about 10 mm, about 20 mm, about 30 mm, or about 50 mm, among others, depending on the depth of the suction cup 108 and the expected compression travel during engagement. In some implementations, the suction cup mounts 152 can include a pivot or articulation feature at the junction between the standoff and the frame member, which can allow the suction cup 108 to tilt relative to the frame when engaging non-planar surfaces.

Referring now to FIGS. 5E and 5F, illustrated are additional views of the gripper assembly 100, in accordance with one or more implementations. As shown in FIG. 5E, the support beam 106 can extend horizontally across the assembly, with the first suction cup 108a, the second suction cup 108b, and the fourth suction cup 108d mounted at spaced positions along the support beam 106 via respective suction cup mounts 208 and suction cup mounts 152. Each of the suction cup mounts 208 can include a compliant element, such as a spring, that can allow the corresponding suction cup 108 to translate vertically relative to the support beam 106. In some implementations, each suction cup mount 208 can include a coil spring disposed between the suction cup 108 body and the frame surface, with the spring set to compress when the suction cup 108 contacts the panel surface and to extend when the suction cup 108 is disengaged. The spring constant can be selected to provide sufficient compliance to accommodate surface irregularities while maintaining adequate preload to establish a vacuum seal. This compliance can enable each suction cup 108 to independently conform to local surface variations when the gripper assembly 100 is pressed against a solar panel. As shown in FIG. 5F, the gripper assembly 100 can be illustrated in a perspective view showing the carbon fiber frame member 202 with the cross member 204 extending diagonally across the frame, the mounting holes 206 positioned at the center of the frame, and the suction cup mounts 208 coupling the first suction cup 108a, the second suction cup 108b, the third suction cup 108c, and the fourth suction cup 108d to respective corners of the carbon fiber frame member 202. This arrangement can provide a stable gripping with the suction cups 108 positioned at distributed intervals along the frame perimeter. The perspective view of FIG. 5F can illustrate the three-dimensional profile of the suction cup mounts 208, showing how the compliant mounting elements project from the surface of the carbon fiber frame member 202 and position the suction cups 108 at an elevated position above the frame plane.

The use of carbon fiber for the carbon fiber frame member 202 can provide several benefits for the gripper assembly 100. Carbon fiber composite materials can exhibit a high strength-to-weight ratio, allowing the gripper assembly 100 to maintain structural integrity while minimizing overall mass. A lightweight frame construction can be advantageous in robotic systems for solar panel installation, where reducing the mass of the end effector can extend the effective reach of the robotic arm, can increase the allowable payload capacity, and can improve the dynamic response during rapid repositioning maneuvers. In some implementations, the carbon fiber frame member 202 can weigh less than a comparable frame formed from aluminum or steel while providing equivalent or greater rigidity. For example, a carbon fiber frame can weigh about 30 percent to about 70 percent less than an equivalent aluminum frame having similar bending and torsional stiffness characteristics. The reduced mass can decrease the inertial loads experienced by the rotational actuation system during frame rotation, which can allow a smaller or less powerful actuator 114 to be used while still achieving adequate rotational performance. In some implementations, the carbon fiber frame member 202 can be formed using a pultrusion process, a filament winding process, a hand layup process, or an autoclave-cured prepreg laminate process, depending on the production volume and the mechanical performance constraints of the application.

In some implementations, the gripper assembly 100 can be part of a system capable of lifting panels from pallets and positioning the panels onto mounting structures such as racking systems used in solar farm installations. The carbon fiber frame member 202 can contribute to the precision and stability of such operations by maintaining its planar geometry under load and by resisting deflection during transport and placement. The gripper assembly 100 can be incorporated into a robotic system that includes a mobile base. In some implementations, the mobile base can navigate autonomously or semi-autonomously within the installation site, using onboard navigation sensors, GPS, or pre-programmed path plans to reach the pallet location and the panel placement location.

The arrangement of the suction cups 108 in a rectangular or diamond arrangement on the carbon fiber frame member 202 can distribute contact forces across a broad area of the panel surface during gripping. This distributed contact arrangement can reduce the stress experienced at any individual suction cup 108 location, which can reduce the risk of damage to the panel during lifting and positioning operations. In some implementations, the spacing between the suction cups 108 can be selected based on the dimensions of the solar panel being retained, such that the suction cups 108 contact the panel at positions that are offset from fragile or sensitive regions of the panel. For example, the suction cups 108 can be spaced to avoid contact with the cells or busbars visible through the rear back sheet of the solar panel, or the suction cups 108 can be positioned at locations that are offset from the junction box and electrical lead regions of the panel. In some implementations, the suction cup 108 spacing can be adjustable, with the suction cup mounts 208 mounted to slotted tracks or sliding rails that allow the spacing to be modified to accommodate different panel sizes.

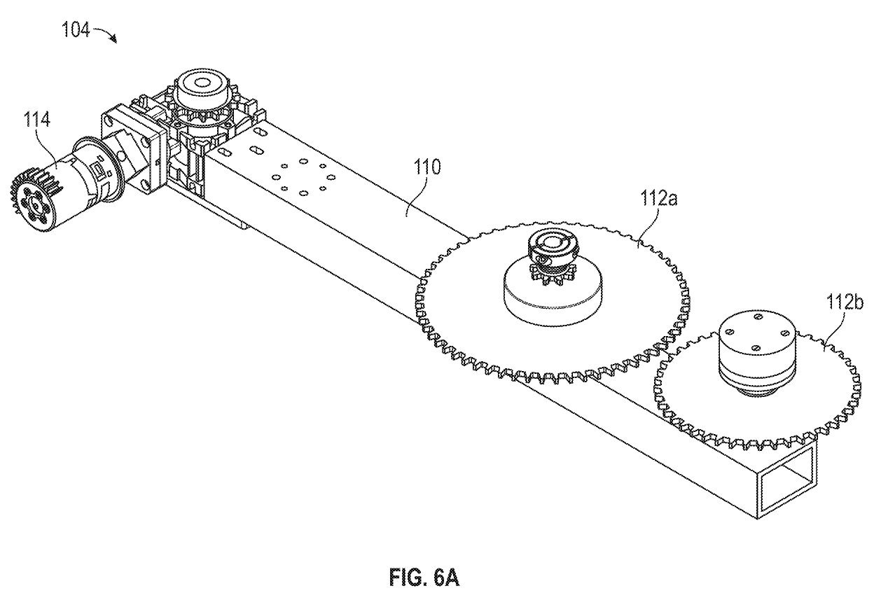

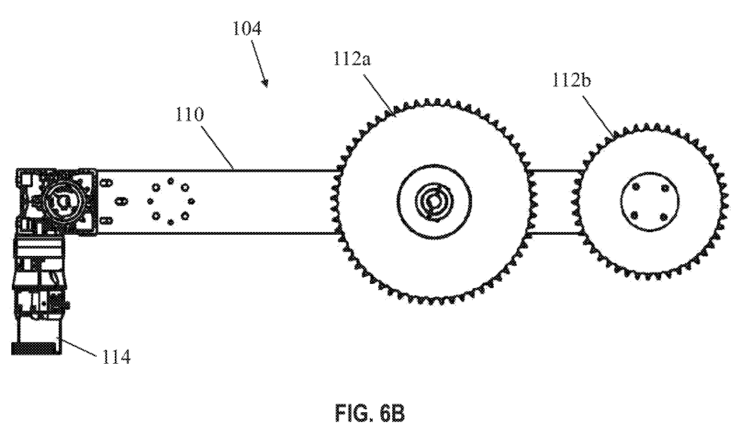

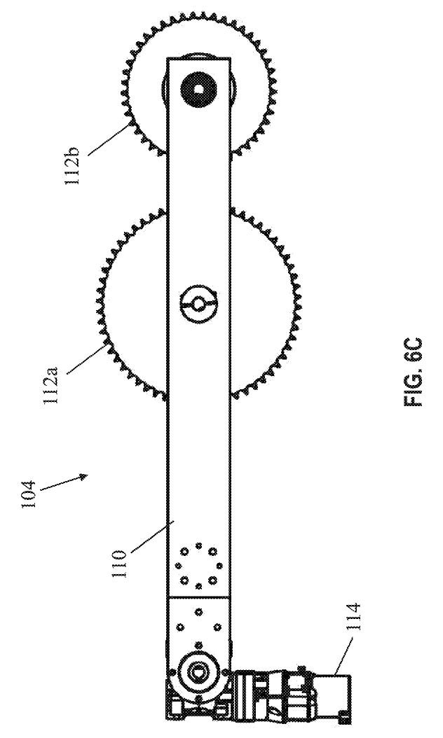

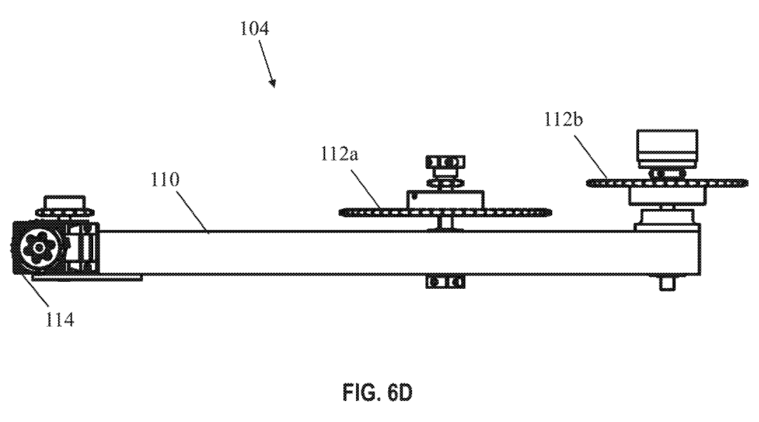

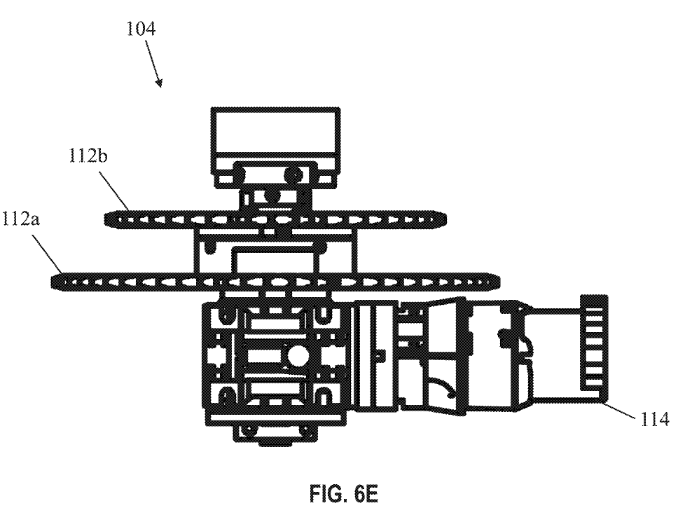

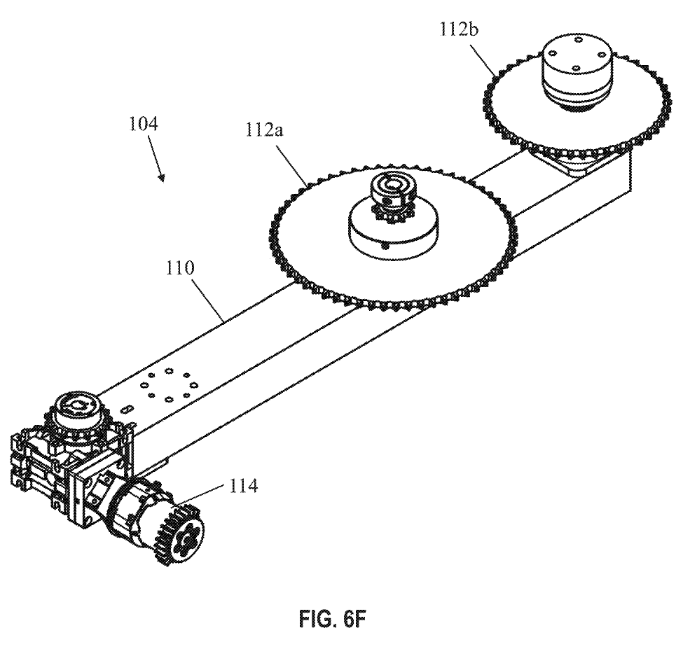

Referring now to FIGS. 6A-6F, illustrated are various views of a rotational actuation assembly of the gripper assembly 100, in accordance with one or more implementations. The rotational actuation assembly can include the frame mounting structure 104, the member 110, the first gear 112a, the second gear 112b, and the actuator 114. These components can cooperate to provide controlled rotational motion to the frame structure 102 of the gripper assembly 100. The rotational actuation assembly can be a subassembly of the gripper assembly 100 that is preassembled and integrated with the frame structure 102, or the components of the rotational actuation assembly can be individually assembled during the fabrication of the gripper assembly 100.

As shown in FIG. 6A, the frame mounting structure 104 can extend longitudinally and can serve as a base structure for the rotational actuation assembly. The member 110 can be positioned along the length of the frame mounting structure 104 and can serve as a structural spine for the assembly. In some implementations, the member 110 can be a machined or extruded member having a planar upper surface and a planar lower surface, with mounting features such as holes, slots, or threaded inserts disposed along its length. The first gear 112a and the second gear 112b can be mounted on or along the member 110 at spaced positions. The actuator 114 can be positioned at one end of the frame mounting structure 104 and can be mechanically coupled to the gear system to provide rotational driving force. In some implementations, the first gear 112a can have a larger diameter than the second gear 112b, and both gears can include toothed perimeters for meshing engagement. The actuator 114 can include a drive gear or a drive pinion that interfaces with the first gear 112a or with an intermediate gear to transmit rotational motion. This arrangement can enable the actuator 114 to transmit torque through the gear system to cause controlled rotation of the frame structure 102. In some implementations, the first gear 112a can include a central bore or hub that is keyed or splined to a shaft by bearings in the member 110, and the second gear 112b can include a similar central bore or hub that is keyed or splined to the rotational shaft that couples to the frame structure 102. The perspective view of FIG. 6A can illustrate the three-dimensional arrangement of the gear system, including the relative heights and axial positions of the first gear 112a and the second gear 112b along the member 110.

Referring now to FIG. 6B, illustrated is a side elevational view of the rotational actuation assembly, in accordance with one or more implementations. As shown in FIG. 6B, the member 110 can extend horizontally from the actuator 114 toward the first gear 112a and the second gear 112b. The first gear 112a can be larger in diameter than the second gear 112b, and both gears can feature teeth around their respective circumferences. The first gear 112a can mesh with the second gear 112b, such that rotation of one gear causes corresponding rotation of the other gear. The gear ratio defined by the relative diameters of the first gear 112a and the second gear 112b can determine the torque multiplication and speed reduction applied to the rotational output. In some implementations, the actuator 114 can drive the first gear 112a through the member 110, and the second gear 112b can be coupled to the frame structure 102 via a rotational shaft or a coupler. The rotational shaft can extend from the second gear 112b in a direction perpendicular to the plane of the frame structure 102. In some implementations, the rotational shaft can be received by one or more bearings, such as ball bearings, roller bearings, or plain bushings, that are mounted to the member 110 or to the frame mounting structure 104. The bearings can be positioned independently of the actuator 114 such that the bearings carry the structural loads imposed by the weight of the frame structure 102 and any attached solar panel, while the actuator 114 is isolated from these structural loads and provides rotational torque. This load isolation arrangement can prolong the service life of the actuator 114 and can reduce the bearing constraints on the motor output shaft.

In some implementations, the frame structure 102 can be rotatably coupled to the frame mounting structure 104 via a chain-driven or belt-driven gear system. In such implementations, the actuator 114 can drive multiple gears via a belt, chain, or other flexible transmission element. One gear, such as the second gear 112b, can be coupled to the frame structure 102 such that the actuator 114 drives rotation of the frame structure 102 via the gear system and the flexible transmission element. For example, the second gear 112b can be coupled to the frame structure 102 via a coupler, a hub, or a keyed shaft connection that transfers rotational motion from the gear to the frame. In some implementations, the belt can be a toothed timing belt, a flat belt, a V-belt, or a poly-V belt, and the chain can be a roller chain or a silent chain. The belt-driven or chain-driven arrangement can accommodate larger center-to-center distances between the driving and driven shafts, which can provide greater flexibility in the layout of the rotational actuation assembly within the frame mounting structure 104.

In some implementations, the actuator 114 can drive the gear system through the member 110, enabling controlled rotational movement through the gear reduction provided by the different-sized gears. This arrangement can allow for precise control of the rotational speed and torque applied to the gripper assembly 100. The gear reduction can enable the gripper assembly 100 to rotate a heavy solar panel with a controlled angular velocity that permits accurate placement and alignment. In some implementations, the gear reduction can increase the holding torque at the frame structure 102, which can maintain the angular position of the frame when the actuator 114 is not energized or when external forces are applied to the grasped panel during placement.

Referring now to FIG. 6C, illustrated is another side elevational view of the rotational actuation assembly, in accordance with one or more implementations. As depicted in FIG. 6C, the member 110 can extend horizontally across the assembly, and the frame mounting structure 104 can be positioned at one end. The first gear 112a and the second gear 112b can be mounted along the member 110, with the first gear 112a having a larger diameter than the second gear 112b. Both gears can feature toothed perimeters for mechanical engagement. The member 110 can extend through or adjacent to both gears and can provide structural mount for the gear shafts and bearings. The frame mounting structure 104 can serve as a structural connection point for integrating the rotational actuation assembly with other components of the gripper assembly 100 and with the robotic arm. In some implementations, the side elevational view of FIG. 6C can illustrate the gear teeth in profile, showing the tooth geometry and the meshing interface between the first gear 112a and the second gear 112b. The tooth profile can be involute, cycloidal, or another geometry selected to minimize backlash and to provide smooth torque transfer during rotation.

Referring now to FIG. 6D, illustrated is a side elevational view of the rotational actuation assembly, in accordance with one or more implementations. As shown in FIG. 6D, the member 110 can extend horizontally across the structure, and the frame mounting structure 104 can be positioned along the lower portion of the assembly. The first gear 112a and the second gear 112b can be positioned at different locations along the member 110, with the first gear 112a situated between the actuator 114 and the second gear 112b. This view can illustrate how the second gear 112b can include or can be mounted on a hub or shaft extension that projects upward from the member 110 to couple with the frame structure 102. In some implementations, the hub or shaft extension of the second gear 112b can include a flanged plate, a keyed shaft section, or a splined interface that mates with a corresponding feature at the mounting holes 206 of the carbon fiber frame member 202. In some implementations, this arrangement can allow for rotational motion to be transmitted from the actuator 114 through the gear system along the member 110 to the frame structure 102. The arrangement can enable the rotational actuation assembly to provide controlled rotation to the gripper assembly 100, facilitating precise angular positioning of solar panels during installation.

Referring now to FIGS. 6E and 6F, illustrated are additional views of the rotational actuation assembly, in accordance with one or more implementations. As shown in FIG. 6E, the frame mounting structure 104 can be visible in an end view, with the first gear 112a and the second gear 112b arranged in a vertical arrangement. The actuator 114 can extend from the main body of the assembly. This view can illustrate how the first gear 112a and the second gear 112b can be positioned to transfer rotational motion from the actuator 114 through the gear system to the frame structure 102. In some implementations, the end view of FIG. 6E can reveal the internal structure of the frame mounting structure 104, including the mounting positions of the bearings that receive the gear shafts and the rotational shaft. The end view can illustrate the relative sizes of the first gear 112a and the second gear 112b and the vertical spacing between the two gears. As shown in FIG. 6F, a perspective view of the rotational actuation assembly can illustrate the three-dimensional spatial relationships among the member 110, the first gear 112a, the second gear 112b, and the actuator 114. The first gear 112a can be mounted on a shaft by the member 110, and the second gear 112b can include a hub or mounting flange that receives the rotational shaft extending to the frame structure 102. This arrangement can allow the rotational actuation assembly to be integrated with the carbon fiber frame member 202 of the gripper assembly 100. In some implementations, the perspective view of FIG. 6F can illustrate a mounting boss or bearing housing at the top of the second gear 112b that receives the lower end of the rotational shaft, with the upper end of the rotational shaft extending upward through the mounting holes 206 of the carbon fiber frame member 202 and being secured to the frame by a flange, a nut, or a clamp.

The rotational actuation assembly can allow for precise control of the rotational movement of the gripper assembly 100. In some implementations, the actuator 114 can be actuated to rotate the frame structure 102 of the gripper assembly 100 about an axis that passes through the mounting holes 206 of the carbon fiber frame member 202 and that is perpendicular to the plane defined by the frame structure 102. This rotation can allow for repositioning of a solar panel engaged by the plurality of suction cups 108 without requiring a change in the position or orientation of the robotic arm to which the gripper assembly 100 is attached. In some implementations, the rotational actuation assembly can include a controller or driver circuit that receives angular position commands from a supervisory control system and that generates motor drive signals to position the frame structure 102 at the commanded angle. The controller can implement closed-loop position control using feedback from a rotary encoder, a resolver, a potentiometer, or another angular position sensor coupled to the rotational shaft or to the second gear 112b. A controller of the robotic system can transmit a first control signal to a first controller of the articulated arm 500 to position the gripper assembly 100 adjacent to a solar panel, can actuate a vacuum source to couple the plurality of suction cups 108 to the solar panel, can transmit a second control signal to the first controller to position the solar panel proximate to a target location, and can transmit a third control signal to the actuator 114 of the gripper assembly 100 to rotate the solar panel to a target orientation. In some implementations, the first control signal and the third control signal can be transmitted simultaneously, such that the articulated arm 500 is moving while the actuator 114 is simultaneously rotating the panel.

The rotational actuator can rotate the frame structure 102 relative to the frame mounting structure 104 and, by extension, relative to an articulated arm 500 of a robotic system. In some implementations, the rotational actuator can rotate the frame structure 102 through any angle between negative 360 degrees and positive 360 degrees relative to the frame mounting structure 104. Illustrative rotation angles can include, but are not limited to, plus or minus 15 degrees, plus or minus 30 degrees, plus or minus 45 degrees, plus or minus 60 degrees, plus or minus 75 degrees, plus or minus 90 degrees, plus or minus 120 degrees, plus or minus 180 degrees, plus or minus 270 degrees, and plus or minus 360 degrees. In some implementations, the rotational actuator can allow for incremental rotations in less than one-degree increments, such as increments of about 0.1 degrees, about 0.5 degrees, or about 0.25 degrees, among others, providing high-resolution angular positioning. The system can be capable of continuous rotation, allowing the frame structure 102 to rotate through multiple complete revolutions for a given application. The rotational actuator can be adjustable to any angle within its operational range, providing flexibility for precise positioning of solar panels during installation. In some implementations, the rotation angle can be computed based on the orientation of the panel as picked from a pallet, the target orientation at the placement location on the racking, and the kinematic arrangement of the robotic arm. This rotation capability can facilitate aligning a rotated solar panel with a mounting structure during the installation process. In many installation scenarios, a 90-degree rotation can be performed to change the panel orientation between pickup and placement and to orient electrical leads or junction boxes of the panel in the desired direction for subsequent electrical connection. In some implementations, the rotation can be performed at a controlled angular velocity, such as about 10 degrees per second, about 30 degrees per second, about 60 degrees per second, or about 90 degrees per second, among others, depending on the speed and precision constraints of the installation process.

The integration of the rotational actuation assembly with the gripper assembly 100 can enable reorientation maneuvers during solar panel installation. In some implementations, the gripper assembly 100 can be positioned adjacent to a solar panel using an articulated arm 500. The plurality of suction cups 108 can be brought into contact with the panel surface, and the compliant suction cup mounts 152 can independently adjust to engage the solar panel surface. Once the solar panel is engaged and vacuum is established, the actuator 114 can be activated to rotate the frame structure 102, repositioning the solar panel to a desired orientation. This rotational capability can be useful when transporting the solar panel to a mounting location and aligning the panel with the mounting structure. In some implementations, rotation can occur during transport, during approach to the mounting location, or at the mounting location prior to placement. In some implementations, the rotation can be initiated while the robotic arm is simultaneously moving the gripper assembly 100 along a trajectory from the pickup location to the placement location, such that the rotation and the transport occur concurrently, which can reduce the overall cycle time for each panel installation.

The gear system, with its defined gear ratio between the first gear 112a and the second gear 112b, can allow for precise control over the rotation speed and angle of the frame structure 102. In some implementations, this precision can enable the gripper assembly 100 to rotate the frame structure 102 by 90 degrees for solar panel installation arrangements where the panel is to be reoriented between a landscape pickup orientation and a portrait installation orientation, or vice versa. In some implementations, the gear system can provide indexed rotation, in which the frame structure 102 can be rotated to one of a plurality of predefined angular positions, such as 0 degrees, 90 degrees, 180 degrees, and 270 degrees, and can be held at each indexed position by the self-locking characteristics of the gear system or by an electronic brake or detent.

The rotational actuation assembly can be part of a larger robotic system for solar panel installation. This system can include a mobile base and an articulated arm 500, with the gripper assembly 100 coupled to a distal end of the articulated arm 500 as an end effector. The integration of the rotational actuation assembly within this system can provide an additional axis of rotation at the end effector that supplements the rotational degrees of freedom provided by the joints of the articulated arm 500. In some implementations, the additional rotational axis provided by the gripper assembly 100 can relieve one or more joints of the articulated arm 500 from the task of providing final orientation adjustment, which can simplify the inverse kinematics computations and can reduce the joint range constraints of the robotic arm. This can be beneficial in constrained installation environments where the robotic arm has limited freedom of motion due to nearby obstacles, structural elements of the racking system, or adjacent solar panels that have been previously installed.

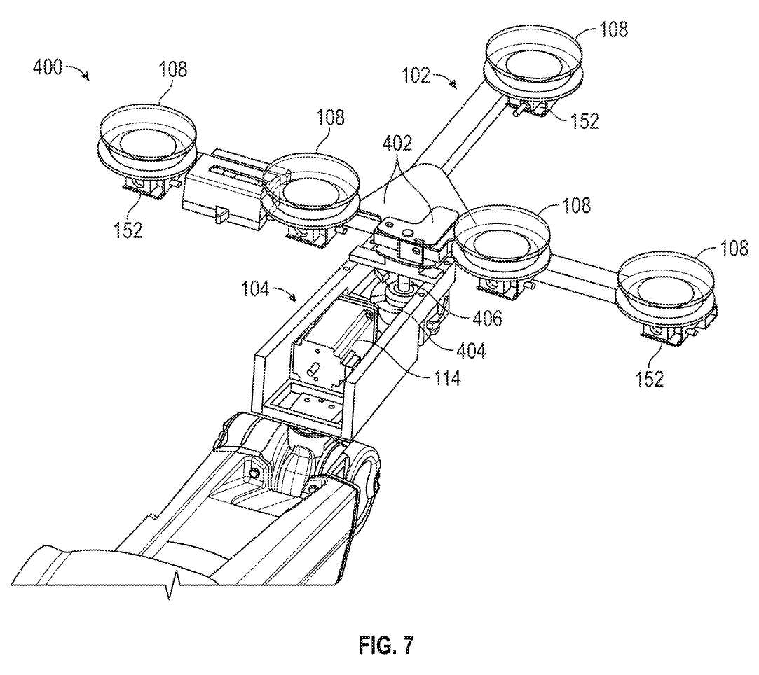

Referring now to FIGS. 7-10, illustrated are various views of a gripper assembly 400 (e.g., a vacuum-actuated end effector, suction-based gripping tool, panel retention head, etc.), in accordance with one or more implementations. The gripper assembly 400 can include a frame structure 102 and a frame mounting structure 104. The gripper assembly 400 can be an example of the gripper assembly 1003 and/or the gripper assembly 1003 can include the gripper assembly 400. In some implementations, the frame structure 102 can be rotatably coupled to the frame mounting structure 104. The gripper assembly 400, as well as the gripper assembly 100 and a gripper assembly 800, can be mounted to the end of an articulated arm 500 (e.g., articulated arm 1006) such as a 6-degree-of-freedom or 7-degree-of-freedom robotic arm. In some implementations, the gripper assembly can function as an additional joint or axis at the end effector of the robot, adding extended reach and enabling various orientations that can be used for solar panel installation. By providing a rotational degree of freedom at the gripper itself, the gripper assembly 400 can enable panel reorientation without requiring the robotic arm to reconfigure its joint angles, which can simplify motion planning and can improve cycle times. In some implementations, the additional rotational degree of freedom can allow the robotic system to reach panel placement positions that would otherwise be kinematically inaccessible using the native joints of the articulated arm 500 alone.

As shown in FIG. 7, the gripper assembly 400 can include a plurality of suction cups 108 mounted to the frame structure 102. In some implementations, the plurality of suction cups 108 includes four suction cups 108. In some implementations, the plurality of suction cups 108 includes five suction cups 108. In some implementations, the plurality of suction cups 108 includes six suction cups 108. In some implementations, the plurality of suction cups 108 includes ten suction cups 108. The plurality of suction cups 108 can be arranged in a linear, radial, matrix, rectangular, triangular, or circular arrangement on the frame structure 102. In some implementations, the arrangement of the suction cups 108 can be adjustable on the frame structure 102. For example, the suction cups 108 can be mounted to sliding rails, slotted tracks, or pivoting arms that allow their positions to be modified to accommodate different panel sizes or arrangements. The gripper assembly 400 can further include a gear system and a rotational shaft 404. The gear system can be operably coupled between the actuator 114 and the rotational shaft 404, and the rotational shaft 404 can be coupled to the frame structure 102 such that rotation of the rotational shaft 404 causes corresponding rotation of the frame structure 102. The suction cup mounts 152 can be used to attach each suction cup 108 to the frame structure 102. Each suction cup mount 152 can include a port fluidly connecting the suction cup 108 to a vacuum source. The rotational shafts 402 can be coupled to the frame structure 102 to provide additional structural rigidity and alignment. In some implementations, the rotational shafts 402 can include triangular gusset plates, L-shaped brackets, or plate reinforcements that are positioned at the junction of intersecting frame members of the frame structure 102 to resist bending and to maintain the geometric relationships among the frame members under load.

The frame structure 102 can include a plurality of interconnected frame members that form a structural base for the assembly. For example, a first bar member can extend transversely from a midpoint of a second bar member, forming a T-shaped frame arrangement. The plurality of bar members can be coupled in various arrangements, such as a Y-shaped, L-shaped, cross-shaped, or polygonal frame arrangement. In some implementations, the frame structure 102 can be formed of carbon fiber. In some implementations, the frame structure 102 can be formed of aluminum, steel, a composite material, or a combination of materials. In some implementations, one or more rotational shafts 402 can be coupled to the frame structure 102. For example, the rotational shafts 402 can include plates, brackets, gussets, or other reinforcing elements. In some implementations, the rotational shafts 402 can contribute to the overall rigidity and structural alignment of the frame structure 102 with respect to the frame mounting structure 104. In some implementations, the rotational shafts 402 can maintain concentric alignment between the rotating frame structure 102 and the rotational shaft 404 of the rotational assembly. The rotational shafts 402 and the frame structure 102 can include corresponding openings that are axially aligned to receive and position the rotational shaft 404, facilitating rotational coupling and structural alignment between the frame structure 102 and the frame mounting structure 104. The frame structure 102 can be coupled to the rotational shaft 404 such that rotation of the rotational shaft 404 causes rotation of the frame structure 102.

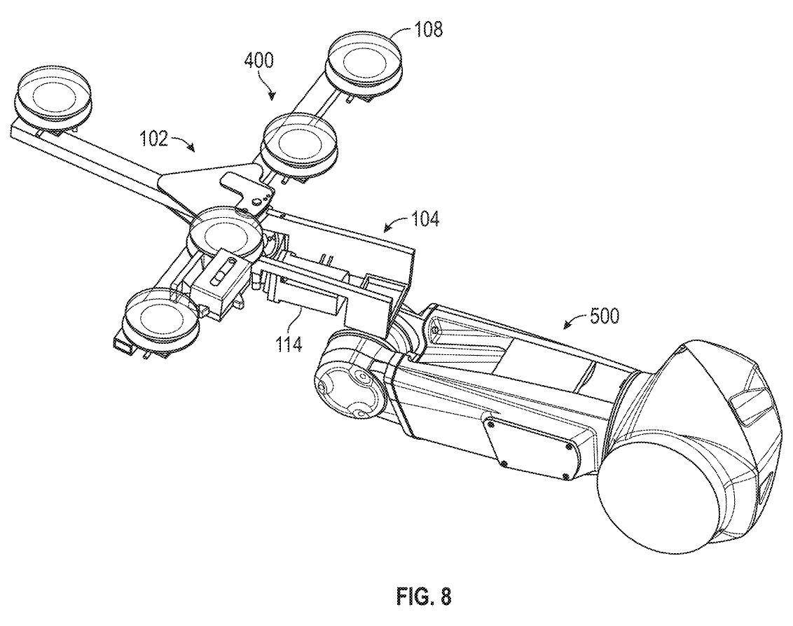

Referring now to FIG. 8, illustrated is a perspective view of the gripper assembly 400 mounted to the articulated arm 500, in accordance with one or more implementations. As shown in FIG. 8, the gripper assembly 400 can be coupled to a distal end of the articulated arm 500 via the frame mounting structure 104. The frame structure 102 can extend from the frame mounting structure 104 and can carry a plurality of suction cups 108. The actuator 114 can be visible at the junction between the frame mounting structure 104 and the articulated arm 500. This view can illustrate how the gripper assembly 400 can function as an end effector that is positioned by the articulated arm 500. The articulated arm 500 can position the gripper assembly 400 in three-dimensional space, while the rotational actuation system of the gripper assembly 400 can provide an additional rotational degree of freedom for reorienting a grasped solar panel. In some implementations, the articulated arm 500 can include six or seven rotational joints arranged in a serial kinematic chain, with the gripper assembly 400 mounted at the distal end of the chain. The combination of the joints of the articulated arm 500 and the rotational actuation system of the gripper assembly 400 can provide the robotic system with seven or eight rotational degrees of freedom in total, which can provide kinematic redundancy that allows the system to reach a given panel position and orientation through multiple joint arrangements.

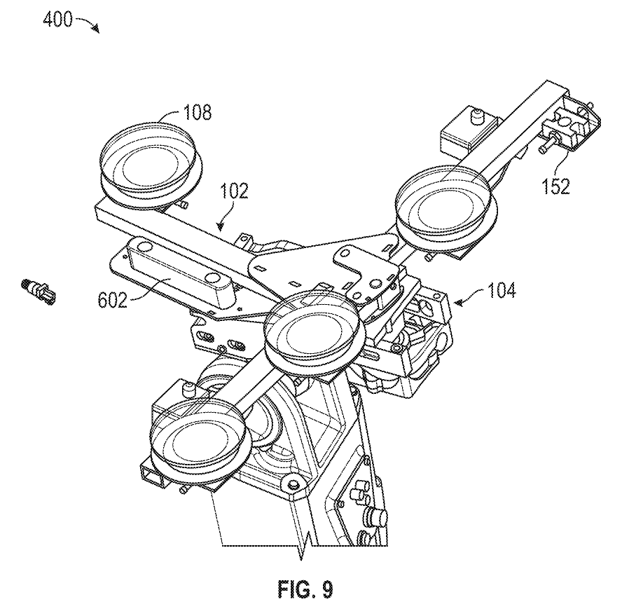

Referring now to FIG. 9, illustrated is a perspective view of the gripper assembly 400 showing sensors 602, in accordance with one or more implementations. In some implementations, one or more sensors 602 can be mounted on the frame structure 102. The sensors 602 can detect the location, orientation, or surface features of a solar panel or other object. The sensors 602 can be used to guide the positioning of the gripper assembly 400 for panel pickup, alignment, and installation. In some implementations, a sensor 602 can be a camera, such as a monocular camera, a stereo camera pair, a depth camera, or a time-of-flight camera. Other types of sensors, such as LIDAR, ultrasonic, or infrared sensors, can be mounted to the frame structure 102 or the frame mounting structure 104. The sensors 602 can be used for functions including panel location detection, orientation detection, surface feature detection, crack detection, connector verification, obstacle detection, alignment assistance, and quality validation. In some implementations, the sensors 602 can detect the position and orientation of a panel's electrical leads or junction box, which can be used by a control system to determine the angle of rotation for the frame structure 102 to position the electrical leads in a desired installation orientation. For example, if the sensors 602 detect that the junction box of the panel is located at the left side of the panel as picked from the pallet, and the installation arrangement calls for the junction box to be at the bottom of the panel as placed on the racking, the control system can command the actuator 114 to rotate the frame structure 102 by 90 degrees to reorient the panel accordingly. The suction cup mounts 152 can be visible in this view, coupling the suction cups 108 to the frame structure 102.

In some implementations, the sensors 602 can be communicatively coupled to the controller 1010 via a wired connection, such as a USB, Ethernet, or serial connection, routed through the frame structure 102 and the frame mounting structure 104 to the controller 1010 on the movable base 1002. In some implementations, the sensors 602 can communicate with the controller 1010 via a wireless connection, such as a Wi-Fi, Bluetooth, or Zigbee link. The controller 1010 can process data from the sensors 602 using image recognition algorithms, machine learning models, or template-matching techniques to identify the position and orientation of the junction box and electrical leads on a solar panel.

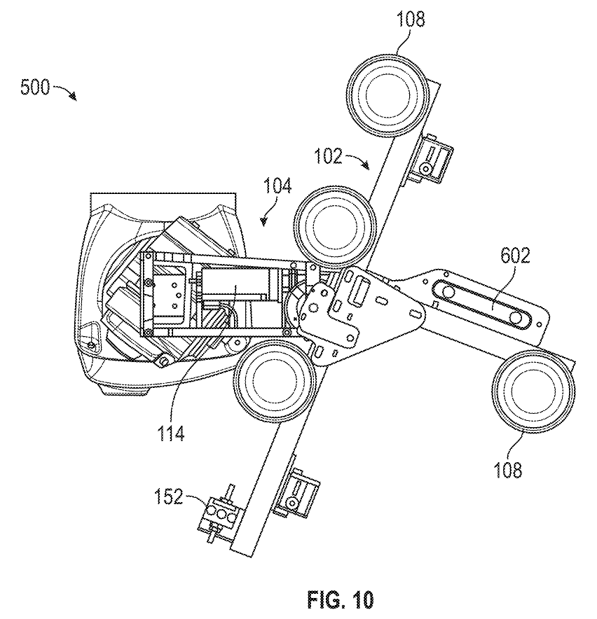

Referring now to FIG. 10, illustrated is a plan view of the gripper assembly 400 mounted to the articulated arm 500, in accordance with one or more implementations. As shown in FIG. 10, the gripper assembly 400 can be visible from above, with the frame structure 102 carrying a plurality of suction cups 108 and the sensors 602 mounted at or near a distal end of the frame structure 102. The frame mounting structure 104 can be visible between the frame structure 102 and the articulated arm 500. The actuator 114 can be positioned within or adjacent to the frame mounting structure 104. The suction cup mounts 152 can be visible at one or more locations along the frame structure 102. This plan view can illustrate the spatial distribution of the suction cups 108 across the frame structure 102 and can show how the sensors 602 can be positioned to have a field of view that faces the panel surface when the gripper assembly 400 is positioned adjacent to a solar panel for pickup. In some implementations, the sensors 602 can be positioned at a distal end of a frame member of the frame structure 102, such that the field of view of the sensors 602 is not obstructed by the suction cups 108 or by the frame mounting structure 104. In some implementations, the sensors 602 can be angled or tilted relative to the plane of the frame structure 102 to direct the sensor field of view toward the panel surface at a predetermined viewing angle.

The plurality of suction cups 108 can be fluidly connected to a vacuum system that includes one or more vacuum lines and one or more vacuum sources. In some implementations, each suction cup 108 can be attached to the frame structure 102 by a suction cup mount 152, with the suction cup 108 disposed on a first side of the frame structure 102 and the suction cup mount 152 positioned on an opposing second side. In some implementations, each suction cup mount 152 can provide a port that fluidly connects the corresponding suction cup 108 to the vacuum system. Tubing can be routed along the exterior of the gripper assembly or at least partially through the frame structure 102 or the frame mounting structure 104. In some implementations, the tubing can be secured to the frame structure 102 using clips, ties, adhesive mounts, or channels formed into the frame members, which can mitigate the tubing from interfering with the rotation of the frame structure 102 relative to the frame mounting structure 104. In some implementations, a first subset of the plurality of suction cups 108 can be fluidly coupled to a first vacuum source through a first vacuum line, and a second subset of the plurality of suction cups 108 can be fluidly coupled to a second vacuum source through a second vacuum line separate from the first vacuum line. The first vacuum line and the second vacuum line can be routed independently through or alongside the articulated arm 500 to maintain separate fluid paths from the movable base to the respective subsets of suction cups 108.

The vacuum source (e.g., vacuum source 1012, etc.) can generate negative pressure at the suction cup 108 interface to enable secure attachment to the surface of a solar panel or other object. In some implementations, the vacuum source can include a vacuum pump, such as a diaphragm pump, a piston pump, or a rotary vane pump. In some implementations, the vacuum source can include a venturi-based vacuum generator that uses compressed air to create vacuum through the Venturi effect. Control valves and pressure sensors can be disposed in-line with the vacuum circuit to regulate suction strength and to monitor for vacuum loss. Vacuum loss can indicate improper engagement of one or more suction cups 108, panel damage, or other anomalous conditions that can warrant corrective action. In some implementations, pressure regulators can be disposed in-line to set a target vacuum level at each suction cup 108 or at each group of suction cups 108, and the pressure sensors can provide real-time or near real-time feedback to a control system that monitors the vacuum status during panel handling. A positive pressure source, such as a compressed air source, can be fluidly coupled to the plurality of suction cups 108 through the same fluid lines used for vacuum, such that the system can switch between a suction mode and a positive pressure mode for panel release.

In some implementations, the vacuum system can include a plurality of vacuum sources, such as multiple vacuum pumps or multiple venturi generators. Redundant vacuum sources can be used, with each source servicing a subset of the plurality of suction cups 108. In this way, loss of vacuum in one source does not disable the suction capability of the entire gripper assembly. For example, a first vacuum source can be fluidly connected to a first group of suction cups 108 disposed on one side of the frame structure 102, and a second vacuum source can be fluidly connected to a second group of suction cups 108 disposed on the opposite side of the frame structure 102. Each of the first vacuum source and the second vacuum source can be coupled to at least two suction cups 108 of the plurality of suction cups 108. Each vacuum source can be individually sufficient to provide suction to maintain coupling of the solar panel to the gripper via its respective subset of suction cups 108 independent of the other vacuum source. If the first vacuum source experiences a failure, the second vacuum source can continue to maintain vacuum at the second group of suction cups 108, mitigating the solar panel from being dropped. The controller can maintain coupling of the gripper to the solar panel through at least one of the vacuum sources in response to loss of vacuum from another of the vacuum sources. The suction cups 108 can be grouped into independently controllable zones, allowing selective activation of different suction zones based on panel size, shape, or condition. For example, when retaining a smaller panel that does not span all suction cup 108 positions, the vacuum system can activate a subset of the suction cups 108 that contact the panel surface while leaving the remaining suction cups 108 deactivated. In some implementations, three or more independently controllable vacuum zones can be provided, with each zone corresponding to a different region of the frame structure 102.

In some implementations, the frame mounting structure 104 can include an enclosure, such as a rectangular housing, formed by a plurality of sidewalls that define an internal cavity. This internal cavity can accommodate the actuation system and the rotational assembly, and can include attachment features for securing those components and for securing the gripper assembly to the articulated arm 500. The actuator 114 can be mounted to a sidewall of the frame mounting structure 104. In some implementations, the frame mounting structure 104 can include a plurality of sidewalls forming an open structure, with attachment features for mounting components and securing the gripper assembly to the articulated arm 500. The attachment features can include attachment flanges, bolt holes, recessed channels, threaded inserts, or other mechanical interfaces. In some implementations, the enclosure of the frame mounting structure 104 can be sealed or partially sealed to protect the internal components from environmental contaminants such as dust, moisture, and debris that can be present at a solar installation site. In some implementations, the enclosure can include access panels, removable covers, or inspection ports that allow maintenance and service of the internal components without removal of the frame mounting structure 104 from the articulated arm 500. The frame mounting structure 104 can be sized to provide additional height or reach that allows the robotic system to perform panel pick-and-place without overextension of the articulated arm 500.

In some implementations, in a gear-driven arrangement, the actuation system can include an actuator 114, such as a servo motor or a brushless DC motor, that is operably coupled to a gear system. A rotational shaft 404 of the gear system, such as an axle mechanically coupled to the gear output, can be coupled to the frame structure 102, allowing the actuator 114 to rotate the frame structure 102 through the gear system. In some implementations, the rotational shaft 404 can extend from the gear system in a direction perpendicular to a horizontal plane defined by the frame structure 102. In some implementations, in an alternative direct-drive arrangement, the actuator 114 can be coupled to the rotational shaft 404 without an intermediate gear system. In some implementations, the shaft of the actuator 114 can itself serve as the rotational shaft 404. In some implementations, the actuator 114 can be a high-torque motor that provides sufficient torque to rotate the frame structure 102 while carrying a solar panel. In some implementations, the actuator 114 can be a direct-drive motor that has a large-diameter rotor and stator that provide high torque at low rotational speeds without requiring an intermediate gear reduction. In the direct-drive arrangement, the elimination of intermediate gears can reduce mechanical backlash and can simplify the mechanical construction of the rotational actuation system.

In some implementations, the actuator shaft can be perpendicular to the rotational shaft 404. In some implementations, the actuator shaft can be parallel to the rotational shaft 404. The relative orientation of the actuator shaft and the rotational shaft 404 can depend on the type of gear system used. For example, a right-angle gearbox can accommodate a perpendicular relationship between the actuator shaft and the rotational shaft 404, while an in-line gearbox or a direct coupling can result in a parallel or collinear relationship. In some implementations, a right-angle gearbox can be selected to allow the actuator 114 to be oriented horizontally within the frame mounting structure 104 while the rotational shaft 404 extends vertically to the frame structure 102, which can reduce the overall height of the assembly and can provide a more compact profile.

The actuator 114 and the gear system can be disposed within the frame mounting structure 104. In some implementations, the gear system can include a worm gear. In some implementations, the actuation system can drive the frame structure 102 through a worm gear arrangement, which can provide a self-locking feature that mitigates the frame structure 102 from rotating under external loads when the actuator 114 is not energized. The self-locking characteristic of a worm gear can be advantageous for maintaining the angular position of the frame structure 102 during panel transport, when external forces such as wind loads or acceleration-induced forces tend to rotate the frame. In some implementations, the gear system can include a spur gear train. In some implementations, the gear system can include harmonic gearing. In some implementations, the gear system can include a gearbox, such as a planetary gearbox, an in-line gearbox, or a right-angle gearbox. The gearbox can be adjacent to or integrated with the actuator 114 and can receive torque from the drive shaft of the actuator 114. The rotational shaft 404 can extend from the gearbox perpendicular to a horizontal plane defined by the frame structure 102, enabling transmission of rotational motion to the frame structure 102 of the gripper assembly. The rotational shaft 404 can be within the frame mounting structure 104 and can be received by one or more bearings 406 that are mounted to the frame mounting structure 104 and that can be positioned independently of the actuator 114 and the gear system. In some implementations, this bearing arrangement can allow the bearings 406 to receive the mechanical loads imposed by the rotating frame structure 102, such as cantilevered weight from a mounted solar panel, while isolating the actuator 114 and the gear system from structural loading. The bearings 406 can include one or more of angular contact bearings, deep groove ball bearings, tapered roller bearings, or thrust bearings, selected based on the magnitude and direction of the loads to be received. The rotational shaft 404 can be oriented perpendicular to a plane defined by the frame structure 102 and can rotate the frame structure 102 relative to the frame mounting structure 104.

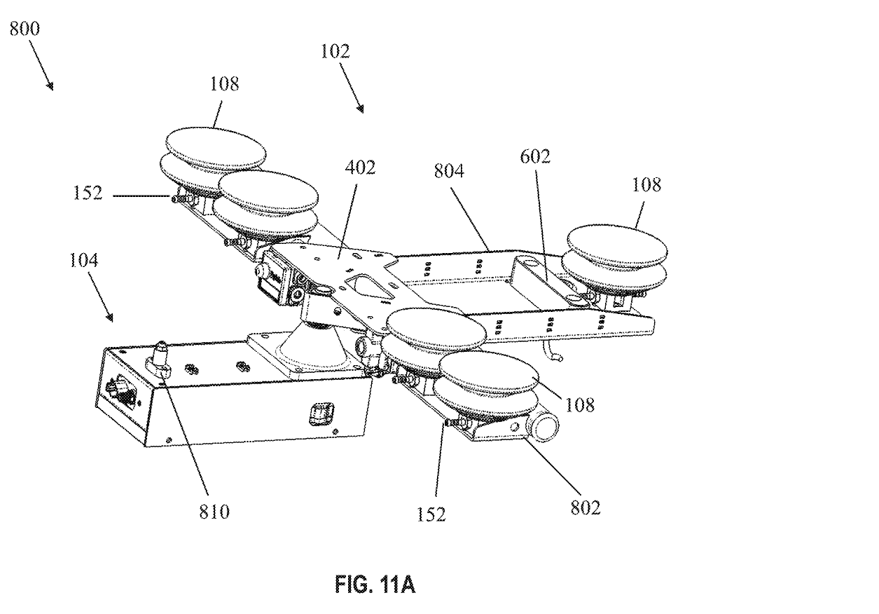

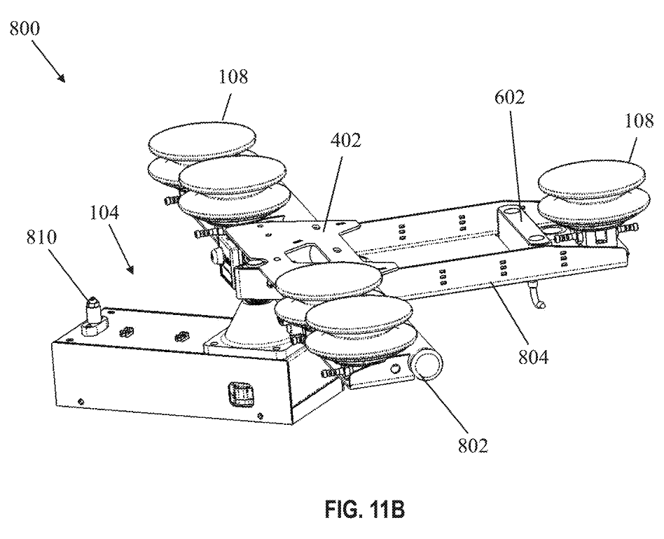

Referring now to FIGS. 11A and 11B, illustrated are perspective views of a gripper assembly 800, in accordance with one or more implementations. The gripper assembly 800 can be similar to the gripper assembly 100 and the gripper assembly 400 described herein and can include the frame structure 102 and the frame mounting structure 104. The gripper assembly 800 can be an example of the gripper assembly 1003 and/or the gripper assembly 1003 can include the gripper assembly 800. The frame structure 102 of the gripper assembly 800 can include a plurality of frame members including a first rotational shaft 802 and a second frame member 804. In some implementations, the frame members can have similar geometries, such as rectangular cross-sections or tubular profiles. In some implementations, the frame members can be different from one another. For example, the second frame member 804 can be a tray-like structure having a flat plate surface with raised sidewalls or flanges. In some implementations, a tray-like structure can provide a mounting surface for a sensor 602, such as a camera, LIDAR sensor, ultrasonic sensor, or infrared sensor, and can position a suction cup 108. In some implementations, the tray-like structure of the second frame member 804 can include apertures, cutouts, or recesses that receive and position the sensors 602 and the suction cups 108 at predetermined locations and orientations. The first rotational shaft 802 can be an elongate bar member that extends laterally across the gripper assembly 800 and can carry a majority of the suction cups 108, while the second frame member 804 can extend from the first rotational shaft 802 in a perpendicular direction and can carry one or more additional suction cups 108 and the sensors 602.

In some implementations, the suction cups 108 can be arranged in a T-shaped arrangement, with a first plurality of suction cups 108, such as four suction cups 108, disposed along the first rotational shaft 802 and at least one additional suction cup 108 disposed on the second frame member 804 oriented perpendicular to the first rotational shaft 802, such that the arrangement forms a T shape when viewed from above. In some implementations, the diameter of each suction cup 108 can be about 100 mm, about 125 mm, about 150 mm, or about 175 mm, among others. In some implementations, different suction cups 108 within the same gripper assembly can have different diameters, such that smaller suction cups 108 can be used in regions of the panel that have limited flat surface area, and larger suction cups 108 can be used in regions that have broader flat surfaces. The plurality of frame members can be coupled in various arrangements, such as Y-shaped, L-shaped, cross-shaped, or polygonal frame arrangements. The plurality of frame members can be formed as discrete elements coupled together to form a frame, or can be formed as a single, monolithic structure. One or more rotational shafts 402 can be coupled to the frame structure 102 at or near the junction of the first rotational shaft 802 and the second frame member 804 to reinforce the frame structure at this intersection. The suction cup mounts 152 can be visible coupling each suction cup 108 to the respective frame member.

As shown in FIGS. 11A and 11B, one or more sensors 602 can be mounted on or near a distal end of the second frame member 804. The sensors 602 can be oriented to face the panel surface when the gripper assembly 800 is positioned adjacent to a solar panel, and can capture data that is used by a control system to determine the location, orientation, and surface condition of the panel. In some implementations, the sensors 602 can include a camera that captures images of the rear surface of the solar panel, enabling the control system to identify the position and orientation of the junction box and electrical leads. The control system can use this information to determine the rotation angle for the frame structure 102 to orient the panel for installation. In some implementations, the sensors 602 can include a proximity sensor or a distance sensor that measures the distance between the gripper assembly 800 and the solar panel surface, which can be used to control the approach speed and engagement sequence of the suction cups 108. One or more sensors 810 can be mounted on the frame mounting structure 104. The sensors 810 can include rotation-limiting sensors, position feedback sensors, rotary encoders, magnetic switches, or other sensing elements that monitor the rotational position and motion of the frame structure 102 relative to the frame mounting structure 104. In some implementations, the sensors 810 can include a limit switch that is triggered when the frame structure 102 reaches a predefined maximum or minimum rotation angle, which can mitigate over-rotation and associated entanglement of vacuum lines or electrical cables.

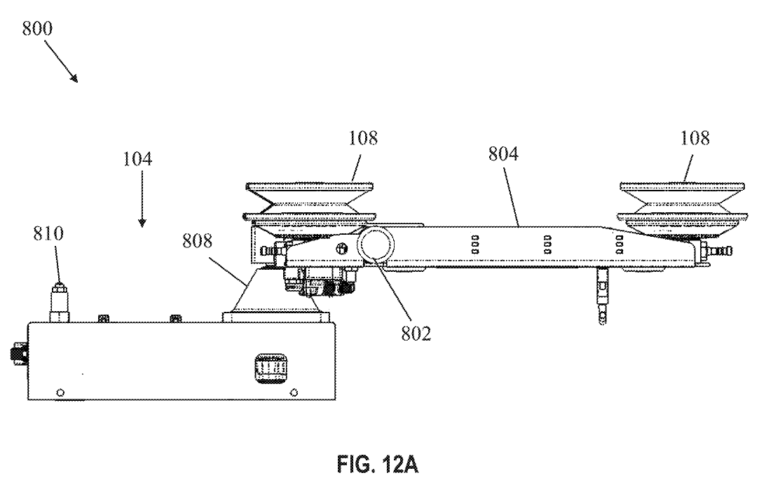

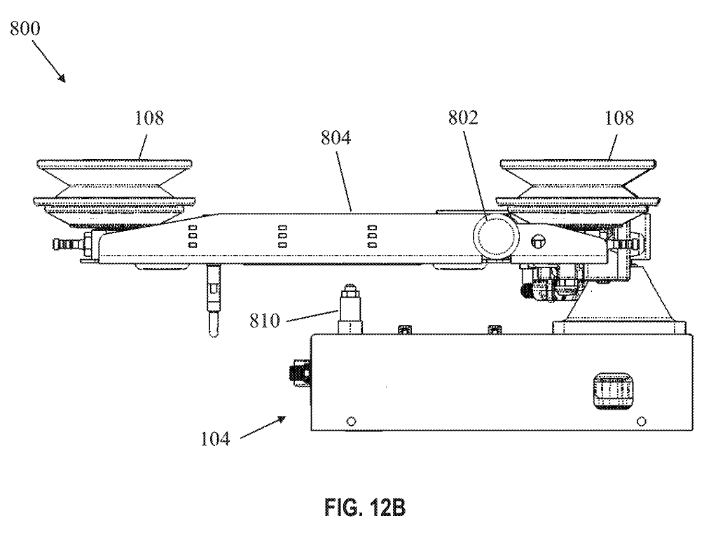

Referring now to FIGS. 12A and 12B, illustrated are side elevational views of the gripper assembly 800, in accordance with one or more implementations. As shown in FIG. 12A, the frame mounting structure 104 can be positioned below the frame structure 102, with a support 808 visible at the interface between the frame mounting structure 104 and the frame structure 102. The support 808 can include a bearing housing, a flange plate, or a rotary coupling that permits the frame structure 102 to rotate relative to the frame mounting structure 104 while maintaining structural transfer between the two assemblies. The first rotational shaft 802 can extend laterally, and the second frame member 804 can extend perpendicular to the first rotational shaft 802. The suction cups 108 can be mounted at spaced positions along the first rotational shaft 802 and the second frame member 804 via the suction cup mounts 152. The sensors 810 can be visible on the frame mounting structure 104. As shown in FIG. 12B, an opposite side view of the gripper assembly 800 can illustrate the first rotational shaft 802 and the second frame member 804 carrying the suction cups 108, with the frame mounting structure 104 providing structural mount from below. The sensors 810 can be visible on the frame mounting structure 104. These side views can illustrate the vertical profile of the gripper assembly 800 and can show how the frame structure 102 is positioned above the frame mounting structure 104 by the rotational coupling. In some implementations, the side views can illustrate the relative positions of the suction cup mounts 152 and the compliant elements that allow each suction cup 108 to self-level relative to the frame members.

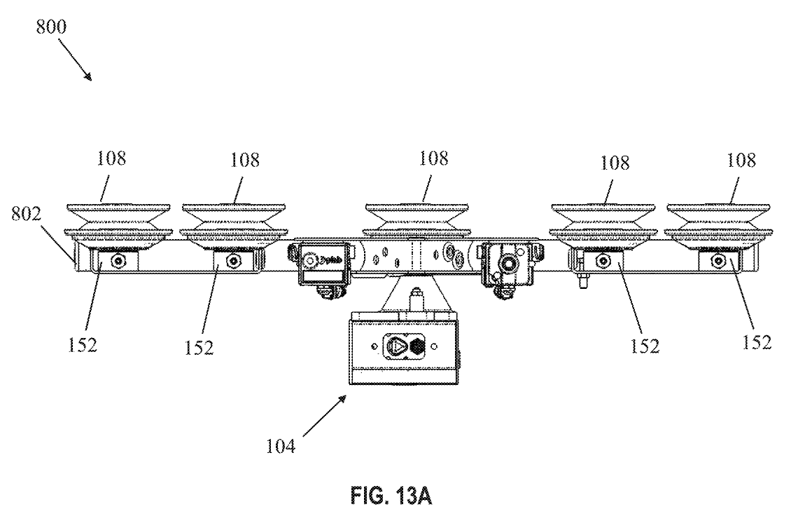

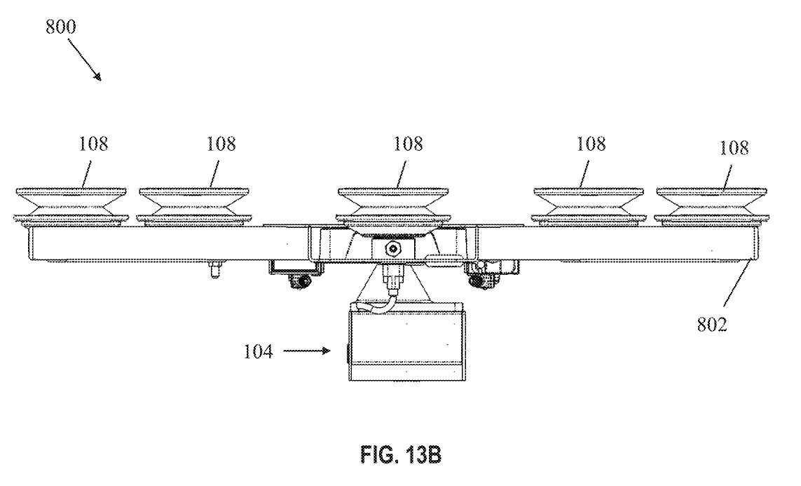

Referring now to FIGS. 13A and 13B, illustrated are front and side elevational views of the gripper assembly 800, in accordance with one or more implementations. As shown in FIG. 13A, the first rotational shaft 802 can extend laterally across the gripper assembly 800, with a plurality of suction cups 108 distributed along its length. The suction cup mounts 152 can couple each suction cup 108 to the first rotational shaft 802. The frame mounting structure 104 can be positioned at the center of the gripper assembly 800 below the first rotational shaft 802. This front view can illustrate how the suction cups 108 are distributed along the span of the first rotational shaft 802 to provide distributed gripping contact across the width of a solar panel. In some implementations, the suction cups 108 can be spaced at intervals of about 100 mm, about 150 mm, about 200 mm, or about 250 mm, among others, along the first rotational shaft 802, depending on the width of the solar panel and the number of suction cups 108 used. As shown in FIG. 13B, a side elevational view of the gripper assembly 800 can illustrate the first rotational shaft 802 extending horizontally with the suction cups 108 mounted thereon, and the frame mounting structure 104 positioned below. These views can illustrate that the gripper assembly 800 can accommodate a greater number of suction cups 108 than the gripper assembly 100 or the gripper assembly 400, which can be advantageous for retaining larger or heavier solar panels that benefit from additional gripping contact points. In some implementations, the gripper assembly 800 can include five, six, seven, eight, nine, or ten suction cups 108, with the number selected based on the panel dimensions, the panel weight, and the gripping force constraints of the application.

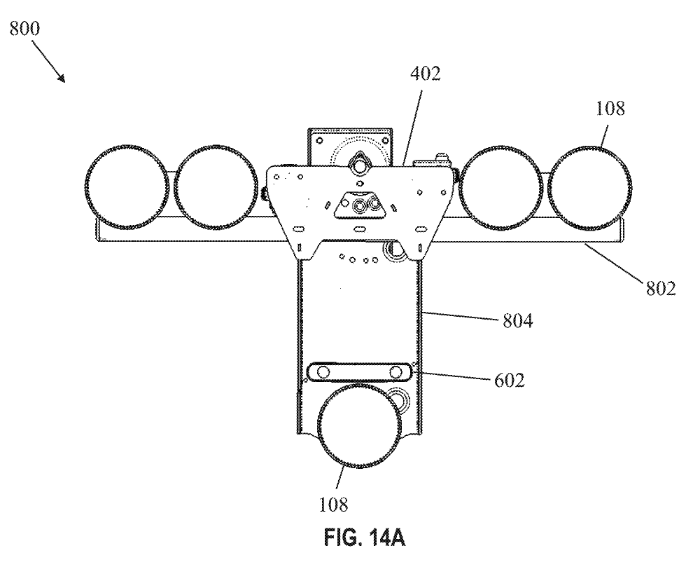

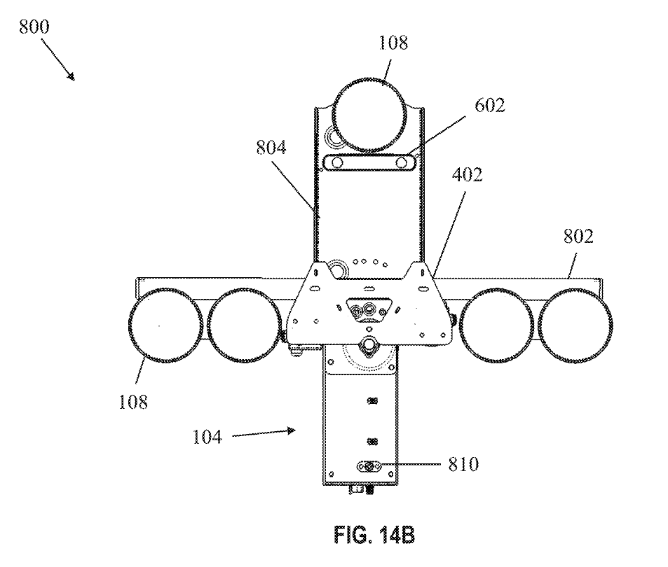

Referring now to FIGS. 14A and 14B, illustrated are plan views of the gripper assembly 800, in accordance with one or more implementations. As shown in FIG. 14A, the gripper assembly 800 can be visible from above, with the first rotational shaft 802 extending horizontally and the second frame member 804 extending downward from the first rotational shaft 802 in a perpendicular direction, forming the T-shaped arrangement. A plurality of suction cups 108 can be distributed along the first rotational shaft 802, and at least one additional suction cup 108 can be positioned on the second frame member 804. The rotational shafts 402 can be visible at the junction of the first rotational shaft 802 and the second frame member 804. The sensors 602 can be visible at or near a distal end of the second frame member 804. As shown in FIG. 14B, another plan view of the gripper assembly 800 can illustrate the first rotational shaft 802 and the second frame member 804 with the suction cups 108, the sensors 602, the rotational shafts 402, and the frame mounting structure 104 visible below the frame structure 102. The sensors 810 can be visible on the frame mounting structure 104. These plan views can illustrate how the T-shaped frame arrangement can position suction cups 108 across both the first rotational shaft 802 and the second frame member 804, providing gripping contact in two perpendicular directions relative to the center of the frame. This T-shaped arrangement can distribute gripping forces across a larger area of the panel surface and can provide improved resistance to rotation or shifting of the panel relative to the frame structure 102 during transport. In some implementations, the T-shaped arrangement can provide gripping contact at positions that are closer to the junction box or electrical lead region of the solar panel via the suction cups 108 mounted on the second frame member 804, which can provide a more stable grip in the vicinity of rear-surface protrusions.

In some implementations, the gripper assembly 800 can orient the electrical leads of a grasped solar panel for installation and electrical connection. For example, the sensors 602 mounted on the frame structure 102 can detect the location, orientation, or surface features of the solar panel, including the position of the junction box and electrical leads. The sensors 602 can be used to guide the positioning of the gripper assembly for panel pickup, alignment, and installation. The rotational actuator can rotate the frame structure 102 to reposition a solar panel engaged by the plurality of suction cups 108, facilitating the orientation of electrical leads during the installation process. In some implementations, causing the actuator to rotate can include rotating the frame structure 102 by 90 degrees to orient the electrical leads in a desired arrangement. The rotation capability can enable aligning the solar panel with the mounting structure such that the electrical leads are positioned for subsequent electrical connection. In some implementations, the sensors 602 mounted on the second frame member 804 can be positioned to have a field of view that encompasses the junction box region of the solar panel, enabling the control system to determine the angular position of the electrical leads relative to the frame structure 102 before and after rotation.

One or more sensors 810, such as rotation-limiting sensors, position feedback sensors, rotary encoders, or magnetic switches, can be used to monitor the rotational motion of the frame structure 102 and to detect when the rotating frame approaches a predefined rotational limit. For example, a sensor 810 can be mounted to the frame mounting structure 104 and can generate a signal when the frame structure 102 reaches a predetermined angular position. In some implementations, the sensors 810 can mitigate entanglement of vacuum lines and electrical cabling that extend between the frame structure 102 and the frame mounting structure 104 or between the gripper assembly and the robotic arm. By detecting when the frame structure 102 approaches a rotational limit, the sensors 810 can provide a signal to a control system that causes the actuator 114 to stop or reverse rotation before the vacuum lines or electrical cables become twisted or entangled. In some implementations, the sensors 810 can provide rotational position feedback that can be used by the control system to determine the current angular orientation of the frame structure 102 relative to the frame mounting structure 104, which can be used for closed-loop rotational position control. In some implementations, the sensors 810 can include a rotary encoder coupled to the rotational shaft or to one of the gears of the gear system, providing continuous angular position data with a resolution of about 0.1 degrees or finer. In some implementations, the sensors 810 can include a pair of magnetic switches or Hall effect sensors positioned at predetermined angular positions on the frame mounting structure 104, with corresponding magnets mounted on the frame structure 102 or on the rotational shaft, such that the sensors generate signals when the magnets pass through the sensor detection zones during rotation.

In some implementations, the sensors 810 can transmit a digital or analog signal to the controller 1010 that represents the current angular position of the frame structure 102. The controller 1010 can compare the current angular position to a commanded angular position and can generate a correction signal to, for example, the actuator 114 to reduce the difference between the current angular position and the commanded angular position. This closed-loop feedback arrangement can provide precise angular positioning of the frame structure 102 during panel rotation.

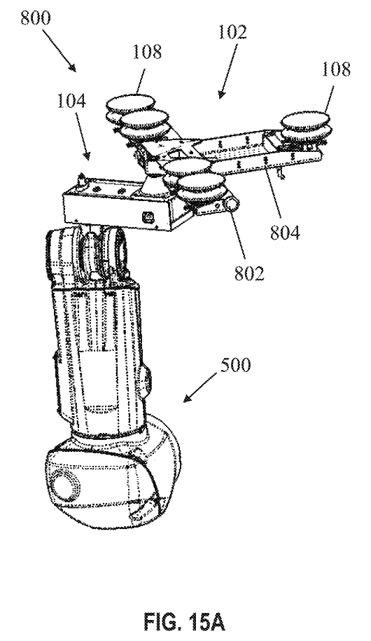

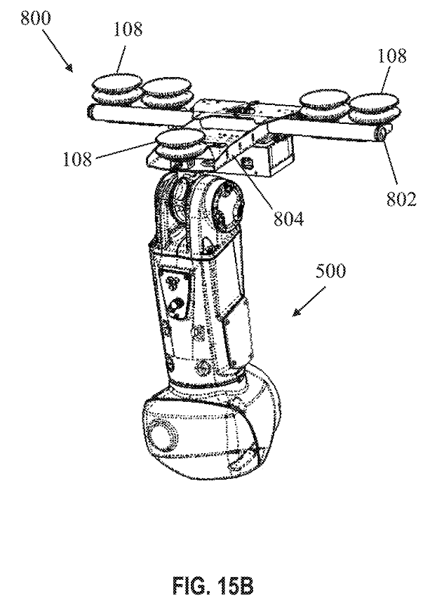

Referring now to FIGS. 15A and 15B, illustrated are perspective views of the gripper assembly 800 mounted to the articulated arm 500, in accordance with one or more implementations. As shown in FIG. 15A, the gripper assembly 800 can be coupled to a distal end of the articulated arm 500 via the frame mounting structure 104. The frame structure 102 can include the first rotational shaft 802 and the second frame member 804, with the suction cups 108 distributed along both frame members. The articulated arm 500 can position the gripper assembly 800 in three-dimensional space during panel pickup and placement operations. As shown in FIG. 15B, another perspective view can illustrate the gripper assembly 800 mounted to the articulated arm 500 from a different vantage point, showing the first rotational shaft 802 carrying the suction cups 108 and the second frame member 804 extending from the junction region. The articulated arm 500 can include multiple rotational joints that collectively provide six or seven degrees of freedom for positioning the gripper assembly 800. The rotational actuation system of the gripper assembly 800 can provide an additional degree of freedom beyond the native joints of the articulated arm 500, which can extend the range of panel orientations that can be achieved at the placement location. In some implementations, the views of FIGS. 15A and 15B can illustrate the gripper assembly 800 in an orientation in which the suction cups 108 face upward, downward, or laterally, demonstrating the ability of the articulated arm 500 to orient the gripper assembly 800 in a variety of poses for approaching and engaging solar panels stored on pallets or positioned on racking structures at various angles.

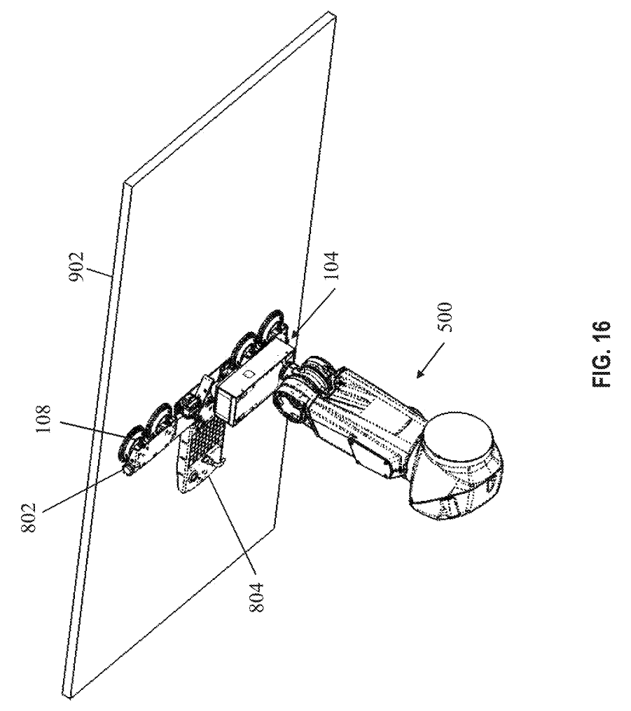

Referring now to FIG. 16, illustrated is a perspective view of the gripper assembly 800 engaged with a solar panel 902 (e.g., a photovoltaic module, solar cell panel, etc.), in accordance with one or more implementations. As shown in FIG. 16, the articulated arm 500 can retain the gripper assembly 800, which can include the first rotational shaft 802 and the second frame member 804 carrying a plurality of suction cups 108. The suction cups 108 can be in contact with a surface of the solar panel 902, maintaining a vacuum seal that retains the solar panel 902 against the frame structure 102. The frame mounting structure 104 can be visible at the junction between the frame structure 102 and the articulated arm 500. In some implementations, the gripper assembly 800 can grasp the rear surface (e.g., non-active surface, underside, first surface 1804, etc.) of the solar panel 902 rather than the front photovoltaic surface. Grasping the rear surface can avoid contact with the photovoltaic cells, which can reduce the risk of contamination, scratching, or micro-damage to the active light-receiving surface.

This view illustrates how the solar panel 902 can be held at an angle relative to vertical, demonstrating the ability of the gripper assembly and the articulated arm 500 to retain and transport the solar panel 902 in various orientations during installation. The articulated arm 500 can position the gripper assembly and the engaged solar panel 902 adjacent to a mounting structure, and the rotational actuation system of the gripper assembly can rotate the frame structure 102 to achieve the desired angular orientation of the solar panel 902 prior to placement. In some implementations, the solar panel 902 can be rotated during transport from the pickup location to the placement location, such that the solar panel 902 arrives at the placement location in the desired orientation and can be placed without additional rotation. In some implementations, the compliant suction cup mounts 152 can maintain secure engagement with the rear surface of the solar panel 902 despite rear-surface irregularities such as junction boxes, electrical leads, connectors, label stickers, or uneven back sheet textures.

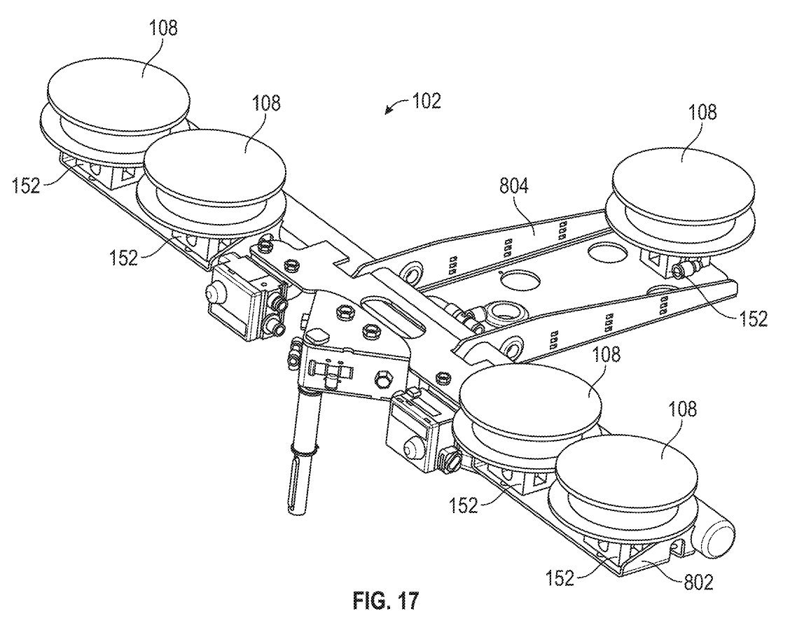

Referring now to FIG. 17, illustrated is a perspective view of a gripper assembly (e.g., gripper assembly 1003, 100, 400, and/or 800), in accordance with one or more implementations. As shown in FIG. 17, the frame structure 102 can include the first rotational shaft 802 and the second frame member 804 in a T-shaped arrangement. A plurality of suction cups 108 can be distributed across the first rotational shaft 802 and the second frame member 804, with each suction cup 108 coupled to the respective frame member via a suction cup mount 152. This view can illustrate additional detail of the suction cup mounts 152 and the mechanical interface between each suction cup 108 and the frame structure 102. In some implementations, the suction cup mounts 152 can include vertical posts, spring-loaded mounts, ball-joint connectors, or other compliant structures that allow each suction cup 108 to independently adjust its orientation and height relative to the frame structure 102. In some implementations, each suction cup mount 152 can include a vacuum fitting or port that provides a sealed fluid connection between the suction cup 108 and a vacuum line routed along the frame structure 102. The T-shaped frame arrangement shown in FIG. 17 can distribute the suction cups 108 across two perpendicular axes, which can provide improved gripping stability and can resist tilting of the grasped panel during rotation and transport. In some implementations, the perspective view of FIG. 17 can illustrate five suction cups 108, with three suction cups 108 disposed along the first rotational shaft 802 and two suction cups 108 disposed along the second frame member 804. In some implementations, the suction cups 108 on the second frame member 804 can be positioned at locations that correspond to regions of the solar panel that are offset from the junction box, such that the suction cups 108 maintain a secure grip without interfering with the junction box or its electrical leads.

In some implementations, the gripper assembly can perform offset picking of solar panels. Offset picking can refer to grasping a solar panel at a position that is offset from the geometric center or center of mass of the panel. By grasping the solar panel at an off-center location, the gripper assembly can achieve a greater effective reach for the robotic arm, can improve the kinematic feasibility of certain pick-and-place trajectories, can facilitate extraction of panels from pallets, can provide a wider placement envelope, and can enable improved approach and release trajectories at the mounting location. The offset picking capability can be useful when the robotic arm has limited reach or when panels are arranged on a pallet in an arrangement that constrains the accessible gripping locations. In some implementations, offset picking can allow the gripper assembly to pick a panel from a pallet position that is near the edge of the pallet, where a centered grip would require the robotic arm to extend beyond its reachable workspace. In some implementations, the offset between the center of the gripper assembly and the center of the panel can be about 50 mm, about 100 mm, about 200 mm, about 300 mm, or about 500 mm, among others, depending on the panel dimensions and the operational constraints of the robotic system.

In some implementations, the controller 1010 can determine the offset between the center of the gripper assembly 1003 and the center of the solar panel 1802 based on image data from the image sensors 1302 and/or the image sensors 1320 and based on the known dimensions of the solar panel 1802. The controller 1010 can select the offset based on the travel direction of the movable base 1002, the side to which the articulated arm 1006 will deploy the solar panel 1802, and the position of the electrical lead terminals on the solar panel 1802, such that the selected offset provides the articulated arm 1006 with sufficient reach to place the solar panel 1802 at the mounting location 1808.

In some implementations, the gripper assembly can grasp the back surface of a solar panel for installation. The front surface of the solar panel can include the photovoltaic cells that capture sunlight and convert it into electrical energy, and can be covered by a protective glass or transparent layer to maximize light absorption. The back surface of the solar panel, in contrast, can include a protective back sheet, a junction box, and electrical leads or connectors for routing the generated electrical current. Because the front surface is the active energy-generating side of the panel, it can be desirable to avoid contact with the front surface during handling to mitigate damage, soiling, or obstruction that could reduce the panel's efficiency. Grasping the back of the solar panel can avoid contact with the photovoltaic surface, can reduce the risk of contamination or scratching, can preserve panel efficiency, and can allow the front surface to remain exposed during the placement operation. In some implementations, grasping the back surface can allow visual inspection sensors mounted on the gripper assembly to view the front surface of the panel during or after placement, which can enable quality verification without additional handling steps.

The suction cup mounts 152 can incorporate a degree of flexibility or adjustability, allowing the suction cups 108 to move and adjust their positions relative to the frame structure 102. This adjustability can allow the suction cups 108 to accommodate variations in the back surface of solar panels being gripped. In some implementations, the suction cup mounts 152 can include articulation points or flexible joints that permit limited movement in multiple directions, allowing each suction cup 108 to independently adjust its level and orientation when engaging the back of the panel. This adaptability can be beneficial when retaining solar panels that do not have flat or uniform rear surfaces due to the presence of junction boxes, electrical leads, adhesive pads, or other protrusions. The independent adjustment of each suction cup 108 can distribute the gripping force across the back panel surface, which can reduce the risk of damage to sensitive solar panel components during grasping and installation. Because the rear surface can include junction boxes and electrical leads, the adjustable and compliant suction cup mounts 152 can maintain distributed gripping force without damaging panel components by allowing each suction cup 108 to conform to the local surface topology at its respective mounting location. In some implementations, the compliance range of the suction cup mounts 152 can be sufficient to accommodate rear-surface protrusions of up to about 10 mm, about 20 mm, about 30 mm, or about 40 mm, among others, in height, depending on the type and arrangement of the junction box and other rear-surface features of the panel.

In some implementations, the gripper assembly can validate a solar panel prior to or during grasping for installation. For example, one or more sensors can detect surface features of the solar panel, including detecting cracks, verifying connector integrity, and assessing overall panel condition. In some implementations, the sensor can be a camera that captures images of the panel surface for visual inspection and validation. Other types of sensors, such as LIDAR, ultrasonic, or infrared sensors, can be employed for obstacle detection and avoidance, as well as for assessing panel surface conditions during the grasping operation. Control valves and pressure sensors disposed in-line with the vacuum circuit can be used to monitor for vacuum loss, which can indicate panel damage, cracks, or improper engagement by the suction cups 108. The suction cups 108 can be grouped into independently controllable zones, allowing selective activation of different suction zones based on panel size, shape, or condition detected during validation. For example, if a sensor detects a crack or damage to a portion of the panel surface, the corresponding suction zone can be deactivated to avoid contact with the damaged area, while the remaining zones can maintain engagement with the undamaged portions of the panel. In some implementations, the validation can include verifying that the vacuum level at each active suction zone meets a minimum threshold, which can confirm that each suction cup 108 has achieved a proper seal against the panel surface. In some implementations, if the vacuum level at one or more suction cups 108 falls below the threshold, the control system can generate an alert, can adjust the position of the gripper assembly to reestablish the seal, or can abort the pick operation to mitigate panel damage or dropping.

Although suction cups 108 are shown and described in the various embodiments herein, the gripper assembly is not limited to suction-based gripping. Other means of gripping can be implemented. For example, the gripper assembly can include mechanical clamping elements, such as toggle clamps, spring-loaded grippers, or pneumatic clamps, that mechanically grip the edges or surface of a solar panel. In some implementations, the gripper assembly can include adhesive pads or gecko-inspired adhesive surfaces that provide adhesion to the panel surface without requiring vacuum. In some implementations, the gripper assembly can include a combination of suction cups 108 and mechanical clamps, such that the suction cups 108 provide primary gripping force and the mechanical clamps provide supplemental retention. These and other object engagement structures can be suitable for retaining a solar panel or other planar object against the frame structure 102 during manipulation and transport.

Although the gripper assembly is described herein with reference to solar panel handling and installation, the assembly can be used for a variety of other applications involving handling of other objects. For example, the gripper assembly can accommodate varying object geometries, weights, or surface materials. The gripper assembly can be used in the installation or handling of glass panes, architectural panels, composite sheets, insulating panels, sheet metal, electronic display panels, large planar manufactured parts, and fragile construction materials. The rotational actuation system, the compliant suction cup mounts 152, and the lightweight frame construction described herein can be adapted for use with these and other objects that benefit from distributed, low-stress gripping and precise rotational repositioning during automated handling operations. In some implementations, the gripper assembly can be used in manufacturing environments for transferring sheet goods between production stations, in warehousing environments for palletizing and depalletizing planar objects, or in construction environments for positioning facade panels, curtain wall elements, or roofing materials. The rotational capability of the gripper assembly can provide an additional degree of manipulation freedom that can simplify the handling of planar objects that are to be reoriented during transfer from one location to another.

### C. Gripper Assembly for Solar Panel Mounting and Installation

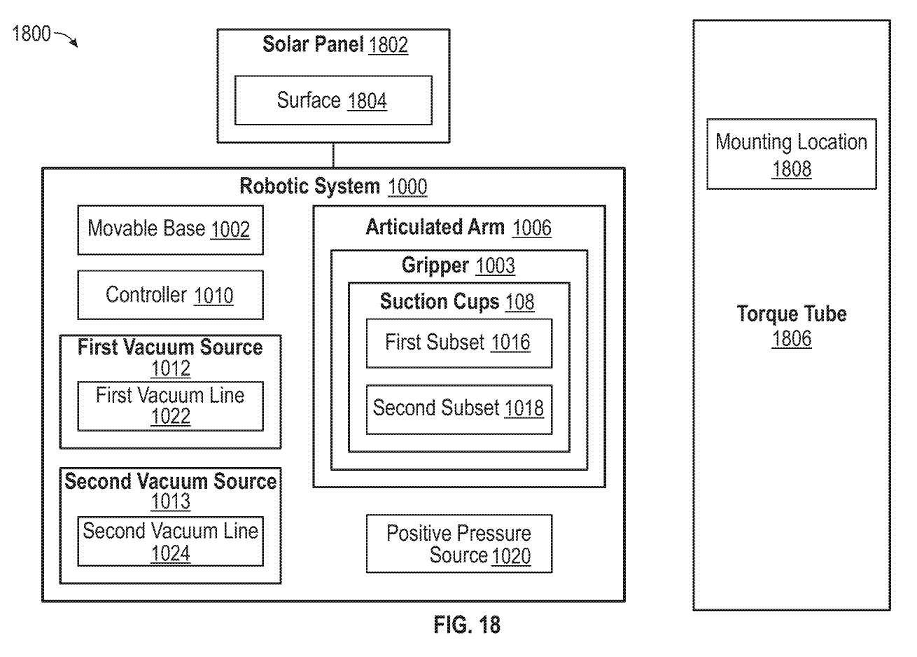

Referring now to FIG. 18, illustrated is a schematic diagram of the robotic system 1000 operating in an environment 1800 (e.g., a solar farm site, photovoltaic installation field, panel deployment zone, outdoor construction environment, etc.) that includes a solar panel 1802 (e.g., a photovoltaic module, solar cell panel, etc.) and a torque tube 1806 (e.g., a mounting rail, structural support pipe, panel support bar, elongate racking tube, etc.) having a mounting location 1808 (e.g., a panel seat, designated placement position, target installation site, racking attachment point, etc.), in accordance with one or more implementations. FIG. 18 can depict the robotic system 1000 with redundant vacuum sources and a positive pressure source 1020 for picking the solar panel 1802 from a staging position and placing the solar panel 1802 at the mounting location 1808 on the torque tube 1806. As shown in FIG. 18, the robotic system 1000 can include a movable base 1002 (e.g., tracked vehicle, mobile platform, wheeled chassis, etc.), an articulated arm 1006 (e.g., multi-joint robotic arm, serial kinematic manipulator, multi-axis positioner, etc.) disposed on the movable base 1002, and a gripper assembly 1003 (e.g., vacuum-actuated end effector, suction-based gripping tool, panel retention head, vacuum pickup assembly, etc.) coupled to a distal end of the articulated arm 1006. The movable base 1002 can house a controller 1010, a first vacuum source 1012 (e.g., first vacuum pump, negative-pressure generator, suction compressor, etc.), a second vacuum source 1013 (e.g., second vacuum pump, negative-pressure generator, suction compressor,), a positive pressure source 1020 (e.g., compressed air source, pneumatic pressure supply, air compressor, etc.), a first vacuum line 1022 (e.g., first fluid conduit, first pneumatic tube, first vacuum hose, etc.), and a second vacuum line 1024 (e.g., second fluid conduit, first pneumatic tube, first vacuum hose, etc.). The gripper assembly 1003 can include a plurality of suction cups 108 (e.g., vacuum cups, suction pads, pneumatic adhesion disc, vacuum retention elements, etc.) arranged to engage a surface 1804 (e.g., a rear face, backsheet side, non-active surface, or underside contact area) of the solar panel 1802. The plurality of suction cups 108 can include a first subset 1016 (e.g., first group, etc.) of the plurality of suction cups 108 and a second subset 1018 (e.g., second group, etc.) of the plurality of suction cups 108. The robotic system 1000 can pick the solar panel 1802 from the environment 1800 by coupling the suction cups 108 to the surface 1804 of the solar panel 1802 via vacuum generated by the first vacuum source 1012 and the second vacuum source 1013, and can place the solar panel 1802 at the mounting location 1808 on the torque tube 1806 by deactivating vacuum and activating the positive pressure source 1020 to release the solar panel 1802.

The environment 1800 can be a solar panel installation site that includes one or more rows along which the robotic system 1000 travels. The environment 1800 can include staging areas where solar panels such as the solar panel 1802 are positioned ahead of the robotic system 1000 in a travel direction, and racking infrastructure such as the torque tube 1806 disposed adjacent to the rows. The torque tube 1806 can extend along a row of the environment 1800 and can include hat rails or other mounting features that receive and retain solar panels at designated positions. The mounting location 1808 can be a designated position on the torque tube 1806 where the solar panel 1802 is to be placed. In some implementations, the mounting location 1808 can be a position on the torque tube 1806 between two hat rails, where the solar panel 1802 rests on the hat rails after placement. In some implementations, the mounting location 1808 can be proximate to a previously placed solar panel, such that the controller 1010 determines the mounting location 1808 based on a reference location of the previously placed solar panel, as described herein.

The solar panel 1802 can be a photovoltaic module that converts sunlight into electrical energy. The solar panel 1802 can include a front surface having photovoltaic cells and a rear surface that includes a protective back sheet, a junction box, and electrical lead terminals. The surface 1804 can be the rear surface or underside of the solar panel 1802, which is the surface engaged by the suction cups 108 of the gripper assembly 1003 during pick-and-place operations. In some implementations, the surface 1804 can be a non-active surface of the solar panel 1802 that does not include photovoltaic cells.

By engaging the surface 1804 rather than the front photovoltaic surface, the gripper assembly 1003 can reduce the risk of contamination, scratching, or micro-damage to the active light-receiving surface of the solar panel 1802 during transport and placement. In some implementations, the surface 1804 can include local surface irregularities such as junction boxes, electrical leads, adhesive pads, or label stickers, and the suction cups 108 of the gripper assembly 1003 can include compliant suction cup mounts that accommodate these surface variations, as described herein.

The movable base 1002 can house a battery system that provides electrical power to the articulated arm 1006, the controller 1010, the first vacuum source 1012, the second vacuum source 1013, and the positive pressure source 1020. The movable base 1002 can remain oriented along the travel direction during pick-and-place operations, such that the movable base 1002 does not turn left or right when the articulated arm 1006 picks and places the solar panel 1802.

The articulated arm 1006 can be disposed on the movable base 1002 and can carry the gripper assembly 1003 at a distal end of the articulated arm 1006. As described with respect to FIGS. 1-3, the articulated arm 1006 can be a multi-joint robotic arm that provides six degrees of freedom through six rotational joints arranged in a serial kinematic chain. The articulated arm 1006 can position the gripper assembly 1003 at a range of positions and orientations relative to the movable base 1002, including positions that are forward of the movable base 1002 for panel pickup, positions that are lateral to the movable base 1002 for panel transport, and positions that are above the movable base 1002 for panel placement onto the torque tube 1806. The articulated arm 1006 can include an arm controller (e.g., first or second controller, etc.) that receives control signals from the controller 1010 and that generates joint-level motor commands to position the articulated arm 1006 at commanded poses.

The controller 1010 can be communicatively coupled with the movable base 1002 and can coordinate the operation of the articulated arm 1006, the gripper assembly 1003, the first vacuum source 1012, the second vacuum source 1013, and the positive pressure source 1020 during pick-and-place operations. The controller 1010 can transmit a first signal to the articulated arm 1006 to control movement of the articulated arm 1006 and can transmit a second signal different from the first signal to control activation of the first vacuum source 1012 and the second vacuum source 1013. The first signal can include joint-level position commands or trajectory commands that cause the arm controller of the articulated arm 1006 to move the gripper assembly 1003 to a commanded pose. The second signal can include vacuum activation commands that cause one or both of the first vacuum source 1012 and the second vacuum source 1013 to generate negative pressure at the suction cups 108. The controller 1010 can transmit at least one of the first signal or the second signal in response to receiving user input requesting movement of the solar panel 1802. For example, the controller 1010 can transmit both the first signal and the second signal in response to an operator pressing a pick button on a user interface. In some implementations, the controller 1010 can transmit additional control signals to the actuator of the gripper assembly 1003 to rotate the solar panel 1802 to a target orientation. The controller 1010 can transmit the arm movement signal and the actuator rotation signal simultaneously, such that the articulated arm 1006 is moving while the actuator of the gripper assembly 1003 is simultaneously rotating the solar panel 1802.

The first vacuum source 1012 can be housed on the movable base 1002 and can generate negative pressure for coupling the first subset 1016 of the plurality of suction cups 108 to the surface 1804 of the solar panel 1802. The first vacuum source 1012 can include one or more vacuum pumps, such as a diaphragm pump, a piston pump, or a rotary vane pump. The first vacuum source 1012 can be fluidly coupled to the first subset 1016 of the plurality of suction cups 108 through the first vacuum line 1022. The first vacuum line 1022 can be routed from the first vacuum source 1012 on the movable base 1002 through or alongside the articulated arm 1006 to the gripper assembly 1003, and can terminate at the ports of the suction cup mounts corresponding to the first subset 1016 of the plurality of suction cups 108. When the first vacuum source 1012 is activated, negative pressure can be supplied through the first vacuum line 1022 to the first subset 1016 of the plurality of suction cups 108, which can draw those suction cups 108 against the surface 1804 of the solar panel 1802 and couple the gripper assembly 1003 to the solar panel 1802. In some implementations, the first subset 1016 of the plurality of suction cups 108 can include one or more suction cups 108. In some implementations, the first subset 1016 can include at least two suction cups 108. The first vacuum source 1012 can be individually sufficient to provide suction to maintain coupling of the solar panel 1802 to the gripper assembly 1003 via the first subset 1016 of the plurality of suction cups 108, independent of the second vacuum source 1013.

The second vacuum source 1013 can be housed on the movable base 1002 and can generate negative pressure for coupling the second subset 1018 of the plurality of suction cups 108 to the surface 1804 of the solar panel 1802. The second vacuum source 1013 can include one or more vacuum pumps, such as a diaphragm pump, a piston pump, or a rotary vane pump. The second vacuum source 1013 can be fluidly coupled to the second subset 1018 of the plurality of suction cups 108 through the second vacuum line 1024. The second vacuum line 1024 can be a fluid line that is separate from the first vacuum line 1022. The second vacuum line 1024 can be routed from the second vacuum source 1013 on the movable base 1002 through or alongside the articulated arm 1006 to the gripper assembly 1003, and can terminate at the ports of the suction cup mounts corresponding to the second subset 1018 of the plurality of suction cups 108. When the second vacuum source 1013 is activated, negative pressure can be supplied through the second vacuum line 1024 to the second subset 1018 of the plurality of suction cups 108, which can draw those suction cups 108 against the surface 1804 of the solar panel 1802. In some implementations, the second subset 1018 of the plurality of suction cups 108 can include one or more suction cups 108. In some implementations, the second subset 1018 can include at least two suction cups 108. The second vacuum source 1013 can be individually sufficient to provide suction to maintain coupling of the solar panel 1802 to the gripper assembly 1003 via the second subset 1018 of the plurality of suction cups 108, independent of the first vacuum source 1012. Each of the first vacuum source 1012 and the second vacuum source 1013 can be coupled to at least one of the suction cups 108 of the plurality of suction cups 108.

The separation of the first vacuum line 1022 and the second vacuum line 1024 as independent fluid paths can provide redundancy in the vacuum system of the robotic system 1000. Because the first vacuum source 1012 and the second vacuum source 1013 are coupled to different subsets of the plurality of suction cups 108 through separate vacuum lines, a failure of one vacuum source or one vacuum line does not deactivate the suction capability at all of the suction cups 108. For example, if the second vacuum source 1013 experiences a pump failure or if the second vacuum line 1024 experiences a line rupture, the first vacuum source 1012 can continue to maintain vacuum at the first subset 1016 of the plurality of suction cups 108 through the first vacuum line 1022, retaining the solar panel 1802 against the gripper assembly 1003. Similarly, if the first vacuum source 1012 experiences a failure, the second vacuum source 1013 can continue to maintain vacuum at the second subset 1018 of the plurality of suction cups 108 through the second vacuum line 1024. The controller 1010 can maintain coupling of the gripper assembly 1003 to the solar panel 1802 through at least one of the first vacuum source 1012 or the second vacuum source 1013 in response to loss of vacuum from the other of the first vacuum source 1012 or the second vacuum source 1013. This dual-path vacuum architecture can mitigate a single-point vacuum failure from resulting in a dropped solar panel 1802 during transport between the staging position and the mounting location 1808.

The controller 1010 can control the first vacuum source 1012 and the second vacuum source 1013 using a common vacuum control signal or using independent vacuum control signals. When a common vacuum control signal is used, the controller 1010 can transmit a single activation command that causes both the first vacuum source 1012 and the second vacuum source 1013 to activate simultaneously. When independent vacuum control signals are used, the controller 1010 can transmit a first vacuum control signal to the first vacuum source 1012 and a second vacuum control signal different from the first vacuum control signal to the second vacuum source 1013. The independent vacuum control signals can allow the controller 1010 to activate, deactivate, or adjust the first vacuum source 1012 and the second vacuum source 1013 independently of one another. For example, the controller 1010 can activate both vacuum sources simultaneously during a pick operation and can deactivate one vacuum source while maintaining the other vacuum source during a diagnostic or test operation. In some implementations, the controller 1010 can monitor the vacuum pressure at each vacuum source or at each suction cup 108 via pressure sensors disposed in-line with the first vacuum line 1022 and/or the second vacuum line 1024, and can generate an alert or take corrective action if the vacuum pressure at one vacuum source falls below a threshold.

The controller 1010 can initiate activation of at least one of the first vacuum source 1012 or the second vacuum source 1013 in response to the gripper assembly 1003 being within a threshold distance from the solar panel 1802. The threshold distance can be a predetermined distance at which the controller 1010 activates the vacuum sources so that vacuum reaches operating capacity before the suction cups 108 make physical contact with the surface 1804 of the solar panel 1802. For example, the controller 1010 can determine that the gripper assembly 1003 is within the threshold distance from the solar panel 1802 based on image data from one or more image sensors coupled to the articulated arm 1006 and/or to the movable base 1002, or based on the pose information reported by the arm controller of the articulated arm 1006. In response to determining that the gripper assembly 1003 is within the threshold distance, the controller 1010 can transmit an activation command to the first vacuum source 1012 and/or the second vacuum source 1013 to begin generating negative pressure. By the time the suction cups 108 make physical contact with the surface 1804, the vacuum can be at operating capacity, which can provide immediate suction engagement. In some implementations, the threshold distance can be about 50 mm, about 100 mm, about 200 mm, or about 500 mm, among others, depending on the spin-up time of the vacuum pumps and the approach speed of the articulated arm 1006. In some implementations, the controller 1010 can activate the first vacuum source 1012 and the second vacuum source 1013 in response to the plurality of suction cups 108 contacting the surface 1804 of the solar panel 1802.

The positive pressure source 1020 can be housed on the movable base 1002 and can be fluidly coupled to the plurality of suction cups 108. The positive pressure source 1020 can include a compressed air source, such as a compressor, an air tank, or an accumulator, that generates positive pressure. The positive pressure source 1020 can be fluidly coupled to the plurality of suction cups 108 through the same fluid lines used for vacuum. In some implementations, the positive pressure source 1020 can share the first vacuum line 1022 and/or the second vacuum line 1024 with the first vacuum source 1012 and the second vacuum source 1013, such that the robotic system 1000 can switch between a vacuum mode in which negative pressure is generated at the suction cups 108 and a positive pressure mode in which compressed air is delivered through the suction cups 108. One or more valves can be disposed in-line with the fluid lines to selectively route vacuum or positive pressure to the suction cups 108 based on the operating mode. When the positive pressure source 1020 is activated, compressed air can flow through the fluid lines and through the ports of the suction cup mounts to the suction cups 108, generating a positive air pressure at the interface between the suction cups 108 and the surface 1804 of the solar panel 1802. This positive air pressure can break residual stiction between the suction cups 108 and the surface 1804 and can release the solar panel 1802 from the gripper assembly 1003.

In some implementations, the positive pressure delivered by the positive pressure source 1020 can exceed the residual vacuum pressure at the suction cup interface by at least about 5 psi, about 10 psi, about 20 psi, or about 30 psi, among others. This pressure differential can be selected to overcome the residual stiction force between the suction cups 108 and the surface 1804 of the solar panel 1802 within the predetermined time period. In some implementations, the controller 1010 can ramp up the positive pressure gradually over the predetermined time period rather than applying the full positive pressure instantaneously, which can reduce the risk of the solar panel 1802 being displaced from the mounting location 1808 by a sudden burst of air.

The controller 1010 can control the articulated arm 1006 to position the gripper assembly 1003 adjacent to the solar panel 1802 during a pick phase of an installation cycle. The controller 1010 can receive image data from one or more image sensors coupled to the articulated arm 1006 and/or to the movable base 1002 and can determine the position and orientation of the solar panel 1802 in the environment 1800. Based on the determined position and orientation, the controller 1010 can transmit a control signal to the arm controller of the articulated arm 1006 to extend the articulated arm 1006 forward from the movable base 1002 and to move the gripper assembly 1003 toward the surface 1804 of the solar panel 1802. In some implementations, the solar panel 1802 can be staged ahead of the robotic system 1000 in a semi-vertical or upright orientation, and the articulated arm 1006 can extend forward to engage the underside of the staged solar panel 1802. In some implementations, the controller 1010 can use image data from the image sensors to determine the position of at least one electrical lead terminal on the solar panel 1802 and can select a coupling location on the surface 1804 based on the terminal position, the travel direction of the movable base 1002, and the side to which the articulated arm 1006 will deploy the solar panel 1802, as described herein.

The controller 1010 can activate the first vacuum source 1012 and the second vacuum source 1013 to couple the plurality of suction cups 108 to the surface 1804 of the solar panel 1802. As described above, the controller 1010 can activate one or both of the vacuum sources while the gripper assembly 1003 is approaching the solar panel 1802, such that negative pressure is at operating capacity by the time the suction cups 108 make physical contact with the surface 1804. The first subset 1016 of the plurality of suction cups 108 can be coupled to the surface 1804 via vacuum generated by the first vacuum source 1012 through the first vacuum line 1022. The second subset 1018 of the plurality of suction cups 108 can be coupled to the surface 1804 via vacuum generated by the second vacuum source 1013 through the second vacuum line 1024. The combined suction from the first subset 1016 and the second subset 1018 can distribute the gripping force across a broad area of the surface 1804, which can reduce localized stress concentrations and can provide stable retention of the solar panel 1802 during transport. At this point in the pick phase, the solar panel 1802 can have a first orientation relative to the movable base 1002, such as a semi-vertical orientation consistent with how the solar panel 1802 was staged in the environment 1800.

The controller 1010 can control the articulated arm 1006 to move the solar panel 1802 to the mounting location 1808 while maintaining suction via the plurality of suction cups 108, the first vacuum source 1012, and the second vacuum source 1013. During a placement phase, the controller 1010 can transmit control signals to the arm controller (e.g., second controller associated with articulated arm 1006) of the articulated arm 1006 to rotate and translate the solar panel 1802 laterally in a direction transverse to the travel direction of the movable base 1002. Because the gripper assembly 1003 holds the underside of the solar panel 1802, the solar panel 1802 rides above the gripper assembly 1003 during the lateral movement, and the articulated arm 1006 can swing the solar panel 1802 to the left or right side of the movable base 1002 and lower the solar panel 1802 onto the hat rails at the mounting location 1808 on the torque tube 1806. The controller 1010 can transmit a control signal to the actuator of the gripper assembly 1003 to rotate the frame structure and the solar panel 1802 by about 90 degrees relative to the articulated arm 1006 during transport, such that the solar panel 1802 arrives at the mounting location 1808 in a second orientation different from the first orientation. In some implementations, the controller 1010 can transmit the arm movement signal and the actuator rotation signal simultaneously, such that the articulated arm 1006 is moving while the actuator is simultaneously rotating the solar panel 1802. Throughout the transport from the staging position to the mounting location 1808, the first vacuum source 1012 and the second vacuum source 1013 can remain active to maintain suction at the suction cups 108.

The controller 1010 can maintain the first vacuum source 1012 and the second vacuum source 1013 in an active state throughout the transport of the solar panel 1802 from the staging area to the mounting location 1808. At least one of the first vacuum source 1012 or the second vacuum source 1013 can remain active as a default state while the solar panel 1802 is coupled to the gripper assembly 1003. Vacuum termination can occur in response to an affirmative release command from the controller 1010, and the absence of a control signal, a communication loss between the controller 1010 and a remote controller or user interface, or a fault in the controller 1010 does not by itself deactivate the vacuum. For example, if communication with a remote user interface is lost during transport, the first vacuum source 1012 and the second vacuum source 1013 can continue to generate negative pressure at the suction cups 108 and can retain the solar panel 1802 against the gripper assembly 1003. Similarly, if the controller 1010 experiences a reboot or a temporary fault, the vacuum can persist in the active state absent an affirmative deactivation command. This fail-safe persistence behavior can mitigate the solar panel 1802 from being dropped during a communication interruption or a controller fault event.

The controller 1010 can deactivate the first vacuum source 1012 and the second vacuum source 1013 and can activate the positive pressure source 1020 to release the solar panel 1802 from the plurality of suction cups 108 based on the solar panel 1802 being proximate to the mounting location 1808. During a release phase, the controller 1010 can determine that the solar panel 1802 is within a distance threshold of the mounting location 1808 on the torque tube 1806. The distance threshold can be a predetermined distance at which the controller 1010 deactivates vacuum and activates positive pressure to release the solar panel 1802. In some implementations, the controller 1010 can determine the distance between the solar panel 1802 and the mounting location 1808 based on image data from image sensors coupled to the articulated arm 1006 and/or to the movable base 1002, based on the pose information reported by the arm controller of the articulated arm 1006, or based on a combination of image data and pose information. In response to determining that the solar panel 1802 is within the distance threshold, the controller 1010 can transmit a deactivation command to the first vacuum source 1012 and the second vacuum source 1013 and can transmit an activation command to the positive pressure source 1020. The positive pressure source 1020 can deliver compressed air through the fluid lines and through the suction cups 108 to break residual stiction between the suction cups 108 and the surface 1804 of the solar panel 1802. The solar panel 1802, gripped from underneath by the gripper assembly 1003, can settle onto the hat rails at the mounting location 1808 on the torque tube 1806 as the suction is released and the positive air pressure is applied.

In some implementations, the controller 1010 can deactivate the vacuum and activate the positive pressure source 1020 in response to user input. For example, an operator can press a release button on a user interface coupled to the controller 1010, and the controller 1010 can deactivate the first vacuum source 1012 and the second vacuum source 1013 and can activate the positive pressure source 1020 in response to receiving the release button input. In some implementations, the controller 1010 can deactivate the vacuum and activate the positive pressure source 1020 in response to a position of the solar panel 1802 satisfying a condition. The condition can include at least one of a distance of the solar panel 1802 to the mounting location 1808 falling below a threshold, an orientation of the solar panel 1802 matching a target orientation, a length of time elapsing from a reference event, or contact of the solar panel 1802 at the mounting location 1808 being detected. For example, the controller 1010 can determine that the distance between the solar panel 1802 and the mounting location 1808 has fallen below 10 mm and can deactivate the vacuum and activate the positive pressure source 1020 in response. In some implementations, the controller 1010 can determine that the solar panel 1802 has achieved a target angular orientation relative to the torque tube 1806 and can trigger the release in response. In some implementations, the controller 1010 can detect physical contact between the solar panel 1802 and the hat rails at the mounting location 1808 based on a force sensor, a current spike in a joint motor of the articulated arm 1006, or a change in vacuum pressure, and can trigger the release in response to the detected contact.

The controller 1010 can activate the positive pressure source 1020 for a predetermined time period and can automatically deactivate the positive pressure source 1020 after the predetermined time period elapses. The predetermined time period can be selected to provide sufficient positive air pressure to break the residual stiction between the suction cups 108 and the surface 1804 of the solar panel 1802. In some implementations, the predetermined time period can be about 0.5 seconds, about 1 second, about 2 seconds, or about 5 seconds. After the predetermined time period elapses, the controller 1010 can transmit a deactivation command to the positive pressure source 1020 to stop the flow of compressed air through the suction cups 108. In some implementations, the controller 1010 can control the articulated arm 1006 to move toward the movable base 1002 while the positive pressure source 1020 is activated. This retraction of the articulated arm 1006 while positive pressure is still active can assist in physically separating the suction cups 108 from the surface 1804 of the solar panel 1802. As the articulated arm 1006 retracts and the gripper assembly 1003 moves away from the solar panel 1802, the combination of the positive air pressure and the physical separation can release the solar panel 1802 from the suction cups 108. In some implementations, the controller 1010 can apply a slight oscillation or jiggle motion to the articulated arm 1006 during the release to overcome stiction between the suction cups 108 and the surface 1804.

After the solar panel 1802 is released at the mounting location 1808 on the torque tube 1806, the controller 1010 can control the articulated arm 1006 to retract to a neutral position. The articulated arm 1006 can retract in a third direction transverse to the travel direction and to the lateral placement direction, and can return the gripper assembly 1003 to a position adjacent to or above the movable base 1002. For example, the articulated arm 1006 retracts away from and below the solar panel 1802 and back towards the movable base 1002. The controller 1010 can command the movable base 1002 to advance along the row in the environment 1800 to the position of the next staged solar panel, and the pick-and-place cycle can repeat. In some implementations, the controller 1010 can operate in a first operating mode when the movable base 1002 moves in a first direction, such as south to north, along a first row, and in a second operating mode when the movable base 1002 moves in a second direction opposite the first direction, such as north to south, along a second row. In the second operating mode, the controller 1010 can determine a different coupling location on the next solar panel and a different mounting location 1808 on the torque tube 1806 based on the reversed travel direction.

The controller 1010 can determine the mounting location 1808 on the torque tube 1806 based on image data from one or more image sensors coupled to the articulated arm 1006 and/or to the movable base 1002 and based on a reference location of a previously placed solar panel. As described herein, the controller 1010 can identify a first mounting location of a first solar panel that has been previously placed on the torque tube 1806 and can use the first mounting location as a reference anchor for determining the mounting location 1808 for the solar panel 1802. The controller 1010 can obtain image data from the image sensors depicting the environment 1800 including the torque tube 1806 and the previously placed solar panel. Based on the image data and the first mounting location, the controller 1010 can determine the mounting location 1808 for the solar panel 1802, where the mounting location 1808 can be proximate to the first mounting location. In some implementations, the controller 1010 can select which image sensor to use for determining the mounting location 1808 based on imaging conditions such as time of day and sun angle. For example, if a west-facing image sensor on the movable base 1002 is affected by glare near sunset, the controller 1010 can select a different image sensor that is not affected by the glare condition.

The controller 1010 can determine whether the solar panel 1802 is within a threshold distance of the mounting location 1808 before executing the release operation. The controller 1010 can withhold the release operation when the movable base 1002 is too far from the torque tube 1806 for the articulated arm 1006 to reach the mounting location 1808. In some implementations, the controller 1010 can determine that the movable base 1002 is beyond a threshold distance from the torque tube 1806 based on image data from the image sensors or based on the pose information from the arm controller. While the solar panel 1802 remains coupled to the gripper assembly 1003, the controller 1010 can adjust the position of the movable base 1002 by moving the movable base 1002 toward the torque tube 1806. After the movable base 1002 is within a second threshold distance of the torque tube 1806, the controller 1010 can control the articulated arm 1006 to finalize placement of the solar panel 1802 at the mounting location 1808 and can execute the release operation. In some implementations, a user interface can display graphical indicators including the mounting location 1808, a distance from the movable base 1002 to the torque tube 1806, and a distance from the solar panel 1802 to the mounting location 1808. The graphical indicators can include color coding, such as red, yellow, and green indicators, to represent proximity and alignment of the solar panel 1802 to the mounting location 1808.

The controller 1010 can use image data from one or more image sensors to determine the position of at least one electrical lead terminal on the solar panel 1802 and can select a coupling location and a mounting orientation based on the determined terminal position. As described herein, each solar panel can have two electrical lead terminals, such as a positive terminal and a negative terminal, at predetermined locations on the panel. The controller 1010 can receive image data from an image sensor coupled to the articulated arm 1006 or from an image sensor coupled to the movable base 1002 and can identify which edge of the solar panel 1802 carries the negative terminal and which edge carries the positive terminal. The identification can be based on visible connector characteristics in the image data, including male versus female connector structure and tip or housing coloration. Based on the determined terminal position, the travel direction of the movable base 1002, and the side to which the articulated arm 1006 will deploy the solar panel 1802, the controller 1010 can select a coupling location on the surface 1804 and a rotation path, such as a clockwise rotation or a counterclockwise rotation. The controller 1010 can select among predetermined rotation paths rather than computing a new trajectory in real time. After the solar panel 1802 is placed at the mounting location 1808 on the torque tube 1806, the electrical lead terminal can be positioned proximate to a target connector coupled to the torque tube 1806, which can allow all panels along a row to be installed with consistent electrical polarity orientation.

FIG. 18 can illustrate the fluid coupling relationships among the first vacuum source 1012, the second vacuum source 1013, the positive pressure source 1020, the first vacuum line 1022, the second vacuum line 1024, and the suction cups 108 of the gripper assembly 1003. The first vacuum line 1022 can extend from the first vacuum source 1012 on the movable base 1002 to the first subset 1016 of the plurality of suction cups 108 on the gripper assembly 1003. The second vacuum line 1024 can extend from the second vacuum source 1013 on the movable base 1002 to the second subset 1018 of the plurality of suction cups 108 on the gripper assembly 1003. The first vacuum line 1022 and the second vacuum line 1024 can be separate fluid lines that do not share a common conduit between the movable base 1002 and the gripper assembly 1003. The first vacuum line 1022 and the second vacuum line 1024 can be routed through or alongside the articulated arm 1006 from the movable base 1002 to the gripper assembly 1003. In some implementations, the first vacuum line 1022 and the second vacuum line 1024 can be flexible tubing, such as polyurethane tubing, silicone tubing, or reinforced rubber tubing, that accommodates the movement of the articulated arm 1006 without kinking or restricting joint rotation. The first vacuum line 1022 and the second vacuum line 1024 can be secured to the articulated arm 1006 using clips, ties, or channels that mitigate the tubing from interfering with the joints of the articulated arm 1006 or with the rotation of the frame structure of the gripper assembly 1003 relative to the frame mounting structure.

In some implementations, the positive pressure source 1020 can be fluidly coupled to the suction cups 108 through the same fluid lines as the first vacuum source 1012 and the second vacuum source 1013. For example, the positive pressure source 1020 can share the first vacuum line 1022 and/or the second vacuum line 1024 with the corresponding vacuum source, with one or more switching valves disposed in-line to alternate between vacuum mode and positive pressure mode. When the switching valves are in a vacuum position, negative pressure from the first vacuum source 1012 or the second vacuum source 1013 can be transmitted through the corresponding vacuum line to the suction cups 108. When the switching valves are in a positive pressure position, compressed air from the positive pressure source 1020 can be transmitted through the corresponding fluid line to the suction cups 108. The controller 1010 can control the switching valves to transition from the vacuum position to the positive pressure position during the release phase. In some implementations, the switching valves can be solenoid-actuated valves, pneumatic valves, or electrically actuated ball valves. In some implementations, the positive pressure source 1020 can include a compressor, a compressed air tank, or a pressure regulator that maintains a positive pressure supply at a predetermined pressure level, such as about 30 psi, about 50 psi, about 60 psi, or about 80 psi, among others.

In some implementations, the first subset 1016 of the plurality of suction cups 108 can include suction cups 108 positioned at a first pair of corners of the frame structure and the second subset 1018 of the plurality of suction cups 108 can include suction cups 108 positioned at a second pair of corners of the frame structure. In some implementations, the first subset 1016 can include three suction cups 108 and the second subset 1018 can include one or two suction cups 108, or vice versa. The allocation of suction cups 108 between the first subset 1016 and the second subset 1018 can be selected based on the weight of the solar panel 1802 and the suction force generated by each suction cup 108 at the operating vacuum level. Each vacuum source, operating through its respective subset of suction cups 108, can generate sufficient suction force to retain the solar panel 1802 against the gripper assembly 1003 under the dynamic loads encountered during transport, including gravitational loads, inertial loads from arm acceleration and deceleration, and wind loads. In some implementations, the solar panel 1802 can weigh up to about 40 kg, and each of the first vacuum source 1012 and the second vacuum source 1013 can generate suction sufficient to retain a 40 kg panel through its respective subset of suction cups 108, such that the loss of one vacuum source does not result in the solar panel 1802 being released during transport.

The controller 1010 can coordinate the operation of the first vacuum source 1012, the second vacuum source 1013, the positive pressure source 1020, and the articulated arm 1006 across the pick, placement, and release phases of the installation cycle. During the pick phase, the controller 1010 can transmit a first signal to the arm controller of the articulated arm 1006 to position the gripper assembly 1003 adjacent to the solar panel 1802 and can transmit a second signal to activate the first vacuum source 1012 and the second vacuum source 1013. The controller 1010 can transmit both signals in response to receiving a single user input, such as an operator pressing a pick button on the user interface. During the placement phase, the controller 1010 can transmit control signals to the arm controller and to the actuator of the gripper assembly 1003 to transport and rotate the solar panel 1802 to the mounting location 1808 on the torque tube 1806 while the first vacuum source 1012 and the second vacuum source 1013 remain active. During the release phase, the controller 1010 can deactivate at least one of the first vacuum source 1012 or the second vacuum source 1013 and can activate the positive pressure source 1020 in response to determining that the solar panel 1802 is within the distance threshold of the mounting location 1808. The controller 1010 can activate the positive pressure source 1020 for the predetermined time period and can control the articulated arm 1006 to retract toward the movable base 1002 while the positive pressure source 1020 is active. After the solar panel 1802 is released and the articulated arm 1006 is retracted to the neutral position, the controller 1010 can deactivate the positive pressure source 1020 and can command the movable base 1002 to advance to the next staged solar panel.

In some implementations, the suction cups 108 can be grouped into independently controllable zones. The independently controllable zones can allow the controller 1010 to selectively activate different groups of suction cups 108 based on the size, shape, or condition of the solar panel 1802 being retained. For example, when retaining a smaller panel that does not span all suction cup 108 positions, the controller 1010 can activate a subset of the suction cups 108 that contact the panel surface while leaving the remaining suction cups 108 deactivated. In some implementations, the controller 1010 can monitor the vacuum pressure at each suction cup 108 or at each group of suction cups 108 via pressure sensors disposed in-line with the vacuum circuit. If the vacuum pressure at one or more suction cups 108 falls below a threshold, the controller 1010 can generate an alert, can adjust the position of the gripper assembly 1003 to reestablish the seal, or can abort the pick operation. In some implementations, the suction cups 108 can have a diameter of about 100 mm, about 125 mm, about 150 mm, or about 175 mm, among others. In some implementations, different suction cups 108 within the same gripper assembly 1003 can have different diameters.

In some implementations, the gripper assembly 1003 can include one or more image sensors mounted on the frame structure. The image sensors on the frame structure can detect the location, orientation, or surface features of the solar panel 1802 or other objects. In some implementations, the image sensors can include a monocular camera, a stereo camera pair, a depth camera, or a time-of-flight camera. The image sensors on the frame structure can capture image data of the surface 1804 of the solar panel 1802, including the position and orientation of the junction box and electrical leads. The controller 1010 can receive the image data from the image sensors on the frame structure and can use the image data to determine the rotation angle for the frame structure to position the electrical leads in a desired installation orientation. In some implementations, the image sensors on the frame structure can detect cracks, verify connector integrity, and assess overall panel condition of the solar panel 1802 prior to or during engagement by the suction cups 108.

In some implementations, the gripper assembly 1003 can include one or more connectors, such as rotation-limiting sensors, position feedback sensors, rotary encoders, or magnetic switches, that monitor the rotational position and motion of the frame structure relative to the frame mounting structure. The connectors can generate a signal when the frame structure reaches a predetermined angular position, which can mitigate over-rotation and associated entanglement of vacuum lines or electrical cables. The connectors can provide rotational position feedback to the controller 1010 for closed-loop rotational position control of the frame structure. In some implementations, the connectors can include a rotary encoder coupled to the rotational shaft or to one of the gears of the gear system, providing continuous angular position data with a resolution of about 0.1 degrees or finer. In some implementations, the connectors can include a pair of magnetic switches or Hall effect sensors positioned at predetermined angular positions on the frame mounting structure, with corresponding magnets mounted on the frame structure or on the rotational shaft.

FIG. 18 can illustrate the overall system architecture of the robotic system 1000 in the context of the environment 1800 that includes the solar panel 1802 to be picked and placed and the torque tube 1806 at which the solar panel 1802 is to be placed. The schematic relationships depicted in FIG. 18 can illustrate how the controller 1010 on the movable base 1002 coordinates the articulated arm 1006, the gripper assembly 1003 with the suction cups 108 divided into the first subset 1016 and the second subset 1018, the first vacuum source 1012 with the first vacuum line 1022, the second vacuum source 1013 with the second vacuum line 1024, and the positive pressure source 1020 to perform a complete pick-and-place cycle from the solar panel 1802 in the environment 1800 to the mounting location 1808 on the torque tube 1806.

The dual-path vacuum architecture depicted in FIG. 18, with the first vacuum source 1012 coupled to the first subset 1016 through the first vacuum line 1022 and the second vacuum source 1013 coupled to the second subset 1018 through the second vacuum line 1024, can provide redundancy such that a failure of one vacuum path does not result in a dropped solar panel 1802. The positive pressure source 1020 can be fluidly coupled to the plurality of suction cups 108 through shared fluid lines and can deliver compressed air to break residual stiction during the release of the solar panel 1802 at the mounting location 1808. The controller 1010 can coordinate the activation and deactivation of the vacuum sources and the positive pressure source 1020 in sequence with the movement of the articulated arm 1006 and the rotation of the gripper assembly 1003 to perform repeatable pick-and-place operations across multiple solar panels 1802 along a row of the environment 1800.

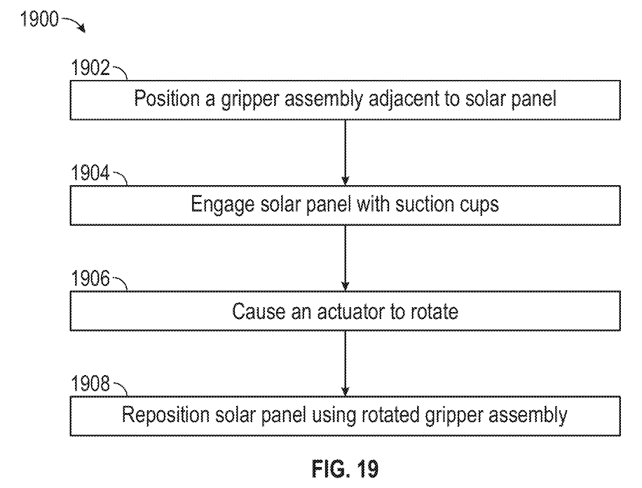

Referring now to FIG. 19, illustrated is a flow chart of a method 1900 for positioning a gripper assembly adjacent to a solar panel, engaging the solar panel with suction cups, causing an actuator to rotate, and repositioning the solar panel using a rotated gripper assembly, in accordance with one or more implementations. The method 1900 can be performed by a controller (e.g., the controller 1010) coupled to one or more processors and one or more memory devices storing instructions that, when executed by the one or more processors, cause the controller to perform the acts of the method 1900. The method 1900 can be performed in connection with a robotic system (e.g., the robotic system 1000) that includes a movable base (e.g., the movable base 1002), an articulated arm (e.g., the articulated arm 1006) disposed on the movable base, and a gripper assembly (e.g., the gripper assembly 1003) coupled to a distal end of the articulated arm. The gripper assembly can include a frame structure (e.g., the frame structure 102) and a plurality of suction cups (e.g., the suction cups 108) mounted to the frame structure. In some implementations, the frame structure can include a carbon fiber frame. The gripper assembly can include a rotational shaft and an actuator (e.g., the actuator 114) coupled to the rotational shaft, the actuator to rotate the frame structure via the rotational shaft.

At block 1902, the controller can position the gripper assembly adjacent to a solar panel (e.g., the solar panel 902). The controller can transmit a control signal to an arm controller of the articulated arm to extend the articulated arm from the movable base and to move the gripper assembly toward a first surface (e.g., the first surface 1804) of the solar panel. The first surface can be a rear surface or an underside of the solar panel. In some implementations, the controller can receive image data from one or more image sensors (e.g., the image sensors 1302 and/or the image sensors 1320) coupled to the movable base and/or to the articulated arm to determine a position and orientation of the solar panel. Based on the determined position and orientation, the controller can generate joint-level position commands or trajectory commands that cause the arm controller of the articulated arm to move the gripper assembly to a position adjacent to the first surface of the solar panel. In some implementations, the controller can determine a coupling location on the first surface based on a position of at least one electrical lead terminal on the solar panel, a travel direction of the movable base, and a side to which the articulated arm will deploy the solar panel.

At block 1904, the controller can engage the solar panel with the plurality of suction cups. The controller can activate a vacuum source (e.g., the vacuum source 1012) on the movable base to generate negative pressure at the plurality of suction cups. The negative pressure can draw the plurality of suction cups against the first surface of the solar panel and couple the gripper assembly to the solar panel. In some implementations, the controller can activate the vacuum source while the gripper assembly is approaching the solar panel, such that negative pressure is at operating capacity by the time the plurality of suction cups make physical contact with the first surface. In some implementations, engaging the solar panel can include independently adjusting each of the plurality of suction cups to engage the solar panel. Each suction cup can be mounted to the frame structure via a suction cup mount (e.g., the suction cup mount 152) that includes a compliant element permitting the suction cup to self-level relative to the first surface of the solar panel. The independent adjustment of each suction cup can accommodate variations in the surface geometry of the solar panel, including protrusions such as junction boxes, electrical leads, and adhesive pads on the rear surface. In some implementations, the vacuum source can include a first vacuum source and a second vacuum source, with a first subset of the plurality of suction cups fluidly coupled to the first vacuum source through a first vacuum line and a second subset of the plurality of suction cups fluidly coupled to the second vacuum source through a second vacuum line separate from the first vacuum line.

At block 1906, the controller can cause an actuator (e.g., actuator 114) coupled to a shaft of the gripper assembly to rotate the frame structure. The controller can transmit a control signal to the actuator of the gripper assembly to rotate the frame structure relative to the articulated arm about an axis of the rotational shaft. The rotational shaft can be oriented perpendicular to a plane defined by the frame structure, such that rotation of the rotational shaft rotates the frame structure and the engaged solar panel. In some implementations, causing the actuator to rotate can include rotating the frame structure by 90 degrees relative to the articulated arm. The actuator can be coupled to the rotational shaft through a gear system that includes a first gear (e.g., the first gear 112a) and a second gear (e.g., the second gear 112b), with the first gear having a larger diameter than the second gear to provide a gear reduction. In some implementations, the actuator can be coupled to the rotational shaft without an intermediate gear system. In some implementations, the controller can transmit the control signal to the actuator simultaneously with a control signal to the arm controller of the articulated arm, such that the articulated arm is moving while the actuator is simultaneously rotating the frame structure.

At block 1908, the controller can reposition the solar panel using the rotated gripper assembly. The controller can transmit a control signal to the arm controller of the articulated arm to transport the solar panel from a staging position to a mounting location (e.g., the mounting location 1808) on a torque tube (e.g., the torque tube 1806) having hat rails. Because the plurality of suction cups engage the underside of the solar panel, the solar panel rides above the gripper assembly during the lateral movement. The controller can control the articulated arm to swing the solar panel to a left side or a right side of the movable base and to lower the solar panel onto the hat rails at the mounting location. The solar panel can arrive at the mounting location in a second orientation different from a first orientation at which the solar panel was picked from the staging position. In some implementations, the controller can align the rotated solar panel with the mounting location such that an electrical lead terminal on the solar panel is positioned proximate to a target connector on the torque tube. In some implementations, the controller can deactivate the vacuum source and activate a positive pressure source (e.g., the positive pressure source 1020) on the movable base to release the solar panel from the plurality of suction cups based on the solar panel being proximate to the mounting location. The positive pressure source can deliver compressed air through the same fluid lines used for vacuum to break residual stiction between the plurality of suction cups and the first surface of the solar panel.

In some implementations, the method 1900 can include transporting the solar panel to the mounting location using the gripper assembly. Transporting the solar panel can include the controller transmitting control signals to the arm controller of the articulated arm to move the gripper assembly from the staging position to the mounting location while the vacuum source remains active to maintain suction at the plurality of suction cups throughout the transport. In some implementations, the order of acts depicted in the method 1900 can be varied. For example, the controller can initiate rotation of the frame structure at block 1906 concurrently with repositioning the solar panel at block 1908, such that the rotation and the transport occur during overlapping time intervals. In some implementations, one or more acts of the method 1900 can be performed in a different order, repeated, or omitted.

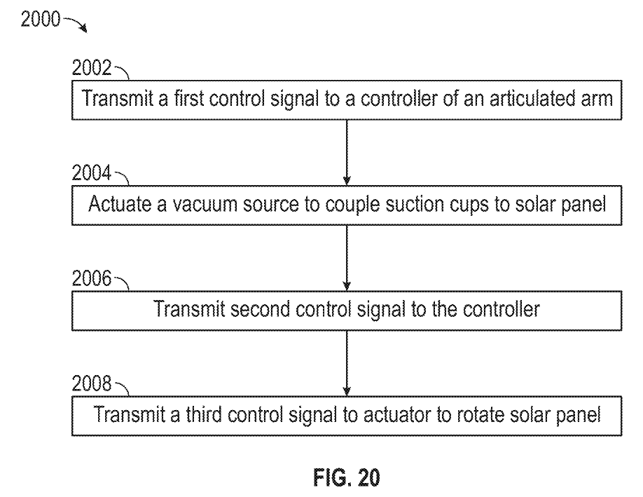

Referring now to FIG. 20, illustrated is a flow chart of a method 2000 for transmitting control signals and actuating vacuum to pick and rotate a solar panel using a robotic arm system, in accordance with one or more implementations. The method 2000 can be performed by a controller (e.g., the controller 1010) coupled to one or more processors and one or more memory devices storing instructions that, when executed by the one or more processors, cause the controller to perform the acts of the method 2000. The method 2000 can be performed in connection with a robotic system (e.g., the robotic system 1000) that includes a movable base (e.g., the movable base 1002), an articulated arm (e.g., the articulated arm 1006) disposed on the movable base, and a gripper assembly (e.g., the gripper assembly 1003) coupled to a distal end of the articulated arm. The gripper assembly can include a frame structure (e.g., the frame structure 102) and a plurality of suction cups (e.g., the suction cups 108) mounted to the frame structure. The gripper assembly can include a rotational shaft and an actuator (e.g., the actuator 114) coupled to the rotational shaft, the actuator to rotate the frame structure via the rotational shaft.

At block 2002, the controller can transmit a first control signal to a first controller of the articulated arm to position the gripper assembly adjacent to a solar panel (e.g., the solar panel 902). The first control signal can include joint-level position commands or trajectory commands that cause the first controller of the articulated arm to move the gripper assembly to a position adjacent to a first surface (e.g., the first surface 1804) of the solar panel. The first surface can be a rear surface or an underside of the solar panel. In some implementations, the controller can receive image data from one or more image sensors (e.g., the image sensors 1302 and/or the image sensors 1320) coupled to the movable base and/or to the articulated arm to determine a position and orientation of the solar panel. Based on the determined position and orientation, the controller can generate the first control signal to cause the first controller of the articulated arm to position the gripper assembly at a coupling location on the first surface of the solar panel. In some implementations, the controller can determine the coupling location on the first surface based on a position of at least one electrical lead terminal on the solar panel, a travel direction of the movable base, and a side to which the articulated arm will deploy the solar panel.

At block 2004, the controller can actuate a vacuum source (e.g., the vacuum source 1012) to couple the plurality of suction cups to the solar panel. The controller can activate the vacuum source on the movable base to generate negative pressure at the plurality of suction cups. The negative pressure can draw the plurality of suction cups against the first surface of the solar panel and couple the gripper assembly to the solar panel. In some implementations, the controller can activate the vacuum source while the gripper assembly is approaching the solar panel, such that negative pressure is at operating capacity by the time the plurality of suction cups make physical contact with the first surface. In some implementations, the vacuum source can include a first vacuum source and a second vacuum source, with a first subset of the plurality of suction cups fluidly coupled to the first vacuum source through a first vacuum line and a second subset of the plurality of suction cups fluidly coupled to the second vacuum source through a second vacuum line separate from the first vacuum line. Each vacuum source can be individually sufficient to maintain coupling of the solar panel to the gripper assembly via its respective subset of the plurality of suction cups, independent of the other vacuum source. In some implementations, the controller can transmit the first control signal at block 2002 and a vacuum activation signal at block 2004 in response to receiving a single user input, such as an operator pressing a pick button on a user interface (e.g., the user interface 1014).

At block 2006, the controller can transmit a second control signal to the first controller of the articulated arm to position the solar panel proximate to a target location. The target location can be a mounting location (e.g., the mounting location 1808) on a torque tube (e.g., the torque tube 1806) having hat rails. The second control signal can cause the first controller of the articulated arm to rotate and translate the solar panel laterally in a direction transverse to a travel direction of the movable base. Because the plurality of suction cups engage the underside of the solar panel, the solar panel rides above the gripper assembly during the lateral movement. The controller can control the articulated arm to swing the solar panel to a left side or a right side of the movable base and to lower the solar panel toward the hat rails at the target location. Throughout the transport from the staging position to the target location, the vacuum source can remain active to maintain suction at the plurality of suction cups. In some implementations, the controller can determine the target location based on image data from the one or more image sensors and based on a reference location of a previously placed solar panel on the torque tube.

At block 2008, the controller can transmit a third control signal to the actuator of the gripper assembly to rotate the solar panel to a target orientation. The third control signal can cause the actuator to rotate the frame structure relative to the articulated arm about an axis of the rotational shaft. The rotational shaft can be oriented perpendicular to a plane defined by the frame structure, such that rotation of the rotational shaft rotates the frame structure and the engaged solar panel. In some implementations, the controller can transmit the third control signal to rotate the frame structure by about 90 degrees relative to the articulated arm. The actuator can be coupled to the rotational shaft through a gear system that includes a first gear (e.g., the first gear 112a) and a second gear (e.g., the second gear 112b), with the first gear having a larger diameter than the second gear to provide a gear reduction. In some implementations, the actuator can be coupled to the rotational shaft without an intermediate gear system. In some implementations, the first control signal and the third control signal can be transmitted simultaneously, such that the articulated arm is moving while the actuator is simultaneously rotating the solar panel. In some implementations, the second control signal and the third control signal can be transmitted simultaneously, such that the articulated arm is transporting the solar panel toward the target location while the actuator is simultaneously rotating the frame structure to achieve the target orientation. After the solar panel is positioned at the target location in the target orientation, the controller can deactivate the vacuum source and activate a positive pressure source (e.g., the positive pressure source 1020) on the movable base to release the solar panel from the plurality of suction cups. The positive pressure source can deliver compressed air through the same fluid lines used for vacuum to break residual stiction between the plurality of suction cups and the first surface of the solar panel. In some implementations, the controller can select the target orientation based on a position of at least one electrical lead terminal on the solar panel, such that the electrical lead terminal is positioned proximate to a target connector on the torque tube after placement.

In some implementations, the order of acts depicted in the method 2000 can be varied. For example, the controller can transmit the third control signal at block 2008 concurrently with transmitting the second control signal at block 2006, such that the rotation and the transport occur during overlapping time intervals. In some implementations, the controller can transmit the first control signal at block 2002 and the third control signal at block 2008 simultaneously, such that the articulated arm movement and the frame structure rotation occur concurrently. In some implementations, one or more acts of the method 2000 can be performed in a different order, repeated, or omitted.

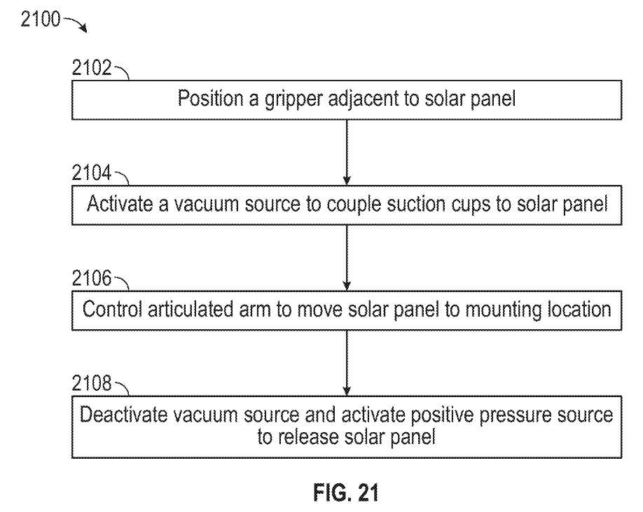

Referring now to FIG. 21, illustrated is a flow chart of a method 2100 for vacuum-based pickup, transport, and release of a solar panel by a robotic arm system, in accordance with one or more implementations. The method 2100 can be performed by a controller (e.g., the controller 1010) coupled to one or more processors and one or more memory devices storing instructions that, when executed by the one or more processors, cause the controller to perform the acts of the method 2100. The method 2100 can be performed in connection with a robotic system (e.g., the robotic system 1000) that includes a movable base (e.g., the movable base 1002), an articulated arm (e.g., the articulated arm 1006) disposed on the movable base, and a gripper (e.g., the gripper assembly 1003) coupled to a distal end of the articulated arm. The gripper can include a plurality of suction cups (e.g., the suction cups 108). The movable base can house a vacuum source (e.g., the vacuum source 1012) and a positive pressure source (e.g., the positive pressure source 1020).

At block 2102, the controller can position the gripper adjacent to a solar panel (e.g., the solar panel 902). The controller can transmit a control signal to an arm controller of the articulated arm to extend the articulated arm from the movable base and to move the gripper toward a surface of the solar panel. The surface can be a rear surface or an underside of the solar panel. In some implementations, the controller can receive image data from one or more image sensors (e.g., the image sensors 1302 and/or the image sensors 1320) coupled to the movable base and/or to the articulated arm to determine a position and orientation of the solar panel. Based on the determined position and orientation, the controller can generate joint-level position commands or trajectory commands that cause the arm controller of the articulated arm to move the gripper to a position adjacent to the surface of the solar panel. In some implementations, the controller can determine a coupling location on the surface based on a position of at least one electrical lead terminal on the solar panel, a travel direction of the movable base, and a side to which the articulated arm will deploy the solar panel.

At block 2104, the controller can activate the vacuum source on the movable base to couple the plurality of suction cups to the surface of the solar panel. The controller can transmit an activation command to the vacuum source to generate negative pressure at the plurality of suction cups. The negative pressure can draw the plurality of suction cups against the surface of the solar panel and couple the gripper to the solar panel. In some implementations, the controller can activate the vacuum source while the gripper is approaching the solar panel, such that negative pressure is at operating capacity by the time the plurality of suction cups make physical contact with the surface. In some implementations, the controller can activate the vacuum source in response to the plurality of suction cups contacting the surface of the solar panel. In some implementations, the vacuum source can include a first vacuum source and a second vacuum source (e.g., the second vacuum source 1013), with a first subset of the plurality of suction cups fluidly coupled to the first vacuum source through a first vacuum line (e.g., the first vacuum line 1022) and a second subset of the plurality of suction cups fluidly coupled to the second vacuum source through a second vacuum line (e.g., the second vacuum line 1024) separate from the first vacuum line. Each vacuum source can be individually sufficient to maintain coupling of the solar panel to the gripper via its respective subset of the plurality of suction cups, independent of the other vacuum source. In some implementations, the controller can maintain coupling of the gripper to the solar panel through at least one of the vacuum sources in response to loss of vacuum from another of the vacuum sources.

At block 2106, the controller can control the articulated arm to move the solar panel to a mounting location (e.g., the mounting location 1808) while maintaining suction via the plurality of suction cups and the vacuum source. The controller can transmit control signals to the arm controller of the articulated arm to rotate and translate the solar panel laterally in a direction transverse to a travel direction of the movable base. Because the plurality of suction cups engage the underside of the solar panel, the solar panel rides above the gripper during the lateral movement. The controller can control the articulated arm to swing the solar panel to a left side or a right side of the movable base and to lower the solar panel toward hat rails at the mounting location on a torque tube (e.g., the torque tube 1806). Throughout the transport from a staging position to the mounting location, the vacuum source can remain active to maintain suction at the plurality of suction cups. In some implementations, the controller can transmit a control signal to an actuator (e.g., the actuator 114) of the gripper to rotate a frame structure (e.g., the frame structure 102) relative to the articulated arm during transport, such that the solar panel arrives at the mounting location in a second orientation different from a first orientation at which the solar panel was picked from the staging position. The controller can maintain the vacuum source in an active state as a default while the solar panel is coupled to the gripper. Vacuum termination can occur in response to an affirmative release command from the controller, and the absence of a control signal, a communication loss, or a controller fault does not by itself deactivate the vacuum.

At block 2108, the controller can deactivate the vacuum source and activate the positive pressure source to release the solar panel from the plurality of suction cups based on the solar panel being proximate to the mounting location. The controller can determine that the solar panel is within a distance threshold of the mounting location and, in response, can transmit a deactivation command to the vacuum source and an activation command to the positive pressure source. The positive pressure source can deliver compressed air through the same fluid lines used for vacuum to break residual stiction between the plurality of suction cups and the surface of the solar panel. In some implementations, the controller can deactivate the vacuum source and activate the positive pressure source in response to user input via a user interface (e.g., the user interface 1014). In some implementations, the controller can deactivate the vacuum source and activate the positive pressure source in response to a position of the solar panel satisfying a condition. The condition can include at least one of a distance of the solar panel to the mounting location falling below a threshold, an orientation of the solar panel matching a target orientation, a length of time elapsing from a reference event, or contact of the solar panel at the mounting location being detected. In some implementations, the controller can activate the positive pressure source for a predetermined time period and can automatically deactivate the positive pressure source after the predetermined time period elapses. In some implementations, the controller can control the articulated arm to move toward the movable base while the positive pressure source is activated, which can assist in physically separating the plurality of suction cups from the surface of the solar panel. In some implementations, the controller can apply an oscillation motion to the articulated arm during release to overcome stiction between the plurality of suction cups and the surface of the solar panel.

After the solar panel is released at the mounting location, the controller can control the articulated arm to retract to a neutral position adjacent to or above the movable base. The controller can command the movable base to advance along a row in an installation environment (e.g., the installation environment 1800) to the position of the next staged solar panel, and the pick-and-place cycle can repeat. In some implementations, the controller can operate in a first operating mode when the movable base moves in a first direction along a first row and in a second operating mode when the movable base moves in a second direction opposite the first direction along a second row. In the second operating mode, the controller can determine a different coupling location on the next solar panel and a different mounting location based on the reversed travel direction.

In some implementations, the order of acts depicted in the method 2100 can be varied. For example, the controller can initiate activation of the vacuum source at block 2104 while the gripper is being positioned at block 2102, such that the vacuum activation and the positioning of the gripper occur during overlapping time intervals. In some implementations, one or more acts of the method 2100 can be performed in a different order, repeated, or omitted.

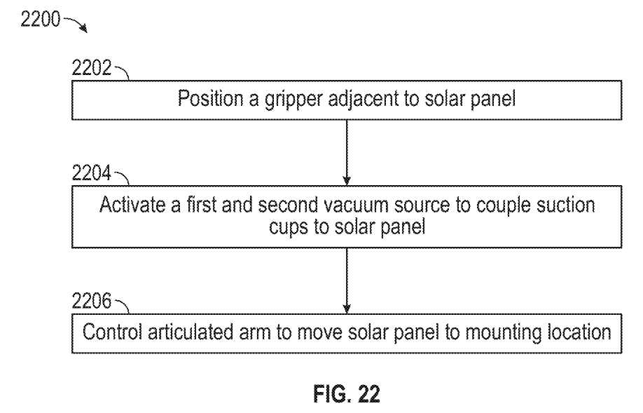

Referring now to FIG. 22, illustrated is a flow chart of a method 2200 for gripping a solar panel with redundant vacuum sources and moving the solar panel to a mounting location, in accordance with one or more implementations. The method 2200 can be performed by a controller (e.g., the controller 1010) coupled to one or more processors and one or more memory devices storing instructions that, when executed by the one or more processors, cause the controller to perform the acts of the method 2200. The method 2200 can be performed in connection with a robotic system (e.g., the robotic system 1000) that includes a movable base (e.g., the movable base 1002), an articulated arm (e.g., the articulated arm 1006) disposed on the movable base, and a gripper (e.g., the gripper assembly 1003) coupled to a distal end of the articulated arm. The gripper can include a plurality of suction cups (e.g., the suction cups 108). The movable base can house a first vacuum source (e.g., the vacuum source 1012) and a second vacuum source (e.g., the second vacuum source 1013).

At block 2202, the controller can position the gripper adjacent to a solar panel (e.g., the solar panel 902). The controller can transmit a control signal to an arm controller of the articulated arm to extend the articulated arm from the movable base and to move the gripper toward a surface (e.g., the first surface 1804) of the solar panel. The surface can be a rear surface or an underside of the solar panel. In some implementations, the controller can receive image data from one or more image sensors (e.g., the image sensors 1302 and/or the image sensors 1320) coupled to the movable base and/or to the articulated arm to determine a position and orientation of the solar panel. Based on the determined position and orientation, the controller can generate joint-level position commands or trajectory commands that cause the arm controller of the articulated arm to move the gripper to a position adjacent to the surface of the solar panel. In some implementations, the controller can determine a coupling location on the surface based on a position of at least one electrical lead terminal on the solar panel, a travel direction of the movable base, and a side to which the articulated arm will deploy the solar panel.

At block 2204, the controller can activate the first vacuum source and the second vacuum source on the movable base to couple the plurality of suction cups to the surface of the solar panel. A first subset (e.g., the first subset 1016) of the plurality of suction cups can be coupled to the first vacuum source through a first vacuum line (e.g., the first vacuum line 1022). A second subset (e.g., the second subset 1018) of the plurality of suction cups can be coupled to the second vacuum source through a second vacuum line (e.g., the second vacuum line 1024) separate from the first vacuum line. The controller can transmit an activation command to the first vacuum source and the second vacuum source to generate negative pressure at the plurality of suction cups. The negative pressure can draw the plurality of suction cups against the surface of the solar panel and couple the gripper to the solar panel. In some implementations, the controller can activate at least one of the first vacuum source or the second vacuum source while the gripper is approaching the solar panel, such that negative pressure is at operating capacity by the time the plurality of suction cups make physical contact with the surface. In some implementations, the controller can initiate activation of at least one of the first vacuum source or the second vacuum source in response to determining that the gripper is within a threshold distance from the solar panel. The first vacuum source can provide suction sufficient to maintain coupling of the solar panel to the gripper via the first subset of the plurality of suction cups independent of the second vacuum source. The second vacuum source can provide suction sufficient to maintain coupling of the solar panel to the gripper via the second subset of the plurality of suction cups independent of the first vacuum source. In some implementations, each of the first vacuum source and the second vacuum source can be coupled to at least two suction cups of the plurality of suction cups. In some implementations, the controller can activate the first vacuum source and the second vacuum source using a common vacuum control signal. In some implementations, the controller can activate the first vacuum source using a first vacuum control signal and the second vacuum source using a second vacuum control signal different from the first vacuum control signal.

At block 2206, the controller can control the articulated arm to move the solar panel to a mounting location (e.g., the mounting location 1808) while maintaining suction via the plurality of suction cups, the first vacuum source, and the second vacuum source. The controller can transmit control signals to the arm controller of the articulated arm to rotate and translate the solar panel laterally in a direction transverse to a travel direction of the movable base. Because the plurality of suction cups engage the underside of the solar panel, the solar panel rides above the gripper during the lateral movement. The controller can control the articulated arm to swing the solar panel to a left side or a right side of the movable base and to lower the solar panel toward hat rails at the mounting location on a torque tube (e.g., the torque tube 1806). Throughout the transport from a staging position to the mounting location, the first vacuum source and the second vacuum source can remain active to maintain suction at the plurality of suction cups through the first vacuum line and the second vacuum line, respectively. In some implementations, the controller can transmit a control signal to an actuator (e.g., the actuator 114) of the gripper to rotate a frame structure (e.g., the frame structure 102) relative to the articulated arm during transport, such that the solar panel arrives at the mounting location in a second orientation different from a first orientation at which the solar panel was picked from the staging position. The controller can maintain the first vacuum source and the second vacuum source in an active state as a default while the solar panel is coupled to the gripper. Vacuum termination can occur in response to an affirmative release command from the controller, and the absence of a control signal, a communication loss, or a controller fault does not by itself deactivate the vacuum. If one of the first vacuum source or the second vacuum source experiences a failure during transport, the controller can maintain coupling of the gripper to the solar panel through the remaining functional vacuum source via the respective subset of the plurality of suction cups.

In some implementations, after the controller moves the solar panel to the mounting location at block 2206, the controller can deactivate at least one of the first vacuum source or the second vacuum source and can activate a positive pressure source (e.g., the positive pressure source 1020) fluidly coupled to the plurality of suction cups to release the solar panel from the plurality of suction cups. The controller can activate the positive pressure source in response to determining that the solar panel is within a distance threshold of the mounting location. The positive pressure source can deliver compressed air through the same fluid lines used for vacuum to break residual stiction between the plurality of suction cups and the surface of the solar panel. In some implementations, the controller can activate the positive pressure source for a predetermined time period and can control the articulated arm to retract toward the movable base while the positive pressure source is active. In some implementations, the controller can transmit a first signal to the articulated arm to control movement of the articulated arm and can transmit a second signal different from the first signal to control activation of the first vacuum source and the second vacuum source. The controller can transmit at least one of the first signal or the second signal in response to receiving user input requesting movement of the solar panel.

In some implementations, the order of acts depicted in the method 2200 can be varied. For example, the controller can initiate activation of the first vacuum source and the second vacuum source at block 2204 while the gripper is being positioned at block 2202, such that the vacuum activation and the positioning of the gripper occur during overlapping time intervals. In some implementations, one or more acts of the method 2200 can be performed in a different order, repeated, or omitted.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations are illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

The term “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain implementations require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A robotic system, comprising:
a movable base having a vacuum source and a positive pressure source;
an articulated arm disposed on the movable base and comprising a gripper configured to couple to a solar panel, the gripper having a plurality of suction cups; and
a controller configured to:
control the articulated arm to position the gripper adjacent to the solar panel;
activate the vacuum source to couple the plurality of suction cups to a surface of the solar panel;
control the articulated arm to move the solar panel to a mounting location while maintaining suction via the plurality of suction cups and the vacuum source; and
deactivate the vacuum source and activate the positive pressure source to release the solar panel from the plurality of suction cups based on the solar panel being proximate to the mounting location.

2. The robotic system of claim 1, wherein the controller is configured to deactivate the vacuum source and activate the positive pressure source to release the solar panel in response to user input.

3. The robotic system of claim 1, wherein the controller is configured to deactivate the vacuum source and activate the positive pressure source to release the solar panel in response to a position of the solar panel satisfying a condition.

4. The robotic system of claim 3, wherein the condition comprises at least one of a distance of the solar panel to the mounting location, an orientation of the solar panel, a length of time, or contact of the solar panel at the mounting location.

5. The robotic system of claim 1, wherein the positive pressure source comprises a compressed air source fluidly coupled to the plurality of suction cups.

6. The robotic system of claim 1, wherein the controller is configured to activate the positive pressure source based on supplying positive pressure to the plurality of suction cups for a predetermined time period.

7. The robotic system of claim 1, wherein to release the solar panel, the controller is further configured to:
activate the positive pressure source to apply positive pressure to the plurality of suction cups; and
control the articulated arm to move towards the movable base while the positive pressure source is activated.

8. The robotic system of claim 1, wherein the vacuum source includes a plurality of vacuum sources, and wherein a first subset of the plurality of suction cups is fluidly connected to a first vacuum source and a second subset of the plurality of suction cups is fluidly connected to a second vacuum source.

9. The robotic system of claim 8, wherein the controller is configured to maintain coupling of the gripper to the solar panel through at least one of the plurality of vacuum sources in response to loss of vacuum from another of the plurality of vacuum sources.

10. The robotic system of claim 1, wherein the controller is configured to activate the vacuum source in response to the plurality of suction cups directly contacting the surface of the solar panel.

11. A method for installing a solar panel using a robotic system, comprising:
positioning, by a controller using an articulated arm disposed on a movable base of the robotic system, a gripper adjacent to the solar panel, the gripper having a plurality of suction cups;
activating, by the controller, a vacuum source on the movable base to couple the plurality of suction cups to a surface of the solar panel;
controlling, by the controller, the articulated arm to move the solar panel to a mounting location while maintaining suction via the plurality of suction cups and the vacuum source; and
deactivating, by the controller, the vacuum source and activating a positive pressure source on the movable base to release the solar panel from the plurality of suction cups based on the solar panel being proximate to the mounting location.

12. The method of claim 11, wherein deactivating the vacuum source and activating, by the controller, the positive pressure source to release the solar panel is performed in response to user input.

13. The method of claim 11, wherein deactivating the vacuum source and activating the positive pressure source by the controller to release the solar panel is performed in response to a position of the solar panel satisfying a condition.

14. The method of claim 13, wherein the condition comprises at least one of a distance of the solar panel to the mounting location, an orientation of the solar panel, a length of time, or contact of the solar panel at the mounting location.

15. The method of claim 11, wherein activating the positive pressure source comprises supplying, by the controller, compressed air from a compressed air source fluidly coupled to the plurality of suction cups.

16. The method of claim 11, wherein activating the positive pressure source comprises supplying, by the controller, positive pressure to the plurality of suction cups for a predetermined time period.

17. The method of claim 11, wherein releasing the solar panel further comprises:
activating, by the controller, the positive pressure source to apply positive pressure to the plurality of suction cups; and
controlling, by the controller, the articulated arm to move toward the movable base while the positive pressure source is activated.

18. The method of claim 11, wherein activating the vacuum source comprises activating, by the controller, a plurality of vacuum sources, such that a first subset of the plurality of suction cups is fluidly connected to a first vacuum source and a second subset of the plurality of suction cups is fluidly connected to a second vacuum source.

19. The method of claim 18, further comprising maintaining, by the controller, coupling of the gripper to the solar panel through at least one of the plurality of vacuum sources in response to loss of vacuum from another of the plurality of vacuum sources.

20. The method of claim 11, further comprising activating, by the controller, the vacuum source in response to the plurality of suction cups directly contacting the surface of the solar panel.
